(19) United States
(12) Patent Application Publication
(10) Pub. No.: US 2004/0116294 A1
(43) Pub. Date: Jun. 17, 2004

(54) Herbicides based on substituted aryl ketones

(76) Inventors: Dieter Feucht, Monheim (DE); Peter Dahmen, Neuss (DE); Mark Wilhelm Drewes, Langenfeld (DE); Rolf Pontzen, Leichlingen (DE); Klaus-Helmut Muller, Dusseldorf (DE); Stefan Lehr, Liederbach (DE); Hans-Georg Schwarz, Langenfeld (DE); Toshio Goto, Shimotsuga-gun (JP); Shinichi Shirakura, Oyama-shi (JP)

Correspondence Address: BAYER CROPSCIENCE LP, Patent Department, 100 BAYER ROAD, PITTSBURGH, PA, 15205-9741, US

(21) Appl. No.: 10/469,660

(22) PCT Filed: Mar. 1, 2002
(86) PCT No.: PCT/EP02/02207

(30) Foreign Application Priority Data
Mar. 14, 2001 (DE) 101 12 104.0

(51) Int. Cl. A01N 43/00; A01N 43/56; A01N 43/647; A01N 43/713; A01N 43/72

(52) U.S. Cl. 504/139; 504/129

(57) ABSTRACT

The invention relates to novel herbicidal synergistic active compound combinations comprising, firstly, known substituted aryl ketones and, secondly, one or more known herbicidally active compounds and optionally additionally a compound which improves crop plant compatibility, which combinations can be used with particularly good results for controlling weeds in various crops of useful plants or else for controlling monocotyledonous and dicotyledonous weeds in the semi- and nonselective field.

### HERBICIDES BASED ON SUBSTITUTED ARYL KETONES

The invention relates to novel herbicidal synergistic active compound combinations comprising, firstly, known substituted aryl ketones and, secondly, one or more known herbicidally active compound and optionally additionally a compound which improves crop plant compatibility, which combinations can be used with particularly good results for controlling weeds in various crops of useful plants or else for controlling monocotyledonous and dicotyledonous weeds in the semi- and nonselective field.

Substituted aryl ketones are known as active herbicides (cf. WO-A-96/26200, WO-A-00/05221, WO-A-00/58306, WO-A-00/68204, WO-A-00/68227). However, the activity of these compounds is not always entirely satisfactory.

Active compound combinations based on substituted aryl ketones are likewise known (cf. WO-A-00/25584). However, the properties of these active compound combinations are likewise not entirely satisfactory.

Surprisingly, it has now been found that a number of active compounds from the group of the substituted aryl ketones, when used together with certain herbicidally active compounds, show synergistic effects with respect to the activity against weeds and can be used particularly advantageously as broadly active combination preparations for the selective control of monocotyledonous and dicotyledonous weeds in crops of useful plants, such as, for example, in cotton, barley, corn, rice, soybeans, sunflowers, wheat and sugar cane, but also for controlling monocotyledonous and dicotyledonous weeds in the semi- and nonselective field.

The invention provides herbicidal compositions, characterized by an effective amount of an active compound combination comprising

(a) at least one substituted aryl ketone of the general formula (I)

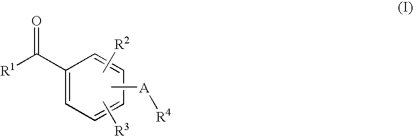

in which

A represents a single bond or represents alkanediyl having 1 to 6 carbon atoms,

R¹ represents one of the groupings below

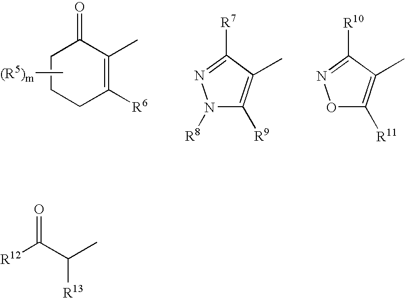

where

m represents the numbers 0 to 6,

R⁵ represents halogen, represents in each case optionally cyano-, halogen- or C₁-C₄-alkoxy-substituted alkyl or alkylthio having in each case 1 to 6 carbon atoms, or represents optionally halogen-, C₁-C₄-alkyl- or C₁-C₄-alkoxy-substituted phenyl, or—if m represents 2—optionally together with a second radical R⁵ also represents a carbonyl group (C═O) or alkanediyl (alkylene) having 2 to 6 carbon atoms,

R⁶ represents hydroxyl, formyloxy, halogen, represents in each case optionally cyano-, halogen- or C₁-C₄-alkoxy-substituted alkoxy, alkylthio, alkylsulfinyl, alkylsulfonyl, alkylcarbonyloxy, alkoxycarbonyloxy, alkylaminocarbonyloxy or alkylsulfonyloxy having in each case 1 to 6 carbon atoms in the alkyl groups, represents in each case optionally cyano- or halogen-substituted alkenyloxy or alkinyloxy having in each case 2 to 6 carbon atoms, or represents in each case optionally nitro-, cyano-, halogen, C₁-C₄-alkyl-, C₁-C₄-halogenoalkyl-, C₁-C₄-alkoxy- or C₁-C₄-halogenoalkoxy-substituted phenoxy, phenylthio, phenylsulfinyl, phenylsulfonyl, phenylcarbonyloxy, phenylcarbonylalkoxy, phenylsulfonyloxy, phenylalkoxy, phenylalkylthio, phenylalkylsulfinyl or phenylalkylsulfonyl having optionally 1 to 4 carbon atoms in the alkyl moiety,

R⁷ represents hydrogen, cyano, carbamoyl, thiocarbamoyl, halogen, represents in each case optionally cyano-, halogen- or C₁-C₄-alkoxy-substituted alkyl, alkoxy, alkylthio, alkylsulfinyl, alkylsulfonyl or alkoxycarbonyl having in each case 1 to 6 carbon atoms in the alkyl groups, or represents optionally cyano-, halogen- or C₁-C₄-alkyl-substituted cycloalkyl having 3 to 6 carbon atoms,

R⁸ represents hydrogen, represents optionally cyano-, halogen- or C₁-C₄-alkoxy-substituted alkyl having 1 to 6 carbon atoms, represents in each case optionally cyano- or halogen-substituted alkenyl or alkinyl having in each case 2 to 6 carbon atoms, represents in each case optionally cyano-, halogen- or C₁-C₄-alkyl-substituted cycloalkyl or cycloalkylalkyl having in each case 3 to 6 carbon atoms in the cycloalkyl group and optionally 1 to 4 carbon atoms in the alkyl moiety, or represents in each case optionally nitro-, cyano-, halogen-, C₁-C₄-alkyl-, C₁-C₄-halogenoalkyl-, C₁-C₄-alkoxy- or C₁-C₄-halogenoalkoxy-substituted phenyl or phenyl-C₁-C₄-alkyl,

R⁹ represents hydroxyl, formyloxy, represents in each case optionally cyano-, halogen- or C₁-C₄-alkoxy-substituted alkoxy, alkylcarbonyloxy, alkoxycarbonyloxy, alkylaminocarbonyloxy or alkylsulfonyloxy having in each case 1 to 6 carbon atoms in the alkyl groups, represents in each case optionally cyano- or halogen-substituted alkenyloxy or alkinyloxy having in each case 2 to 6 carbon atoms, represents in each case optionally nitro-, cyano-, halogen-, C₁-C₄-alkyl- or C₁-C₄-halogenoalkyl-substituted phenylalkoxy, phenylcarbonyloxy, phenylcarbonylalkoxy or phenylsulfonyloxy having optionally 1 to 4 carbon atoms in the alkyl moiety,

R¹⁰ represents hydrogen, cyano, carbamoyl, thiocarbamoyl, halogen or represents in each case optionally cyano-, halogen- or C₁-C₄-alkoxy-substituted alkyl, alkylcarbonyl, alkoxy, alkoxycarbonyl, alkylthio alkylsulfinyl or alkylsulfonyl having in each case 1 to 6 carbon atoms in the alkyl groups,

R¹¹ represents hydrogen, represents optionally cyano-, halogen- or C₁-C₄-alkoxy-substituted alkyl having 1 to 6 carbon atoms or represents optionally cyano-, halogen- or C₁-C₄-alkyl-substituted cycloalkyl having 3 to 6 carbon atoms,

R¹² represents hydrogen, represents optionally cyano-, halogen- or C₁-C₄-alkoxy-substituted C₁-C₆-alkyl or represents optionally cyano-, halogen- or C₁-C₄-alkyl-substituted cycloalkyl having 3 to 8 carbon atoms, and

R¹³ represents hydrogen, cyano, carbamoyl, halogen, or represents in each case optionally represents optionally cyano-, halogen- or C₁-C₄-alkoxy-substituted alkyl, alkoxy, alkoxycarbonyl, alkylthio, alkylsulfinyl or alkylsulfonyl having in each case 1 to 6 carbon atoms in the alkyl groups,

R² represents hydrogen, nitro, cyano, carboxyl, carbamoyl, thiocarbamoyl, halogen, or represents in each case optionally represents optionally cyano-, halogen- or C₁-C₄-alkoxy-, C₁-C₄-alkylthio-, C₁-C₄-alkylsulfinyl- or C₁-C₄-alkylsulfonyl-substituted alkyl, alkoxy, alkylthio, alkylsulfinyl, alkylsulfonyl, alkylamino, dialkylamino or dialkylaminosulfonyl having in each case 1 to 6 carbon atoms in the alkyl groups,

R³ represents hydrogen, nitro, cyano, carboxyl, carbamoyl, thiocarbamoyl, halogen, or represents in each case optionally cyano-, halogen- or C₁-C₄-alkoxy-, C₁-C₄-alkylthio-, C₁-C₄-alkylsulfinyl- or C₁-C₄-alkylsulfonyl-substituted alkyl, alkoxy, alkylthio, alkylsulfinyl, alkylsulfonyl, alkylamino, dialkylamino or dialkylaminosulfonyl having in each case 1 to 6 carbon atoms in the alkyl groups, and

R⁴ represents an optionally substituted 4- to 12-membered saturated or unsaturated monocyclic or bicyclic heterocyclic grouping which contains 1 to 4 heteroatoms, up to 4 of which are nitrogen atoms, and optionally—alternatively or additionally—1 to 3 oxygen atoms, sulfur atoms, —SO— groups, —SO₂— groups, —CO— groups and/or —CS— groups,

including all possible tautomeric forms of the compounds of the general formula (I) and the possible salts or acid or base adducts of the compounds of the general formula (I)

(“active compounds of group 1”)

and

(b) one or more compounds from a second group of herbicides comprising the active compounds listed below:

2-chloro-N-(ethoxymethyl)-N-(2-ethyl-6-methyl-phenyl)-acetamide (acetochlor), 5-(2-chloro-4-trifluoromethyl-phenoxy)-2-nitro-benzoic acid sodium salt (acifluorfen-sodium), 2-chloro-6-nitro-3-phenoxy-benzeneamine (aclonifen), 2-chloro-N-(methoxymethyl)-N-(2,6-diethyl-phenyl)-acetamide (alachlor), N-ethyl-N′-i-propyl-6-methylthio-1,3,5-triazine-2,4-diamine (ametryn), 4-amino-N-(1,1-dimethyl-ethyl)-4,5-dihydro-3-(1-methyl-ethyl)-5-oxo-1H-1,2,4-triazole-1-carboxamide (amicarbazone), N-(4,6-dimethoxy-pyrimidin-2-yl)-N′-(N-methyl-N-methylsulfonyl-sulfamoyl)-urea (amidosulfuron), 1H-1,2,4-triazol-3-amine (amitrole), S-[2-[(4-chloro-phenyl)-(1-isopropyl)-amino]-2-oxo-ethyl] O,O-dimethyl phosphorodithioate (anilofos), 6-chloro-4-ethylamino-2-isopropylamino-1,3,5-triazine (atrazin), 2-[2,4-dichloro-5-(2-propinyloxy)-phenyl]-5,6,7,8-tetrahydro-1,2,4-triazolo-[4,3-a]-pyridin-3(2H)-one (azafenidin), N-(4,6-dimethoxy-pyrimidin-2-yl)-N′-[1-methyl-4-(2-methyl-2H-tetrazol-5-yl)-1H-pyrazol-5-ylsulfonyl]-urea (azimsulfuron), N-benzyl-2-(4-fluoro-3-trifluoromethyl-phenoxy)-butanamide (beflubutamid), 4-chloro-2-oxo-3(2H)-benzothiazoleacetic acid (benazolin), N-butyl-N-ethyl-2,6-dinitro-4-trifluoromethyl-benzeneamine (benfluralin), 2,3-dihydro-3,3-dimethyl-5-benzofuranyl-ethanesulfonate (benfuresate), N-(4,6-dimethoxy-pyrimidin-2-yl)-N′-(2-methoxycarbonyl-phenylmethylsulfonyl)-urea (bensulfuron-methyl), S-[(4-chloro-phenyl)-methyl]diethylthiocarbamate (benthiocarb, thiobencarb), methyl 2-[2-[4-(3,6-dihydro-3-methyl-2,6-dioxo-4-trifluoromethyl-1(2H)-pyrimidinylphenoxymethyl]-5-ethyl-phenoxy-propanoate (benzfendizone), 3-(2-chloro-4-methylsulfonyl-benzoyl)-4-phenylthio-bicyclo-[3.2.1]-oct-3-en-2-one (benzobicyclon), 2-[[4-(2,4-dichloro-3-methyl-benzoyl)-1,3-dimethyl-1H-pyrazol-5-yl]-oxy]-1-(4-methyl-phenyl)-ethanone (benzofenap), ethyl N-benzoyl-N-(3,4-dichloro-phenyl)-DL-alaninate (benzoylprop-ethyl), 3-i-propyl-1H-2,1,3-benzo-thiadiazin-4(3H)-one (bentazone), methyl 5-(2,4-dichloro-phenoxy)-2-nitro-benzoate (bifenox), 2,6-bis-(4,6-dimethoxy-pyrimidin-2-yl-oxy)-benzoic acid sodium salt (bispyribac-sodium), 5-bromo-6-methyl-3-(1-methyl-propyl)-2,4(1H,3H)-pyrimidinedione (bromacil), 2-bromo-3,3-dimethyl-N-(1-methyl-1-phenyl-ethyl)-butanamide (bromobutide), 3,5-dibromo-4-hydroxy-benzaldehyde O-(2,4-dinitro-phenyl)-oxime (bromofenoxim), 3,5-dibromo-4-hydroxy-benzonitrile (bromoxynil), N-butoxymethyl-2-chloro-N-(2,6-diethyl-phenyl)-acetamide (butachlor), [1,1-dimethyl-2-oxo-2-(2-propenyloxy)]-ethyl 2-chloro-5-(3,6-dihydro-3-methyl-2,6-dioxo-4-trifluoromethyl-1(2H)-pyrimidinyl)-benzoate (butafenacil-allyl), 2-(1-ethoximino-propyl)-3-hydroxy-5-[2,4,6-trimethyl-3-(1-oxo-butyl)-phenyl]-2-cyclo-hexen-1-one (butroxydim), S-ethyl-bis-(2-methyl-propyl)-thiocarbamate (butylate), N,N-diethyl-3-(2,4,6-trimethyl-phenylsulfonyl)-1H-1,2,4-triazole-1-carboxamide (cafenstrole), 2-[1-[(3-chloro-2-propenyl)-oxy-imino]-propyl]-3-hydroxy-5-(tetrahydro-2H-pyran-4-yl)-2-cyclohexen-1-one (caloxydim, tepraloxydim), 2-(4-chloro-2-fluoro-5-(2-chloro-2-ethoxycarbonyl-ethyl)-phenyl)-4-difluoromethyl-5-methyl-2,4-dihydro-3H-1,2,4-triazol-3-one (carfentrazone-ethyl), 2,4-dichloro-1-(3-methoxy-4-nitro-phenoxy)-benzene (chlomethoxyfen), 3-amino-2,5-dichloro-benzoic acid (chloramben), N-(4-chloro-6-methoxy-pyrimidin-2-yl)-N′-(2-ethoxycarbonyl-phenylsulfonyl)-urea (chlorimuron-ethyl), 1,3,5-trichloro-2-(4-nitro-phenoxy)-benzene (chlomitrofen), N-(4-methoxy-6-methyl-1,3,5-triazin-2-yl)-N′-(2-chloro-phenylsulfonyl)-urea (chlorsulfuron), N′-(3-chloro-4-methyl-phenyl)-N,N-dimethyl-urea (chlortoluron), ethyl 2-chloro-3-[2-chloro-5-(1,3,4,5,6,7-hexahydro-1,3-dioxo-2H-isoindol-2-yl)-phenyl]-2-propanoate (cinidon-ethyl), exo-1-methyl-4-isopropyl-2-(2-methyl-phenyl-methoxy)-7-oxabicyclo-[2.2.1]-heptane (cinmethylin), N-(4,6-dimethoxy-1,3,5-triazin-2-yl)-N′-(2-(2-methoxy-ethoxy)-phenylsulfonyl)-urea (cinosulfuron), 2-[1-[2-(4-chloro-phenoxy)-propoxyaminobutyl]]-5-(tetrahydro-2H-thiopyran-3-yl)-1,3-cyclohexanedione (clefoxydim), (E,E)-(+)-2-[1-[[(3-chloro-2-propenyl)-oxy]-imino]-propyl]-3-hydroxy-2-cyclohexen-1-one (clethodim), (R)-(2-propinyl) 2-[4-(5-chloro-3-fluoro-pyridin-2-yl-oxy)-phenoxy-propanoate (clodinafop-propargyl), 2-(2,4-dichloro-3-methyl-phenoxy)-N-phenyl-propanamide (clomeprop), 3,6-dichloro-pyridine-2-carboxylic acid (clopyralid), methyl 3-chloro-2-[(5-ethoxy-7-fluoro[1,2,4]triazolo[1,5-c]pyrimidin-2-yl-sulfonyl)-amino]-benzoate (cloransulam-methyl), N-[(2-chloro-phenyl)-methyl]-N′-(1-methyl-1-phenyl-ethyl)-urea (cumyluron), 2-chloro-4-ethylamino-6-(1-cyano-1-methyl-ethylamino)-1,3,5-triazine (cyanazine), N-(4,6-dimethoxy-pyrimidin-2-yl)-N′-(2-cyclopropylcarbonyl-phenylsulfonyl)-urea (cyclosulfamuron), 2-(1-ethoximinobutyl)-3-hydroxy-5-(tetrahydro-2H-thiopyran-3-yl)-2-cyclohexen-1-one (cycloxydim), (R)-2-butyl [4-(4-cyano-2-fluoro-phenoxy)-phenoxy]-propanoate (cyhalofop-butyl), 2,4-dichloro-phenoxyacetic acid (2,4-D), 3,6-dichloro-2-methoxy-benzoic acid (dicamba), (R)-2-(2,4-Dichloro-phenoxy)-propanoic acid (dichlorprop-P), methyl 2-[4-(2,4-dichlorophenoxy)-phenoxy]-propanoate (diclofop-methyl), N-(2,6-dichloro-phenyl)-5-ethoxy-7-fluoro-[1,2,4]-triazolo-[1,5-c]-pyrimidine-2-sulfonamide (diclosulam), 1,2-dimethyl-3,5-diphenyl-1H-pyrazolium methylsulfate (difenzoquat), N-(2,4-difluoro-phenyl)-2-(3-trifluoromethyl-phenoxy)-pyridine-3-carboxamide (diflufenican), 2-[1-[(3,5-difluoro-phenyl)-amino-carbonyl-hydrazono]-ethyl]-pyridine-3-carboxylic acid (diflufenzopyr), S-(1-methyl-1-phenyl-ethyl)-1-piperidine carbothioate (dimepiperate), 2-chloro-N-(2,6-dimethyl-phenyl)-N-(2-methoxy-ethyl)-acetamide (dimethachlor), N-(1,2-dimethyl-propyl)-N′-ethyl-6-methylthio-1,3,5-triazine-2,4-diamine (dimethametryn), (S-)2-chloro-N-(2,4-dimethyl-3-thienyl)-N-(2-methoxy-1-methyl-ethyl)-acetamide (S-)(dimethenamid), 2-amino-4-(1-fluoro-1-methyl-ethyl)-6-(1-methyl-2-(3,5-dimethyl-phenoxy)-ethylamino)-1,3,5-triazine (dimexyflam), N3,N3-diethyl-2,4-dinitro-6-trifluoromethyl-1,3-diamino-benzene (dinitramine), 6,7-dihydro-dipyrido[1,2-a:2′,1′-c]pyrazinediium (diquat), S,S-dimethyl-2-difluoromethyl-4-i-butyl-6-trifluoromethyl-pyridine-3,5-dicarbothioate (dithiopyr), N′-(3,4-dichloro-phenyl)-N,N-dimethyl-urea (diuron), N-(4-methyl-phenyl)-N′-(1-methyl-1-phenyl-ethyl)-urea (dymron, daimuron), 2-[2-(3-chloro-phenyl)-oxiranylmethyl]-2-ethyl-1H-indene-1,3(2H)-dione (epropodan), S-ethyl dipropylthiocarbamate (EPTC), S-(phenylmethyl)-N-ethyl-N-(1,2-dimethyl-propyl)-thiocarbamate (esprocarb), N-ethyl-N-(2-methyl-2-propenyl)-2,6-dinitro-4-trifluoromethyl-benzeneamine (ethalfluralin), (S)-(2-ethoxy-1-methyl-2-oxoethyl) 2-chloro-5-(2-chloro-4-trifluoromethyl-phenoxy)-benzoate (ethoxyfen), N-(4,6-dimethoxy-pyrimidin-2-yl)-N′-(2-ethoxy-phenoxysulfonyl)-urea (ethoxysulfuron), N-(2,3-dichloro-phenyl)-4-ethoxymethoxy-benzamide (etobenzanid), (R)-ethyl-2-[4-(6-chloro-benzoxazol-2-yl-oxy)-phenoxy]-propanoate (fenoxaprop-(P)-ethyl), 4-(2-chloro-phenyl)-N-cyclohexyl-N-ethyl-4,5-dihydro-5-oxo-1H-tetrazole-1-carboxamide (fentrazamide), isopropyl N-benzoyl-N-(3-chloro-4-fluoro-phenyl)-DL-alaninate (flamprop-isopropyl), isopropyl N-benzoyl-N-(3-chloro-4-fluoro-phenyl)-L-alaninate (flamprop-isopropyl-L), methyl N-benzoyl-N-(3-chloro-4-fluoro-phenoxy)-DL-alaninate (flamprop-methyl), N-(2,6-difluoro-phenyl)-8-fluoro-5-methoxy-[1,2,4]-triazolo-[1,5-c]-pyrimidine-2-sulfonamide (florasulam), butyl (R)-2-[4-(5-trifluoromethyl-pyridin-2-yl-oxy)-phenoxy]-propanoate (fluazifop, -butyl, -P-butyl), i-propyl 5-(4-bromo-1-methyl-5-trifluoromethyl-1H-pyrazol-3-yl)-2-chloro-4-fluoro-benzoate (fluazolate), 4,5-dihydro-3-methoxy-4-methyl-5-oxo-N-[(2-trifluoromethoxy-phenyl)-sulfonyl]-1-H-1,2,4-triazole-1-carboxamide sodium salt (flucarbazone-sodium), N-(4-fluoro-phenyl)-N-i-propyl-2-(5-trifluoromethyl-1,3,4-thiadiazol-2-yl-oxy)-acetamide (flufenacet), N-(2,6-difluoro-phenyl)-5-methyl-1,2,4-triazolo[1,5-a]-pyrimidine-2-sulfonamide (flumetsulam), pentyl [2-chloro-4-fluoro-5-(1,3,4,5,6,7-hexahydro-1,3-dioxo-2H-isoindol-2-yl)-phenoxy]-acetate (flumiclorac-pentyl), 2-[7-fluoro-3,4-dihydro-3-oxo-4-(2-propinyl)-2H-1,4-benzoxazin-6-yl]-4,5,6,7-tetrahydro-1H-isoindole-1,3-dione (flumioxazin), 2-[4-chloro-2-fluoro-5-[(1-methyl-2-propinyl)-oxy]-phenyl]-4,5,6,7-tetrahydro-1H-isoindole-1,3(2H)-dione (flumipropyn), 3-chloro-4-chloromethyl-1-(3-trifluoromethyl-phenyl)-2-pyrrolidinone (fluorochloridone), ethoxycarbonylmethyl 5-(2-chloro-4-trifluoromethyl-phenoxy)-2-nitro-benzoate (fluoroglycofen-ethyl), 1-(4-chloro-3-(2,2,3,3,3-pentafluoro-propoxymethyl)-phenyl)-5-phenyl-1H-1,2,4-triazol-3-carboxamide (flupoxam), 1-isopropyl-2-chloro-5-(3,6-dihydro-3-methyl-2,6-dioxo-4-trifluoromethyl-1(2H)-pyrimidyl)-benzoate (flupropacil), N-(4,6-dimethoxy-pyrimidin-2-yl)-N′-(3-methoxycarbonyl-6-trifluoromethyl-pyridin-2-yl-sulfonyl)-urea sodium salt (flupyrsulfuron-methyl-sodium), 9-hydroxy-9H-fluorene-9-carboxylic acid (flurenol), (4-amino-3,5-dichloro-6-fluoro-pyridin-2-yl-oxy)-acetic acid (-2-butoxy-1-methyl-ethylester, -1-methyl-heptyl ester) (fluroxypyr, -butoxypropyl, -meptyl), 5-methylamino-2-phenyl-4-(3-trifluoromethyl-phenyl)-3(2H)-furanone (flurtamone), methyl-[(2-chloro-4-fluoro-5-(tetrahydro-3-oxo-1H,3H-[1,3,4]-thiadiazolo-[3,4-a]-pyridazin-1-ylidene)-amino-phenyl]-thio-acetate (fluthiacet-methyl), 5-(2-chloro-4-trifluoromethyl-phenoxy)-N-methylsulfonyl-2-nitro-benzamide (fomesafen), 2-[[[[(4,6-dimethoxy-2-pyrimidinyl)-amino]-carbonyl]-amino]-sulfonyl]-4-formylamino-N,N-dimethyl-benzamide (foramsulfuron), 2-amino-4-(hydroxymethylphosphinyl)-butanoic acid (-ammonium salt) (glufosinate (-ammonium)), N-phosphonomethyl-glycine (-isopropylammonium salt), (glyphosate, -isopropylammonium), (R)-2-[4-(3-chloro-5-trifluoromethyl-pyridin-2-yl-oxy)-phenoxy]-propanoic acid (-methyl ester, -2-ethoxy-ethyl ester, -butyl ester) (haloxyfop, -methyl, -P-methyl, -ethoxyethyl, -butyl), 3-cyclohexyl-6-dimethylamino-1-methyl-1,3,5-triazine-2,4(1H,3H)-dione (hexazinone), methyl 2-(4,5-dihydro-4-methyl-4-isopropyl-5-oxo-1H-imidazol-2-yl)-4-methyl-benzoate (imazamethabenz-methyl), 2-(4,5-dihydro-4-methyl-4-isopropyl-5-oxo-1H-imidazol-2-yl)-5-methyl-pyridine-3-carboxylic acid (imazamethapyr), 2-(4,5-dihydro-4-methyl-4-isopropyl-5-oxo-1H-imidazol-2-yl)-5-methoxymethyl-pyridine-3-carboxylic acid (imazamox), 2-(4,5-dihydro-4-methyl-4-isopropyl-5-oxo-1H-imidazol-2-yl)-quinoline-3-carboxylic acid (imazaquin), 2-(4,5-dihydro-4-methyl-4-i-propyl-5-oxo-1H-imidazol-2-yl)-5-ethyl-pyridine-3-carboxylic acid (imazethapyr), N-(4,6-dimethoxy-pyrimidin-2-yl)-N′-(2-chloro-imidazo[1,2-a]-pyridin-3-yl-sulfonyl)-urea (imazosulfuron), N-(4-methoxy-6-methyl-1,3,5-triazin-2-yl)-N′-(5-iodo-2-methoxycarbonyl-phenylsulfonyl)-urea sodium salt (iodosulfuron-methyl-sodium), 4-hydroxy-3,5-diiodo-benzonitrile (ioxynil), N,N-dimethyl-N′-(4-isopropyl-phenyl)-urea (isoproturon), N-(3-(1-ethyl-1-methyl-propyl)-isoxazol-5-yl)-2,6-dimethoxy-benzamide (isoxaben), (4-chloro-2-methylsulfonyl-phenyl)-(5-cyclopropyl-isoxazol-4-yl)-methanone (isoxachlortole), (5-cyclopropyl-isoxazol-4-yl)-(2-methylsulfonyl-4-trifluoromethyl-phenyl)-methanone (isoxaflutole), 2-[2-[4-[3,5-dichloro-2-pyridinyl)-oxy]-phenoxy]-1-oxo-propyl]-isoxazolidine (isoxapyrifop), (2-ethoxy-1-methyl-2-oxo-ethyl) 5-(2-chloro-4-trifluoromethyl-phenoxy)-2-nitro-benzoate (lactofen), N′-(3,4-dichloro-phenyl)-N-methoxy-N-methyl-urea (linuron), (4-chloro-2-methyl-phenoxy)-acetic acid (MCPA), 2-(4-chloro-2-methyl-phenoxy)-propionic acid (mecoprop), 2-(2-benzothiazolyloxy)-N-methyl-N-phenyl-acetamide (mefenacet), methyl 2-[[[[(4,6-dimethoxy-2-pyrimidinyl)-amino]-carbonyl]-amino]-sulfonyl]-4-[[(methylsulfonyl)-amino]methyl]-benzoate (mesosulfuron), 2-(4-methylsulfonyl-2-nitro-benzoyl)-1,3-cyclohexanedione (mesotrione), 4-amino-3-methyl-6-phenyl-1,2,4-triazin-5(4H)-one (metamitron), 2-chloro-N-(2,6-dimethyl-phenyl)-N-(1H-pyrazol-1-yl-methyl)-acetamide (metazachlor), N′-(4-(3,4-dihydro-2-methoxy-2,4,4-trimethyl-2H-1-benzopyran-7-yl-oxy)-phenyl)-N-methoxy-N-methyl-urea (metobenzuron), N′-(4-bromo-phenyl)-N-methoxy-N-methylurea (metobromuron), (S)-2-chloro-N-(2-ethyl-6-methyl-phenyl)-N-(2-methoxy-1-methyl-ethyl)-acetamide (metolachlor, S-metolachlor), N-(2,6-dichloro-3-methyl-phenyl)-5,7-dimethoxy-1,2,4-triazolo[1,5-a]-pyrimidine-2-sulfonamide (metosulam), N′-(3-chloro-4-methoxy-phenyl)-N,N-dimethyl-urea (metoxuron), 4-amino-6-tert-butyl-3-methylthio-1,2,4-triazin-5(4H)-one (metribuzin), N-(4-methoxy-6-methyl-1,3,5-triazin-2-yl)-N′-(2-methoxycarbonyl-phenylsulfonyl)-urea (metsulfuron-methyl), S-ethyl hexahydro-1H-azepin-1-carbothioate (molinate), 2-(2-naphthyloxy)-N-phenyl-propanamide (naproanilide), N-butyl-N′-(3,4-dichloro-phenyl)-N-methyl-urea (neburon), N-(4,6-dimethoxy-pyrimidin-2-yl)-N′-(3-dimethylcarbamoyl-pyridin-2-yl-sulfonyl)-urea (nicosulfuron), 4-chloro-5-methylamino-2-(3-trifluoromethyl-phenyl)-3(2H)pyridazinone (norflurazon), S-(2-chloro-benzyl) N,N-diethyl-thiocarbamate (orbencarb), 4-dipropylamino-3,5-dinitro-benzenesulfonamide (oryzalin), 3-[2,4-dichloro-5-(2-propinyloxy)-phenyl]-5-(t-butyl)-1,3,4-oxadiazol-2(3H)-one (oxadiargyl), 3-[2,4-dichloro-5-(1-methyl-ethoxy)-phenyl]-5-(t-butyl)-1,3,4-oxadiazol-2(3H)-one (oxadiazon), N-(4,6-dimethyl-pyrimidin-2-yl)-N′-(2-oxetan-3-yl-oxycarbonyl-phenylsulfonyl)-urea (oxasulfuron), 3-[1-(3,5-dichloro-phenyl)-1-i-propyl]-2,3-dihydro-6-methyl-5-phenyl-4H-1,3-oxazin-4-one (oxaziclomefone), 2-chloro-1-(3-ethoxy-4-nitro-phenoxy)-4-trifluoromethyl-benzene (oxyfluorfen), 1,1′-dimethyl-4,4′-bipyridinium (paraquat), 1-amino-N-(1-ethyl-propyl)-3,4-dimethyl-2,6-dinitro-benzene (pendimethalin), 4-(t-butyl)-N-(1-ethyl-propyl)-2,6-dinitro-benzeneamine (pendralin), 3-(4-chloro-5-cyclopentyloxy-2-fluoro-phenyl)-5-(1-methyl-ethylidene)-2,4-oxazolidine-dione (pentoxazone), 4-amino-3,5,6-trichloro-pyridine-2-carboxylic acid (picloram), N-(4-fluoro-phenyl)-6-(3-trifluoromethyl-phenoxy)-pyridine-2-carboxamide (picolinafen), S-[2-(2-methyl-1-piperidinyl)-2-oxo-ethyl] O,O-dipropyl phosphorodithioate (piperophos), 2-chloro-N-(2,6-diethyl-phenyl)-N-(2-propoxy-ethyl)-acetamide (pretilachlor), N-(4,6-bis-difluoromethoxy-pyrimidin-2-yl)-N′-(2-methoxycarbonyl-phenylsulfonyl)-urea (primisulfuron-methyl), 1-chloro-N-[2-chloro-4-fluoro-5-[(6S,7aR)-6-fluoro-tetrahydro-1,3-dioxo-1H-pyrrolo[1,2-c]imidazol-2(3H)-yl]-phenyl]-methanesulfonamide (profluazol), 2-chloro-N-isopropyl-N-phenyl-acetamide (propachlor), N-(3,4-dichloro-phenyl)-propanamide (propanil), (R)-[2-[[(1-methyl-ethylidene)-amino]-oxy]-ethyl]2-[4-(6-chloro-2-quinoxalinyloxy)-phenoxy]-propanoate (propaquizafop), 2-chloro-N-(2-ethyl-6-methyl-phenyl)-N-[(1-methyl-ethoxy)-methyl]-acetamide (propisochlor), methyl 2-[[[(4,5-dihydro-4-methyl-5-oxo-3-propoxy-1H-1,2,4-triazol-1-yl)-carbonyl]-amino]-sulfonyl]-benzoate sodium salt (propoxycarbazone-sodium), S-phenylmethyl-N,N-dipropyl-thiocarbamate (prosulfocarb), N-(4-methoxy-6-methyl-1,3,5-triazin-2-yl)-N′-(2-(3,3,3-trifluoro-propyl)-phenylsulfonyl)-urea (prosulfuron), ethyl [2-chloro-5-(4-chloro-5-difluoromethoxy-1-methyl-1H-pyrazol-3-yl)-4-fluoro-phenoxy]-acetate (pyraflufen-ethyl), 1-(3-chloro-4,5,6,7-tetrahydro-pyrazolo[1,5-a]pyridin-2-yl)-5-(methyl-2-propinylamino)-1H-pyrazole-4-carbonitrile (pyraclonil, pyrazogyl), 4-(2,4-dichloro-benzoyl)-1,3-dimethyl-5-(4-methyl-phenylsulfonyloxy)-pyrazole (pyrazolate), 4-(2,4-dichloro-benzoyl)-1,3-dimethyl-5-(phenylcatbonylmethoxy)-pyrazole (pyrazoxyfen), N-(4,6-dimethoxy-pyrimidin-2-yl)-N′-(4-ethoxycarbonyl-1-methyl-pyrazol-5-yl-sulfonyl)-urea (pyrazosulfuron-ethyl), diphenylmethanone O-[2,6-bis-(4,6-dimethoxy-pyrimidin-2-yl-oxy)-benzoyl]-oxime (pyribenzoxim), O-[3-(1,1-dimethyl-ethyl)-phenyl] (6-methoxy-2-pyridinyl)-methylthiocarbamate (pyributicarb), 6-chloro-3-phenyl-4-pyridazinol (pyridafol), O-(6-chloro-3-phenyl-pyridazin-4-yl) S-octyl-thiocarbonate (pyridate), 6-chloro-3-phenyl-pyridazin-4-ol (pyridatol), 7-[(4,6-dimethoxy-2-pyrimidinyl)-thio]-3-methyl-1(3H)-isobenzofuranone (pyriftalid), methyl 2-(4,6-dimethoxy-pyrimidin-2-yl-oxy)-benzoate (pyriminobac-methyl), 2-chloro-6-(4,6-dimethoxy-pyrimidin-2-ylthio)-benzoic acid sodium salt (pyrithiobac-sodium), 3,7-dichloro-quinoline-8-carboxylic acid (quinchlorac), 7-chloro-3-methyl-quinoline-8-carboxylic acid (quinmerac), 2-[4-(6-chloro-2-quinoxalinyloxy)-phenoxy]-propanoic acid (-ethyl ester, -tetrahydro-2-furanyl-methyl ester) (quizalofop, -ethyl, -P-ethyl, -P-tefuryl), N-(4,6-dimethoxy-pyrimidin-2-yl)-N′-(3-ethylsulfonyl-pyridin-2-yl-sulfonyl)-urea (rimsulfuron), 2-(1-ethoximinobutyl)-5-(2-ethylthiopropyl)-3-hydroxy-2-cyclohexen-1-one (sethoxydim), 6-chloro-2,4-bis-ethylamino-1,3,5-triazine (simazine), 2-(2-chloro-4-methylsulfonyl-benzoyl)-cyclohexane-1,3-dione (sulcotrione), 2-(2,4-dichloro-5-methylsulfonylamino-phenyl)-4-difluoromethyl-5-methyl-2,4-dihydro-3H-1,2,4-triazol-3-one (sulfentrazone), methyl 2-[[[[(4,6-dimethyl-2-pyrimidinyl)-amino]-carbonyl]-amino]-sulfonyl]-benzoate (sulfometuron-methyl), N-phosphonomethyl-glycine-trimethylsulfonium (sulfosate), N-(4,6-dimethoxy-pyrimidin-2-yl)-N′-(2-ethylsulfonyl-imidazo[1,2-a]pyridine-3-sulfonamide (sulfosulfuron), 6-chloro-4-ethylamino-2-tert-butylamino-1,3,5-triazine (terbuthylazine), 2-tert-butylamino-4-ethylamino-6-methylthio-1,3,5-triazine (terbutryn), 2-chloro-N-(2,6-dimethyl-phenyl)-N-(3-methoxy-2-thienyl-methyl)-acetamide (thenylchlor), methyl 2-difluoro-methyl-5-(4,5-dihydro-thiazol-2-yl)-4-(2-methyl-propyl)-6-trifluoromethyl-pyridine-3-carboxylate (thiazopyr), 6-(6,7-dihydro-6,6-dimethyl-3H,5H-pyrrolo[2,1-c]-1,2,4-thiadiazol-3-ylideneamino)-7-fluoro-4-(2-propinyl)-2H-1,4-benzoxazin-3(4H)-one (thidiazimin), N-(4-methoxy-6-methyl-1,3,5-triazin-2-yl)-N′-(2-methoxycarbonyl-thien-3-yl-sulfonyl)-urea (thifensulfuron-methyl), 2-(ethoximino-propyl)-3-hydroxy-5-(2,4,6-trimethyl-phenyl)-2-cyclohexen-1-one (tralkoxydim), S-(2,3,3-trichloro-2-propenyl)diisopropylcarbamothioate (triallate), N-(4-methoxy-6-methyl-1,3,5-triazin-2-yl)-N′-[2-(2-chloro-ethoxy)-phenylsulfonyl]-urea (triasulfuron), N-methyl-N-(4-methoxy-6-methyl-1,3,5-triazin-2-yl)-N′-(2-methoxycarbonyl-phenylsulfonyl)-urea (tribenuron-methyl), (3,5,6-trichloro)-pyridin-2-yl-oxy-acetic acid (triclopyr), 2-(3,5-dichloro-phenyl)-2-(2,2,2-trichloro-ethyl)-oxirane (tridiphane), N-[[(4,6-dimethoxy-2-pyrimidinyl)-amino]-carbonyl]-3-(2,2,2-trifluoro-ethoxy)-2-pyridinesulfonamide sodium salt (trifloxysulfuron), 1-amino-2,6-dinitro-N,N-dipropyl-4-trifluoromethyl-benzene (trifluralin), N-[4-dimethylamino-6-(2,2,2-trifluoro-ethoxy)-1,3,5-triazin-2-yl]-N′-(2-methoxycarbonyl-phenylsulfonyl)-urea (triflusulfuron-methyl), N-(4-methoxy-6-trifluoromethoxy-1,3,5-triazin-2-yl)-N′-(2-trifluoromethyl-phenylsulfonyl)-urea (tritosulfuron), N-[[(4,6-dimethoxy-2-pyrimidinyl)-amino]-carbonyl]-3-(N-methyl-N-methylsulfonyl-amino])-2-pyridinesulfonamide, (cf. WO-A-92/10660), 4-[4,5-dihydro-4-methyl-5-oxo-(3-trifluoromethyl)-1H-1,2,4-triazol-1-yl]-2-[(ethylsulfonyl)amino]-5-fluoro-benzenecarbothioamide (cf WO-A-95/30661)

(“active compounds of group 2”),

and optionally additionally

(c) at least one compound which improves crop plant compatibility, from the group of compounds below:

4-dichloroacetyl-1-oxa-4-aza-spiro[4.5]-decane (AD-67), 1-dichloroacetyl-hexahydro-3,3,8a-trimethylpyrrolo[1,2-a]-pyrimidin-6(2H)-one (BAS-145138), 4-dichloroacetyl-3,4-dihydro-3-methyl-2H-1,4-benzoxazine (benoxacor), 1-methylhexyl 5-chloro-quinoxalin-8-oxy-acetate (cloquintocet-mexyl, α-(cyanomethoximino)-phenylacetonitrile (cyometrinil), 2,4-dichlorophenoxy acetic acid (2,4-D), 2,2-dichloro-N-(2-oxo-2-(2-propenylamino)-ethyl)-N-(2-propenyl)-acetamide (DKA-24), 2,2-dichloro-N,N-di-2-propenyl acetamide (dichlormid), N-(4-methyl-phenyl)-N′-(1-methyl-1-phenyl-ethyl)-urea (dymron), 4,6-dichloro-2-phenyl-pyrimidine (fenclorim), ethyl 1-(2,4-dichloro-phenyl)-5-trichloro-methyl-1H-1,2,4-triazole-3-carboxylate (fenchlorazol-ethyl), phenylmethyl 2-chloro-4-trifluoromethyl-thiazole-5-carboxylate (flurazole), 4-chloro-N-(1,3-dioxolan-2-yl-methoxy)-α-trifluoroacetophenone oxime (fluxofenim), 3-dichloroacetyl-5-(2-furanyl)-2,2-dimethyl-oxazolidine (furilazole, MON-13900), ethyl-4,5-dihydro-5,5-diphenyl-3-isoxazolecarboxylate (isoxadifen-ethyl), (4-chloro-2-methyl-phenoxy)-acetic acid (MCPA), (+-)-2-(4-chloro-2-methylphenoxy)-propionic acid (mecoprop), diethyl 1-(2,4-dichlorophenyl)-4,5-dihydro-5-methyl-1H-pyrazole-3,5-dicarboxylate (mefenpyr-diethyl), 2-dichloromethyl-2-methyl-1,3-dioxolane (MG-191), 1,8-naphthalic anhydride, α-(1,3-dioxolan-2-yl-methoximino)-phenylacetonitrile (oxabetrinil), 2,2-dichloro-N-(1,3-dioxolan-2-yl-methyl)-N-(2-propenyl)-acetamide (PPG-1292), 3-dichloroacetyl-2,2,5-trimethyl-oxazolidine (R-29148), N-cyclopropyl-4-[[(2-methoxy-5-methyl-benzoyl)-amino]-sulfonyl]-benzamide, N-[[(4-methoxyacetylamino)-phenyl]-sulfonyl-2-methoxy-benzamide and N-[[(4-methylaminocarbonylamino)-phenyl]-sulfonyl-2-methoxy-benzamide (the latter each known from WO-A-99/66795)

(“active compounds of group 3”).

Preferred meanings of the groups listed above in connection with the formula (I) are defined below.

m preferably represents the numbers 0, 1, 2, 3 or 4.

A preferably represents a single bond or represents alkanediyl (alkylene) having 1 to 3 carbon atoms.

R¹ preferably represents one of the groupings below

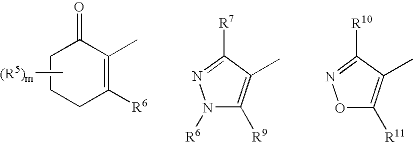

R² preferably represents hydrogen, nitro, cyano, carboxyl, carbamoyl, thiocarbamoyl, fluorine, chlorine, bromine, iodine, or represents in each case optionally cyano-, fluorine-, chlorine-, bromine-, C₁-C₃-alkoxy-, C₁-C₃-alkylthio-, C₁-C₃-alkylsulfinyl- or C₁-C₃-alkylsulfonyl-substituted alkyl, alkoxy, alkylthio, alkylsulfinyl, alkylsulfonyl, alkylamino, dialkylamino or dialkylaminosulfonyl having in each case 1 to 5 carbon atoms in the alkyl groups.

R³ preferably represents hydrogen, nitro, cyano, carboxyl, carbamoyl, thiocarbamoyl, fluorine, chlorine, bromine, iodine, or represents in each case optionally cyano-, fluorine-, chlorine-, bromine-, C₁-C₃-alkoxy-, C₁-C₃-alkylthio-, C₁-C₃-alkylsulfinyl- or C₁-C₃-alkylsulfonyl-substituted alkyl, alkoxy, alkylthio, alkylsulfinyl, alkylsulfonyl, alkylamino, dialkylamino or dialkylaminosulfonyl having in each case 1 to 5 carbon atoms in the alkyl groups.

R⁴ preferably represents one of the heterocyclic groupings below

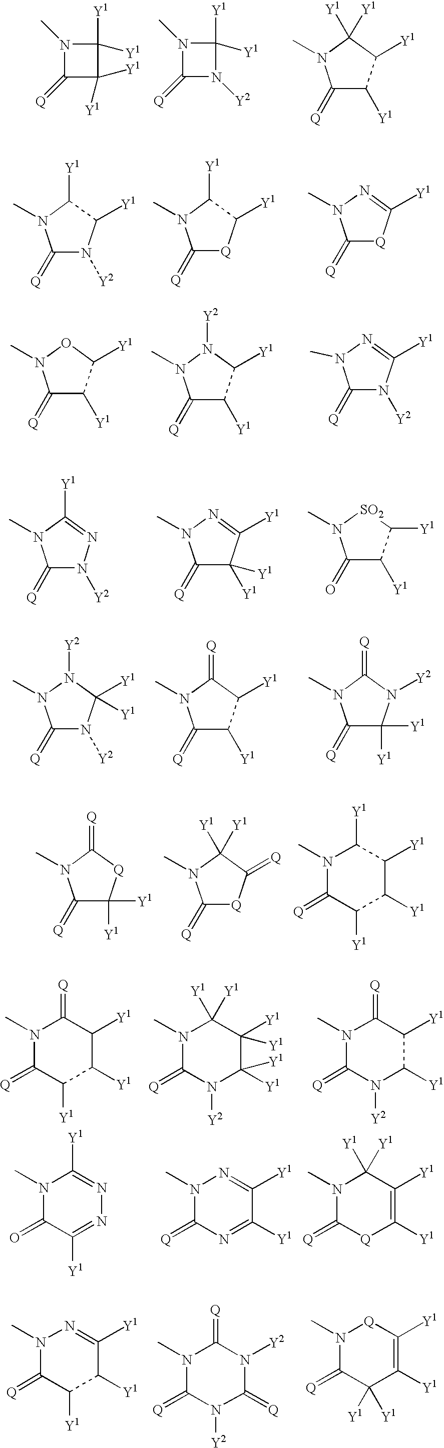

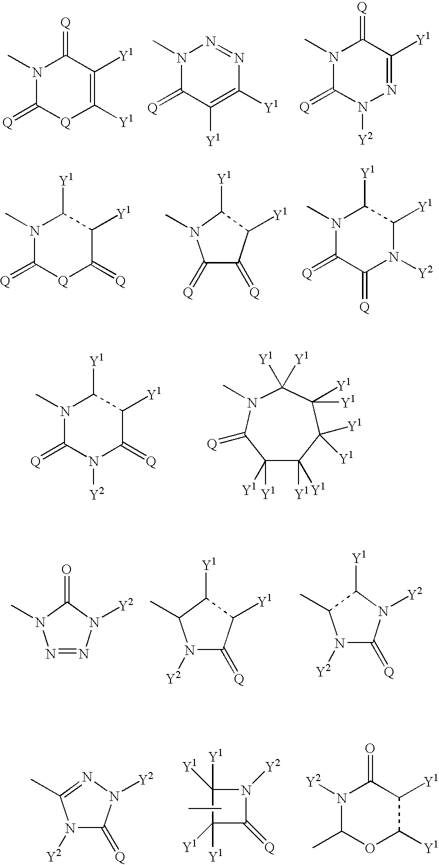

where in each case the broken bond is a single bond or a double bond, and each heterocyclic grouping preferably carries 3, particularly preferably 2 substituents, and very particularly 1 substituent.

Q represents oxygen or sulfur,

Y¹ represents hydrogen, hydroxyl, mercapto, cyano, fluorine, chlorine, bromine, iodine, represents in each case optionally cyano-, fluorine-, chlorine-, bromine-, C₁-C₃-alkoxy-, C₁-C₃-alkylthio-, C₁-C₃-alkylsulfinyl- or C₁-C₃-alkylsulfonyl-substituted alkyl, alkylcarbonyl, alkoxy, alkoxycarbonyl, alkylthio, alkylsulfinyl or alkylsulfonyl having in each case up to 5 carbon atoms in the alkyl groups, represents in each case optionally fluorine- or chlorine-substituted alkylamino or dialkylamino having in each case up to 5 carbon atoms in the alkyl groups, represents in each case optionally fluorine-, chlorine- and/or bromine-substituted alkenyl, alkinyl, alkenyloxy, alkenylthio or alkenylamino having in each case up to 5 carbon atoms in the alkenyl or alkinyl groups, represents in each case optionally fluorine-, chlorine- and/or bromine-substituted cycloalkyl, cycloalkyloxy, cycloalkylthio, cycloalkylamino, cycloalkylalkyl, cycloalkylalkoxy, cycloalkylalkylthio or cycloalkylalkylamino having in each case 3 to 6 carbon atoms in the cycloalkyl groups and optionally up to 3 carbon atoms in the alkyl moiety, or represents in each case optionally fluorine-, chlorine-, bromine-, iodine-, C₁-C₄-alkyl- or C₁-C₄-alkoxy-substituted phenyl, phenyloxy, phenylthio, phenylamino, benzyl, benzyloxy, benzylthio or benzylamino, represents pyrrolidino, piperidino or morpholino, or—if two adjacent radicals Y¹ and Y¹ are located at a double bond—together with the adjacent radical Y¹ also represents a benzo grouping, and

Y² represents hydrogen, hydroxyl, amino, alkylideneamino having up to 4 carbon atoms, represents in each case optionally fluorine-, chlorine-, bromine- or C₁-C₃-alkoxy-substituted alkyl, alkoxy, alkylamino, dialkylamino or alkanoylamino having in each case up to 5 carbon atoms in the alkyl groups, represents in each case optionally fluorine-, chlorine- and/or bromine-substituted alkenyl, alkinyl or alkenyloxy having in each-case up to 5 carbon atoms in the alkenyl or alkinyl groups, represents in each case optionally fluorine-, chlorine- and/or bromine-substituted cycloalkyl, cycloalkylalkyl or cycloalkylamino having in each case 3 to 6 carbon atoms in the cycloalkyl groups and optionally up to 3 carbon atoms in the alkyl moiety, or represents in each case optionally fluorine, chlorine-, bromine-, iodine-, C₁-C₄-alkyl- or C₁-C₄-alkoxy-substituted phenyl or benzyl, or together with an adjacent radical Y¹ or Y² represents optionally halogen- or C₁-C₄-alkyl-substituted alkanediyl having 3 to 5 carbon atoms,

where the individual radicals Y¹ and Y²—if more than one of them, preferably up to three, are attached to the same heterocyclic groupings—can have identical or different meanings within the scope of the above definition.

R⁵ preferably represents fluorine, chlorine, bromine, represents in each case optionally cyano-, fluorine-, chlorine-, bromine- or C₁-C₃-alkoxy-substituted alkyl or alkylthio having in each case 1 to 5 carbon atoms, represents optionally fluorine-, chlorine-, bromine-, C₁-C₄-alkyl- or C₁-C₄-alkoxy-substituted phenyl, or optionally also—if m represents 2—together with a second radical R⁵ represents alkanediyl (alkylene) having 2 to 6 carbon atoms.

R⁶ preferably represents hydroxyl, formyloxy, or represents in each case optionally cyano-, fluorine-, chlorine- or C₁-C₃-alkoxy-substituted alkoxy, alkylthio, alkylsulfinyl, alkylsulfonyl, alkylcarbonyloxy, alkoxycarbonyloxy, alkylaminocarbonyloxy or alkylsulfonyloxy having in each case 1 to 5 carbon atoms in the alkyl groups, represents in each case optionally cyano-, fluorine-, chlorine- and/or bromine-substituted alkenyloxy or alkinyloxy having in each case 3 to 5 carbon atoms, or represents in each case optionally nitro-, cyano-, fluorine-, chlorine-, bromine-, or (in each case fluorine- and/or chlorine-substituted) C₁-C₄-alkyl- or C₁-C₄-alkoxy-substituted phenoxy, phenylthio, phenylsulfinyl, phenylsulfonyl, phenylcarbonyloxy, phenylcarbonylalkoxy, phenylsulfonyloxy, phenylalkoxy, phenylalkylthio, phenylalkylsulfinyl or phenylalkylsulfonyl having optionally 1 to 4 carbon atoms in the alkyl moiety.

R⁷ preferably represents hydrogen, cyano, carbamoyl, thiocarbamoyl, fluorine, chlorine, bromine, represents in each case optionally cyano-, fluorine-, chlorine-, bromine- or C₁-C₃-alkoxy-substituted alkyl, alkoxy, alkylthio, alkylsulfinyl, alkylsulfonyl or alkoxycarbonyl having in each case 1 to 5 carbon atoms in the alkyl groups, or represents optionally cyano-, fluorine-, chlorine, bromine- or C₁-C₃-alkyl-substituted cycloalkyl having 3 to 6 carbon atoms.

R⁸ preferably represents hydrogen, represents in each case optionally cyano-, fluorine-, chlorine-, bromine- or C₁-C₃-alkoxy-substituted alkyl having 1 to 5 carbon atoms, represents in each case optionally cyano-, fluorine-, chlorine- and/or bromine-substituted alkenyl or alkinyl having in each case 3 to 5 carbon atoms, represents in each case optionally cyano-, fluorine-, chlorine-, bromine- or C₁-C₃-alkyl-substituted cycloalkyl or cycloalkylalkyl having in each case 3 to 6 carbon atoms in the cycloalkyl group and optionally 1 to 3 carbon atoms in the alkyl moiety, or represents in each case optionally nitro-, cyano-, fluorine-, chlorine-, bromine-, iodine-, or (in each case optionally fluorine- and/or chlorine-substituted) C₁-C₄-alkyl- or C₁-C₄-alkoxy-substituted phenyl or phenyl-C₁-C₄-alkyl.

R⁹ preferably represents hydroxyl, formyloxy, represents in each case optionally cyano-, fluorine-, chlorine-, bromine- or C₁-C₃-alkoxy-substituted alkoxy, alkylcarbonyloxy, alkoxycarbonyloxy, alkylaminocarbonyloxy or alkylsulfonyloxy having in each case 1 to 5 carbon atoms in the alkyl groups, represents in each case optionally cyano-, fluorine-, chlorine- and/or bromine-substituted alkenyloxy or alkinyloxy having in each case 3 to 5 carbon atoms, or represents in each case optionally nitro-, cyano-, fluorine-, chlorine-, bromine-, iodine-, or (in each case optionally fluorine- and/or chlorine-substituted) C₁-C₄-alkyl- or C₁-C₄-alkoxy-substituted phenylalkoxy, phenylcarbonyloxy, phenylcarbonylalkoxy or phenylsulfonyloxy having optionally 1 to 3 carbon atoms in the alkyl moiety.

R¹⁰ preferably represents hydrogen, cyano, carbamoyl, thiocarbamoyl, fluorine, chlorine, bromine, or represents in each case optionally cyano-, fluorine-, chlorine-, bromine- or C₁-C₃-alkoxy-substituted alkyl, alkylcarbonyl, alkoxy, alkoxycarbonyl, alkylthio, alkylsulfinyl or alkylsulfonyl having in each case 1 to 5 carbon atoms in the alkyl groups.

R¹¹ preferably represents hydrogen, represents optionally cyano-, fluorine-, chlorine-, bromine- or C₁-C₃-alkoxy-substituted alkyl having 1 to 5 carbon atoms or represents optionally cyano-, fluorine-, chlorine-, bromine- or C₁-C₃-alkyl-substituted cycloalkyl having 3 to 6 carbon atoms.

R¹² preferably represents hydrogen, represents optionally cyano-, fluorine-, chlorine-, bromine- or C₁-C₃-alkoxy-substituted alkyl having 1 to 5 carbon atoms or represents optionally cyano-, fluorine-, chlorine-, bromine- or C₁-C₃-alkyl-substituted cycloalkyl having 3 to 6 carbon atoms.

R¹³ preferably represents hydrogen, cyano, carbamoyl, fluorine, chlorine, bromine, or represents in each case optionally cyano-, fluorine-, chlorine-, bromine- or C₁-C₃-alkoxy-substituted alkyl, alkoxy, alkoxycarbonyl, alkylthio, alkylsulfinyl or alkylsulfonyl having in each case 1 to 5 carbon atoms in the alkyl groups.

m particularly preferably represents the numbers 0, 1, 2 or 3.

A particularly preferably represents a single bond or represents methylene, ethane-1,2-diyl (dimethylene), ethane-1,1-diyl, propane-1,2-diyl or propane-1,3-diyl (trimethylene).

R² particularly preferably represents hydrogen, nitro, cyano, carboxyl, carbamoyl, thiocarbamoyl, fluorine, chlorine, bromine, iodine, or represents in each case optionally fluorine-, chlorine-, methoxy-, ethoxy-, n- or i-propoxy-, methylthio-, ethylthio-, n- or i-propylthio-, methylsulfinyl-, ethylsulfinyl-, methylsulfonyl- or ethylsulfonyl-substituted methyl, ethyl, n- or i-propyl, n-, i-, s- or t-butyl, represents in each case optionally fluorine- and/or chlorine-, methoxy-, ethoxy-, n- or i-propoxy-substituted methoxy, ethoxy, n- or i-propoxy, represents in each case optionally fluorine- and/or chlorine-substituted methylthio, ethylthio, n- or i-propylthio, methylsulfinyl, ethylsulfinyl, n- or i-propylsulfinyl, methylsulfonyl, ethylsulfonyl, n- or i-propylsulfonyl, or represents methylamino, ethylamino, n- or i-propylamino, dimethylamino, diethylamino, dimethylaminosulfonyl or diethylamino-sulfonyl.

R³ particularly preferably represents hydrogen, nitro, cyano, carboxyl, carbamoyl, thiocarbamoyl, fluorine, chlorine, bromine, represents in each case optionally fluorine-, chlorine-, methoxy-, ethoxy-, n- or i-propoxy-, methylthio-, ethylthio-, n- or i-propylthio-, methylsulfinyl-, ethylsulfinyl-, methylsulfonyl- or ethylsulfonyl-substituted methyl, ethyl, n- or i-propyl, n-, i-, s- or t-butyl, represents in each case optionally fluorine- and/or chlorine-, methoxy-, ethoxy-, n- or i-propoxy-substituted methoxy, ethoxy, n- or i-propoxy, represents in each case optionally fluorine- and/or chlorine-substituted methylthio, ethylthio, n- or i-propylthio, methylsulfinyl, ethylsulfinyl, n- or i-propylsulfinyl, methylsulfonyl, ethylsulfonyl, n- or i-propylsulfonyl, or represents methylamino, ethylamino, n- or i-propylamino, dimethylamino, diethylamino, dimethylaminosulfonyl or diethylaminosulfonyl.

R⁴ particularly preferably represents one of the heterocyclic groupings below

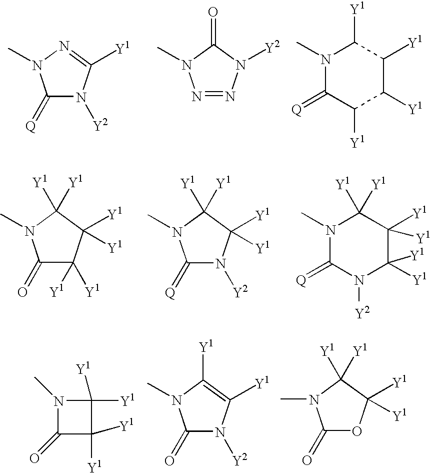

where in each case the broken bond is a single bond or a double bond,

Q preferably represents oxygen,

Y¹ preferably represents hydrogen, hydroxyl, mercapto, cyano, fluorine, chlorine, bromine, iodine, represents in each case optionally fluorine-, chlorine-methoxy-, ethoxy-, n- or i-propoxy-, methylthio-, ethylthio-, n- or i-propylthio-, methylsulfinyl-, ethylsulfinyl-, methylsulfonyl- or ethylsulfonyl-substituted methyl, ethyl, n- or i-propyl, n-, i-, s- or t-butyl, methoxy, ethoxy, n- or i-propoxy, n-, i-, s- or t-butoxy, methylthio, ethylthio, n- or i-propylthio, n-, i-, s- or t-butylthio, methylsulfinyl, ethylsulfinyl, n- or i-propylsulfinyl, methylsulfonyl, ethylsulfonyl, n- or i-propylsulfonyl, represents methylamino, ethylamino, n- or i-propylamino, n-, i-, s- or t-butylamino, dimethylamino, diethylamino, di-n-propylamino or di-i-propylamino, represents in each case optionally fluorine- and/or chlorine-substituted ethenyl, propenyl, butenyl, ethinyl, propinyl, butinyl, propenyloxy, butenyloxy, propenylthio, butenylthio, propenylamino or butenylamino, represents in each case optionally fluorine- and/or chlorine-substituted cyclopropyl, cyclobutyl, cyclopentyl, cyclohexyl, cyclopropyloxy, cyclobutyloxy, cyclopentyloxy, cyclohexyloxy, cyclopropylthio, cyclobutylthio, cyclopentylthio, cyclohexylthio, cyclopropylamino, cyclobutylamino, cyclopentylamino, cyclohexylamino, cyclopropylmethyl, cyclobutylmethyl, cyclopentylmethyl, cyclohexylmethyl, cyclopropylmethoxy, cyclobutylmethoxy, cyclopentylmethoxy, cyclohexylmethoxy, cyclopropylmethylthio, cyclobutylmethylthio, cyclopentylmethylthio, cyclohexylmethylthio, cyclopropylmethylamino, cyclobutylmethylamino, cyclopentylmethylamino or cyclohexylmethylamino, or represents in each case optionally fluorine-, chlorine-, methyl-, ethyl-, n- or i-propyl-, n-, i-, s- or t-butyl-, methoxy-, ethoxy-, n- or i-propoxy-substituted phenyl, phenyloxy, phenylthio, phenylamino, benzyl, benzyloxy, benzylthio or benzylamino, represents pyrrolidino, piperidino or morpholino, or—if two adjacent radicals Y¹ and Y¹ are located at a double bond—together with the adjacent radical Y¹ also represents a benzo grouping.

Y² preferably represents hydrogen, hydroxyl, amino, represents in each case optionally fluorine- and/or chlorine-, methoxy- or ethoxy-substituted methyl, ethyl, n- or i-propyl, n-, i- or s-butyl, methoxy, ethoxy, n- or i-propoxy, methylamino, ethylamino or dimethylamino, represents in each case optionally fluorine- and/or chlorine-substituted ethenyl, propenyl, ethinyl, propinyl or propenyloxy, represents in each case optionally fluorine- and/or chlorine-substituted cyclopropyl, cyclobutyl, cyclopentyl, cyclohexyl, cyclopropylmethyl, cyclobutylmethyl, cyclopentylmethyl, cyclohexylmethyl, or represents in each case optionally fluorine-, chlorine-, methyl-, ethyl-, n- or i-propyl-, n-, i-, s- or t-butyl-, methoxy-, ethoxy-, n- or i-propoxy-substituted phenyl or benzyl, or together with an adjacent radical Y¹ or Y² represents in each case optionally methyl- and/or ethyl-substituted propane-1,3-diyl (trimethylene) or butane-1,4-diyl (tetramethylene).

R⁵ particularly preferably represents fluorine, chlorine, bromine, represents in each case optionally cyano-, fluorine-, chlorine-, methoxy- or ethoxy-substituted methyl, ethyl, n- or i-propyl, n-, i-, s- or t-butyl, methylthio, ethylthio, n- or i-propylthio, represents optionally fluorine-, chlorine-, methyl- or methoxy-substituted phenyl, or optionally also—if m represents 2—together with the second radical R⁵ represents ethane-1,2-diyl (dimethylene), propane-1,3-diyl (trimethylene) or butane-1,4-diyl (tetramethylene).

R⁶ particularly preferably represents hydroxyl, formyloxy, represents in each case optionally cyano-, fluorine-, chlorine-, methoxy- or ethoxy-substituted methoxy, ethoxy, n- or i-propoxy, methylthio, ethylthio, n- or i-propylthio, methylsulfinyl, ethylsulfinyl, methylsulfonyl, ethylsulfonyl, acetyloxy, propionyloxy, n- or i-butyroyloxy, methoxycarbonyloxy, ethoxycarbonyloxy, n- or i-propoxycarbonyloxy, methylaminocarbonyloxy, ethylaminocarbonyloxy, n- or i-propylaminocarbonyloxy, methylsulfonyloxy, ethylsulfonyloxy, n- or i-propylsulfonyloxy, represents in each case optionally cyano-, fluorine-, chlorine- or bromine-substituted propenyloxy, butenyloxy, propinyloxy or butinyloxy, or represents in each case optionally nitro-, cyano-, fluorine-, chlorine-, bromine-, methyl-, ethyl-, n- or i-propyl-, n-, i-, s- or t-butyl-, trifluoromethyl-, methoxy-, ethoxy-, n- or i-propoxy-, difluoromethoxy- or trifluoromethoxy-substituted phenoxy, phenylthio, phenylsulfinyl, phenylsulfonyl, benzoyloxy, benzoylmethoxy, phenylsulfonyloxy, phenylmethoxy, phenylmethylthio, phenylmethylsulfinyl or phenylmethylsulfonyl.

R⁷ particularly preferably represents hydrogen, cyano, carbamoyl, thiocarbamoyl, fluorine, chlorine, bromine, represents in each case optionally cyano-, fluorine-, chlorine-, methoxy- or ethoxy-substituted methyl, ethyl, n- or i-propyl, methoxy, ethoxy, n- or i-propoxy, methylthio, ethylthio, n- or i-propylthio, methylsulfinyl, ethylsulfinyl, methylsulfonyl, ethylsulfonyl, methoxycarbonyl, ethoxycarbonyl, n- or i-propoxycarbonyl, or represents in each case optionally cyano-, fluorine-, chlorine-, bromine-, methyl- or ethyl-substituted cyclopropyl, cyclobutyl, cyclopentyl or cyclohexyl.

R⁸ particularly preferably represents hydrogen, represents in each case optionally cyano-, fluorine-, chlorine-, bromine-, methoxy- or ethoxy-substituted methyl, ethyl, n- or i-propyl, n-, i-, s- or t-butyl, represents in each case optionally cyano-, fluorine-, chlorine- or bromine-substituted propenyl, butenyl, propinyl or butinyl, represents in each case optionally cyano-, fluorine-, chlorine-, bromine-, methyl- or ethyl-substituted cyclopropyl, cyclobutyl, cyclopentyl, cyclohexyl, cyclopropylmethyl, cyclobutylmethyl, cyclopentylmethyl or cyclohexylmethyl, or represents in each case optionally nitro-, cyano-, fluorine-, chlorine-, bromine- methyl-, ethyl-, n- or i-propyl-, n-, i-, s- or t-butyl-, trifluoromethyl-, methoxy-, ethoxy-, n- or propoxy-, difluoromethoxy- or trifluoromethoxy-substituted phenyl or benzyl.

R⁹ particularly preferably represents hydroxyl, formyloxy, represents in each case optionally cyano-, fluorine-, chlorine-, bromine-, methoxy-, ethoxy-, n- or i-propoxy-substituted methoxy, ethoxy, n- or i-propoxy, acetyloxy, propionyloxy, n- or i-butyroyloxy, methoxycarbonyloxy, ethoxycarbonyloxy, n- or i-propoxycarbonyloxy, methylaminocarbonyloxy, ethylaminocarbonyloxy, n- or i-propylaminocarbonyloxy, methylsulfonyloxy, ethylsulfonyloxy, n- or i-propylsulfonyloxy, represents in each case optionally cyano-, fluorine-, chlorine- or bromine-substituted propenyloxy, butenyloxy, propinyloxy or butinyloxy, or represents in each case optionally nitro-, cyano-, fluorine-, chlorine-, bromine-, methyl-, ethyl-, n- or i-propyl-, n-, i-, s- or t-butyl-, trifluoromethyl-, methoxy-, ethoxy-, n- or i-propoxy-, difluoromethoxy- or trifluoromethoxy-substituted phenylmethoxy, benzoyloxy, benzoylmethoxy or phenylsulfonyloxy.

R¹⁰ particularly preferably represents hydrogen, cyano, carbamoyl, thiocarbamoyl, fluorine, chlorine, bromine, or represents in each case optionally cyano-, fluorine-, chlorine-, bromine-, methoxy- or ethoxy-substituted methyl, ethyl, n- or i-propyl, acetyl, propionyl, n- or i-butyroyl, methoxy, ethoxy, n- or i-propoxy, methoxycarbonyl, ethoxycarbonyl, n- or i-propoxycarbonyl, methylthio, ethylthio, n- or i-propylthio, methylsulfinyl, ethylsulfinyl, methylsulfonyl or ethylsulfonyl.

R¹¹ particularly preferably represents hydrogen, represents in each case optionally cyano-, fluorine-, chlorine-, bromine-, methoxy- or ethoxy-substituted methyl, ethyl, n- or i-propyl, or represents in each case optionally cyano-, fluorine-, chlorine-, bromine-, methyl- or ethyl-substituted cyclopropyl.

R¹² particularly preferably represents hydrogen, represents in each case optionally cyano-, fluorine-, chlorine-, bromine-, methoxy- or ethoxy-substituted methyl, ethyl, n- or i-propyl, or represents in each case optionally cyano-, fluorine-, chlorine-, bromine-, methyl- or ethyl-substituted cyclopropyl.

R¹³ particularly preferably represents hydrogen, cyano, carbamoyl, fluorine, chlorine, bromine, or represents in each case optionally cyano-, fluorine-, chlorine-, bromine-, methoxy- or ethoxy-substituted methyl, ethyl, n- or i-propyl, methoxy, ethoxy, n- or i-propoxy, methoxycarbonyl, ethoxycarbonyl, n- or i-propoxycarbonyl, methylthio, ethylthio, n- or i-propylthio, methylsulfinyl, ethylsulfinyl, methylsulfonyl or ethylsulfonyl.

A group of compounds which is very particularly preferred as active compound components of group 1 are those compounds of the formula (I) in which

m represents the numbers 0, 1 or 2,

A represents methylene,

R¹ represents one of the groupings below

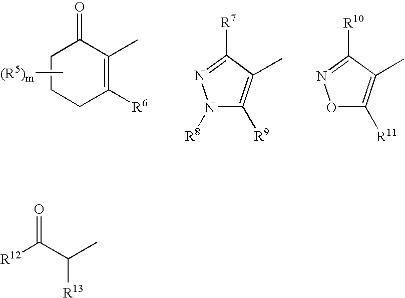

R² represents hydrogen, nitro, cyano, fluorine, chlorine, bromine, iodine, methyl, ethyl, difluoromethyl, trifluoromethyl, dichloromethyl, trichloromethyl, methoxymethyl, methylthiomethyl, methylsulfinylmethyl, methylsulfonylmethyl, methoxy, ethoxy, difluoromethoxy, trifluoromethoxy, methylthio, ethylthio, methylsulfinyl, ethylsulfinyl, methylsulfony, ethylsulfonyl or dimethylaminosulfonyl,

R³ represents hydrogen, nitro, cyano, fluorine, chlorine, bromine, iodine, methyl, ethyl, difluoromethyl, trifluoromethyl, dichloromethyl, trichloromethyl, methoxymethyl, methylthiomethyl, methylsulfinylmethyl, methylsulfonylmethyl, methoxy, ethoxy, difluoromethoxy, trifluoromethoxy, methylthio, ethylthio, methylsulfinyl, ethylsulfinyl, methylsulfony, ethylsulfonyl or dimethylaminosulfonyl,

R⁴ represents the heterocyclic grouping below

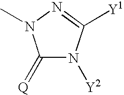

in which

Q represents oxygen or sulfur,

Y¹ represents hydrogen, hydroxyl, mercapto, cyano, fluorine, chlorine, bromine, iodine, represents in each case optionally fluorine-, chlorine-, methoxy-, ethoxy-, n- or i-propoxy-, methylthio-, ethylthio-, methylenesulfinyl-, ethylsulfinyl-, methylsulfonyl- or ethylsulfonyl-substituted methyl, ethyl, n- or i-propyl, methoxy, ethoxy, n- or i-propoxy, methylthio, ethylthio, n- or i-propylthio, methylsulfinyl, ethylsulfinyl, n- or i-propylsulfinyl, methylsulfonyl, ethylsulfonyl, n- or i-propylsulfonyl, represents methylamino, ethylamino, n- or i-propylamino, dimethylamino or diethylamino, represents in each case optionally fluorine- and/or chlorine-substituted ethenyl, propenyl, ethinyl, propinyl, propenyloxy, propenylthio or propenylamino, represents in each case optionally fluorine- and/or chlorine-substituted cyclopropyl, cyclopropyloxy, cyclopropylamino, cyclopropylmethyl, cyclopropylmethoxy or cyclopropylmethylamino, or represents in each case optionally fluorine-, chlorine-, methyl-, ethyl-, n- or i-propyl-, methoxy-, ethoxy-, n- or i-propoxy-substituted phenyl, phenyloxy, phenylthio, phenylamino, benzyl, benzyloxy, benzylthio or benzylamino, or—if two adjacent radicals Y¹ and Y¹ are located at a double bond—together with the adjacent radical Y¹ also represents a benzo grouping, and

Y² represents hydrogen, hydroxyl, amino, represents in each case optionally fluorine- and/or chlorine-, methoxy- or ethoxy-substituted methyl, ethyl, n- or i-propyl, methoxy, ethoxy, n- or i-propoxy, methylamino, ethylamino or dimethylamino, represents propenyl or propinyl, represents in each case optionally fluorine- and/or chlorine-substituted cyclopropyl, cyclobutyl or cyclopropylmethyl, or represents in each case optionally fluorine-, chlorine-, methyl, ethyl-, n- or i-propyl-, methoxy-, ethoxy-, n- or i-propoxy-substituted phenyl or benzyl, or together with an adjacent radical Y¹ or Y² represents in each case optionally methyl- and/or ethyl-substituted propane-1,3-diyl (trimethylene) or butane-1,4-diyl (tetramethylene),

where the individual radicals Y¹ and Y²—if more than one of them are attached to the same heterocyclic groupings—can have identical or different meanings within the scope of the above definition,

R⁵ represents in each case optionally fluorine- or chlorine-substituted methyl, ethyl, n- or i-propyl, methylthio, ethylthio, n- or i-propylthio, represents phenyl, or optionally also—if m represents 2—together with a second radical R⁵ represents ethane-1,2-diyl (dimethylene), propane-1,3-diyl (trimethylene) or butane-1,4-diyl (tetramethylene),

R⁶ represents hydroxyl, formyloxy, represents in each case optionally fluorine-, chlorine-, methoxy- or ethoxy-substituted methoxy, ethoxy, n- or i-propoxy, methylthio, ethylthio, n- or i-propylthio, methylsulfinyl, ethylsulfinyl, methylsulfonyl, ethylsulfonyl, acetyloxy, propionyloxy, n- or i-butyroyloxy, methoxycarbonyloxy, ethoxycarbonyloxy, n- or i-propoxycarbonyloxy, methylaminocarbonyloxy, ethylaminocarbonyloxy, n- or i-propylaminocarbonyloxy, methylsulfonyloxy, ethylsulfonyloxy, n- or i-propylsulfonyloxy, represents propenyloxy or propinyloxy, or represents in each case optionally nitro-, cyano-, fluorine-, chlorine-, bromine-, methyl-, ethyl-, n- or i-propyl-, trifluoromethyl, methoxy-, ethoxy-, n- or i-propoxy-, difluoromethoxy- or trifluoromethoxy-substituted phenoxy, phenylthio, phenylsulfinyl, phenylsulfonyl, benzoyloxy, benzoylmethoxy, phenylsulfonyloxy, phenylmethoxy phenylmethylthio, phenylmethylsulfinyl or phenylmethylsulfonyl,

R⁷ represents hydrogen, cyano, fluorine, chlorine, bromine, represents in each case optionally fluorine-, chlorine-, methoxy- or ethoxy-substituted methyl, ethyl, n- or i-propyl, methoxy, ethoxy, n- or i-propoxy, methylthio, ethylthio, n- or i-propylthio, methylsulfinyl, ethylsulfinyl, n- or i-propylsulfinyl, methylsulfonyl, ethylsulfonyl, n- or i-propylsulfonyl, methoxycarbonyl, ethoxycarbonyl, n- or i-propoxycarbonyl,

R⁸ represents hydrogen, represents in each case optionally cyano-, fluorine-, chlorine-, methoxy- or ethoxy-substituted methyl, ethyl, n- or i-propyl, represents in each case optionally fluorine- or chlorine-substituted propenyl or propinyl, represents optionally fluorine-, chlorine-, bromine-, methyl- or ethyl-substituted cyclopropyl, or represents in each case optionally fluorine-, chlorine-, bromine-, methyl-, ethyl-, n- or i-propyl-, trifluoromethyl-, methoxy-, ethoxy-, n- or i-propoxy-, difluoromethoxy- or trifluoromethoxy-substituted phenyl or benzyl,

R⁹ represents hydroxyl, formyloxy, represents in each case optionally cyano-, fluorine-, chlorine-, bromine-, methoxy-, ethoxy-, n- or i-propoxy-substituted methoxy, ethoxy, n- or i-propoxy, acetyloxy, propionyloxy, n- or i-butyroyloxy, methoxycarbonyloxy, ethoxycarbonyloxy, n- or i-propoxycarbonyloxy, methylaminocarbonyloxy, ethylaminocarbonyloxy, n- or i-propylaminocarbonyloxy, methylsulfonyloxy, ethylsulfonyloxy, n- or i-propylsulfonyloxy, represents propenyloxy or propinyloxy, or represents in each case optionally nitro-, cyano-, fluorine-, chlorine-, bromine-, methyl-, ethyl-, n- or i-propyl-, trifluoromethyl-, methoxy-, ethoxy-, n- or i-propoxy-, difluoromethoxy- or trifluoromethoxy-substituted phenylmethoxy, benzoyloxy, benzoylmethoxy or phenylsulfonyloxy,

R¹⁰ represents hydrogen, cyano, fluorine, chlorine, bromine, or represents in each case optionally fluorine-, chlorine-, methoxy-, ethoxy-, n- or i-propoxy-substituted methyl, ethyl, n- or i-propyl, acetyl, propionyl, n- or i-butyroyl, methoxy, ethoxy, n- or i-propoxy, methoxycarbonyl, ethoxycarbonyl, n- or i-propoxycarbonyl, methylthio, ethylthio, n- or i-propylthio, methylsulfinyl, ethylsulfinyl, methylsulfonyl or ethylsulfonyl,

R¹¹ represents hydrogen, represents in each case optionally fluorine-, chlorine-, bromine-, methoxy- or ethoxy-substituted methyl, ethyl, n- or i-propyl, or represents optionally fluorine-, chlorine-, bromine-, methyl- or ethyl-substituted cyclopropyl,

R¹² represents hydrogen, represents in each case optionally fluorine-, chlorine-, methoxy- or ethoxy-substituted methyl, ethyl, n- or i-propyl, or represents optionally fluorine-, chlorine-, bromine-, methyl- or ethyl-substituted cyclopropyl, and

R¹³ represents hydrogen, cyano, fluorine, chlorine, bromine, or represents in each case optionally fluorine-, chlorine-, bromine-, methoxy- or ethoxy-substituted methyl, ethyl, n- or i-propyl, methoxy, ethoxy, n- or i-propoxy, methoxycarbonyl, ethoxycarbonyl, n- or i-propoxycarbonyl, methylthio, ethylthio, n- or i-propylthio, methylsulfinyl, ethylsulfinyl, n- or i-propylsulfinyl, methylsulfonyl, ethylsulfonyl, n- or i-propylsulfonyl.

A further group which is very particularly preferred as active compound components are those compounds of the formula (I) in which

A, R¹, R² and R³ have the meanings given above as being very particularly preferred and

R⁴ represents one of the heterocyclic groupings below

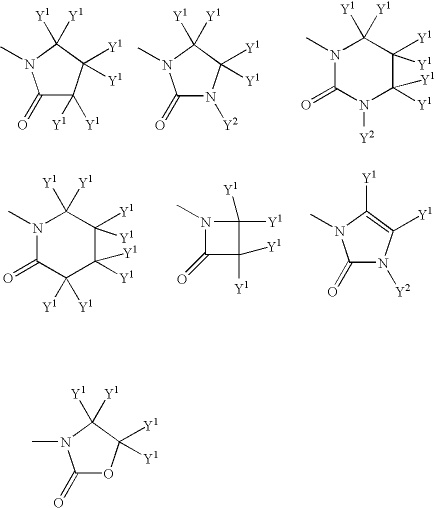

in which

Y¹ represents hydrogen, cyano, fluorine, chlorine, bromine, represents in each case optionally fluorine-, chlorine-, methoxy- or ethoxy-substituted methyl, ethyl, n- or i-propyl, methoxy, ethoxy, n- or i-propoxy, methythio, ethylthio, n- or i-propylthio, methylsulfinyl, ethylsulfinyl, n- or i-propylsulfinyl, methylsulfonyl, ethylsulfonyl, n- or i-propylsulfonyl, represents methylamino, ethylamino, n- or i-propylamino, dimethylamino or diethylamino, represents in each case optionally fluorine- and/or chlorine-substituted ethenyl, propenyl, ethinyl, propinyl, propenyloxy, propenylthio or propenylamino, represents in each case optionally fluorine- and/or chlorine-substituted cyclopropyl, cyclopropyloxy, cyclopropylamino, cyclopropylmethyl, cyclopropylmethoxy or cyclopropylmethylamino, or represents in each case optionally fluorine-, chlorine-, methyl-, ethyl-, n- or i-propyl-, methoxy-, ethoxy-, n- or i-propoxy-substituted phenyl, phenyloxy, phenylthio, phenylamino, benzyl, benzyloxy, benzylthio or benzylamino, or—if two adjacent radicals Y¹ and Y¹ are located at a double bond—together with the adjacent radical Y¹ also represents a benzo grouping, and

Y² represents hydrogen, hydroxyl, arnino, represents in each case optionally fluorine- and/or chlorine-, methoxy- or ethoxy-substituted methyl, ethyl, n- or i-propyl, methoxy, ethoxy, n- or i-propoxy, methylamino, ethylamino or dimethylamino, represents propenyl or propinyl, represents in each case optionally fluorine- and/or chlorine-substituted cyclopropyl, cyclobutyl or cyclopropylmethyl, or represents in each case optionally fluorine-, chlorine-, methyl-, ethyl-, n- or i-propyl-, methoxy-, ethoxy-, n- or i-propoxy-substituted phenyl or benzyl, or together with an adjacent radical Y¹ or Y² represents in each case optionally methyl- and/or ethyl-substituted propane-1,3-diyl (trimethylene) or butane-1,4-diyl (tetramethylene),

where the individual radicals Y¹ and Y²—if a plurality of these radicals is attached to the same heterocyclic groupings—may have identical or different meanings within the scope of the above definition.

Moreover, a group of compounds which is furthermore very particularly preferred as active compound components of group 1 are those compounds of the formula (I) in which

A, R¹, R² and R³ have the meanings given above as being very particulalry preferred and

R⁴ represents the heterocyclic grouping below

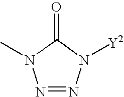

in which

Y² represents hydrogen, hydroxyl, amino, represents in each case optionally fluorine- and/or chlorine-, methoxy- or ethoxy-substituted methyl, ethyl, n- or i-propyl, methoxy, ethoxy, n- or i-propoxy, represents propenyl or propinyl, represents in each case optionally fluorine- and/or chlorine-substituted cyclopropyl, cyclobutyl or cyclopropylmethyl, or represents in each case optionally fluorine-, chlorine-, methyl-, ethyl, n- or i-propyl-, methoxy-, ethoxy-, n- or i-propoxy-substituted phenyl or benzyl.

The compounds of the general formulae (I-A) to (I-C) are particularly emphasized as active compound components of group 1:

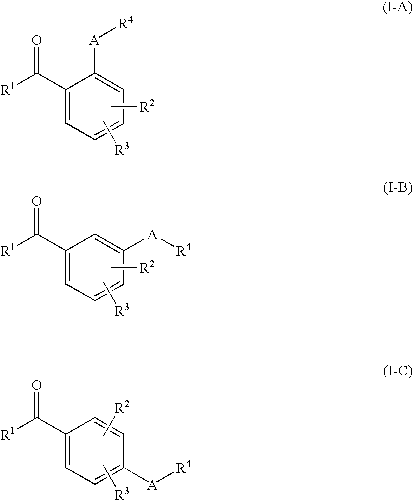

Here, A, R¹, R², R³ and R⁴ each preferably have the meanings given as being very particularly preferred.

Compounds of the general formulae (I-A1) to (I-A4), of the general formulae (I-B1) to (I-B4) and of the general formulae (I-C1) to (I-C4) are furthermore very particularly emphasized as active compound components of the group 1:

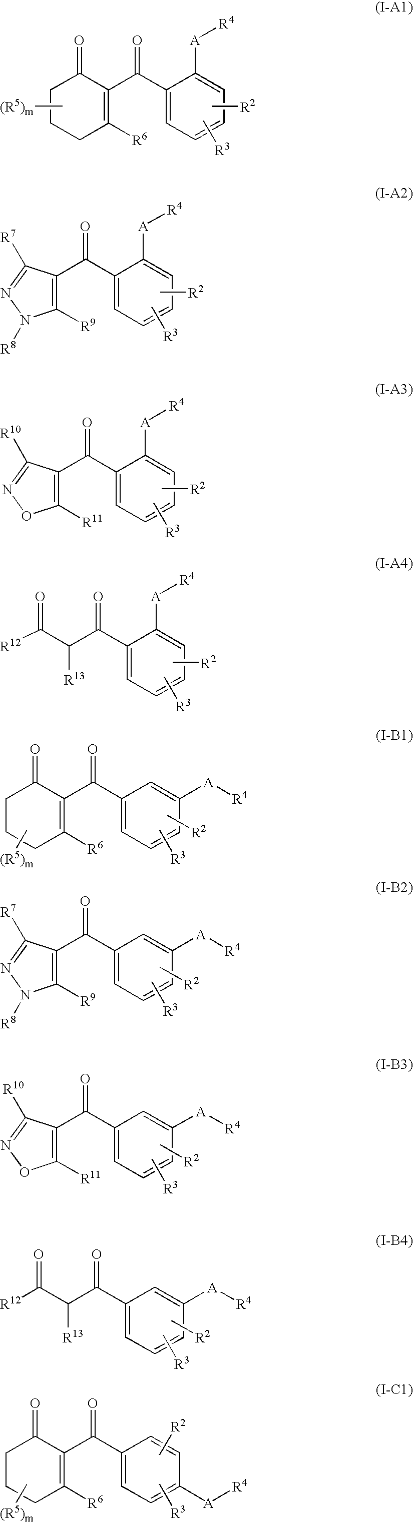

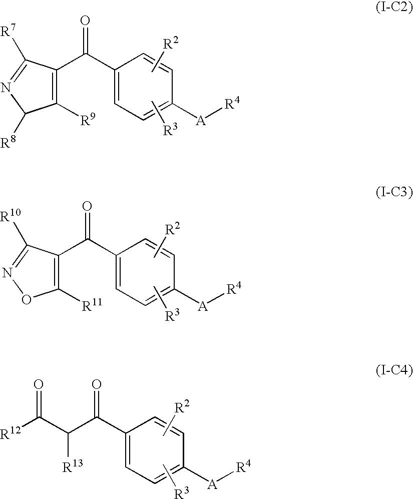

Here, m, A, R², R³, R⁴, R⁵, R⁶, R⁷, R⁸, R⁹, R¹⁰, R¹¹, R¹² and R¹³ preferably have the meanings given above as being very particularly preferred.

Examples of the compounds of the formula (I) which are very particularly preferred as reactive compound components according to the invention are listed in table 1 below.

TABLE 1

| | |
|---|---|
| | (I) |
| 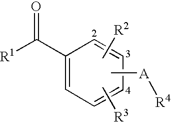 | |

Examples of the active compound components of the formula (I)

| | | | | | |
|---|---|---|---|---|---|
| I-1 | 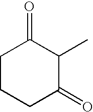 | (2) CH₃ | (4) SO₂CH₃ | 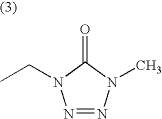 | |
| I-2 | 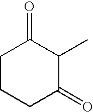 | (2) Cl | (4) Cl | 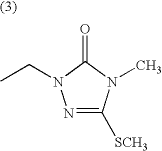 | m.p.: 148° C. |
| I-3 | 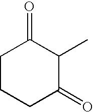 | (2) Cl | (4) Cl | 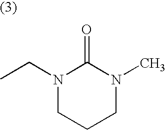 | m.p.: 127° C. |
| I-4 | 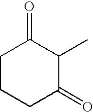 | (2) Cl | (4) Cl | 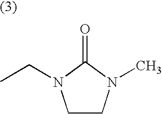 | m.p.: 142° C. |
| I-5 | 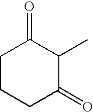 | (4) CF₃ | — | 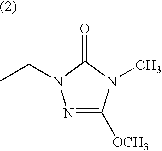 | logP = 2.35^{a)} |
| I-6 | 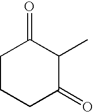 | (2) Cl | (4) Cl | 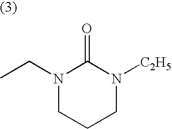 | logP = 2.45^{a)} |
| I-7 | 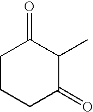 | (2) Cl | (4) Cl | 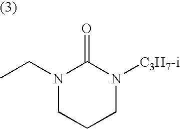 | m.p.: 151° C. |
| I-8 | 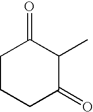 | (2) Cl | (4) SO₂CH₃ | 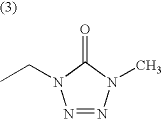 | |
| I-9 | 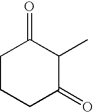 | (2) Cl | (4) SO₂CH₃ | 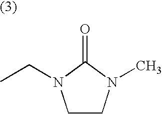 | m.p.: 154° C. |
| I-10 | 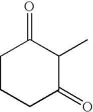 | (2) Cl | (4) SO₂CH₃ | 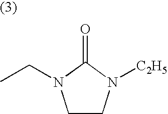 | m.p.: 180° C. |
| I-11 | 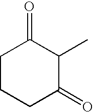 | (2) Cl | (4) SO₂CH₃ | 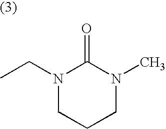 | logP = 1.73^{a)} |
| I-12 | 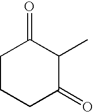 | (2) Cl | (4) SO₂CH₃ | 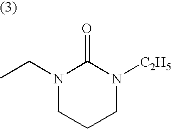 | logP = 1.96^{a)} |
| I-13 | 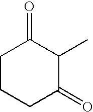 | (2) Cl | (4) SO₂CH₃ | 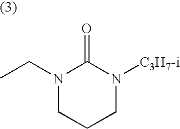 | m.p.: 180° C. |
| I-14 | 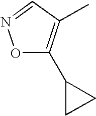 | (2) OCH₃ | (4) Cl | 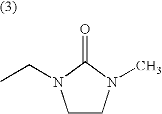 | logP = 2.46^{a)} |
| I-15 | 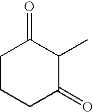 | (4) CF₃ | — | 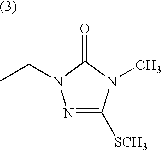 | logP = 2.59^{a)} |
| I-16 | 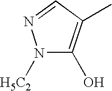 | (4) CF₃ | — | 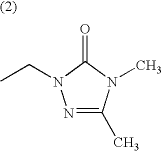 | m.p.: 121° C. |

The logP values given in table 1 were determined in accordance with EEC directive 79/831 Annex V.A8 by HPLC (High Performance Liquid Chromatography) using a reverse-phase column (C 18). Temperature: 43° C.

(a) Mobile phases for the determination in the acidic range: 0.1% aqueous phosphoric acid, acetonitrile; linear gradient from 10% acetonitrile to 90% acetonitrile—the corresponding data in table 1 are marked ^{a)}.

(b) Mobile phases for the determination in the neutral range: 0.01 molar aqueous phosphate buffer solution, acetonitrile; linear gradient from 10% acetonitrile to 90% acetonitrile—the corresponding data in table 1 are marked ^{b)}.

Calibration was carried out using unbranched alkan-2-ones (having 3 to 16 carbon atoms) with known logP values (determination of the logP values by the retention times using linear interpolation between two successive alkanones).

The lambda max values were determined in the maxima of the chromatographic signals using the UV spectra from 200 nm to 400 nm.

The compounds of the formula (I) are described in the abovementioned patent applications for substituted aryl ketones.

According to their chemical structure, the active compounds of group 2 can be assigned to the following classes of active compounds:

amides (for example isoxaben, picolinafen, propanil), arylheterocycles (for example azafenidin, benzfendizone, butafenacil-allyl, carfentrazone-ethyl, cinidon-ethyl, fluazolate, flumiclorac-pentyl, flumioxazin, flupropacil, fluthiacet-methyl, oxadiazon, oxadiargyl, profluazol, pyraflufen-ethyl, pyridate, pyridafol, sulfentrazone, thidiazimin, 4-[4,5-dihydro-4-methyl-5-oxo-(3-trifluoromethyl)-1H-1,2,4-triazol-1-yl]-2-[(ethylsulfonyl)amino]-5-fluoro-benzenecarbothioamide), aryloxyphenoxypropionates (for example clodinafop-propargyl, cyhalofop-butyl, diclofop-methyl, fenoxaprop-P-ethyl, fluazifop-P-butyl, haloxyfop-R-methyl, quizalofop-P-ethyl), carboxylic acid derivatives (for example clopyralid, dicamba, fluroxypyr, picloram, triclopyr), benzothiadiazoles (for example bentazon), chloroacetamides (for example acetochlor, alachlor, butachlor, (S-) dimethenamid, metazachlor, metolachlor, pretilachlor, propachlor, propisochlor), cyclohexanediones (for example butroxydim, clefoxydim, cycloxydim, sethoxydim, tralkoxydim), dinitroanilines (for example benfluralin, ethalfluralin, oryzalin, pendimethalin, trifluralin), diphenyl ethers (for example acifluorfen-sodium, aclonifen, bifenox, fluoroglycofen-ethyl, fomesafen, lactofen, oxyfluorfen), ureas (for example chlortoluron, diuron, isoproturon, linuron, metobromuron, metoxuron), imidazolinones (for example imazamethabenz-methyl, imazamox, imazaquin, imazethapyr), isoxazoles (for example isoxaflutole), nicotinanilides (for example diflufenican), nitriles (for example bromoxynil, ioxynil), organophosphorus compounds (for example anilofos, glufosinate-ammonium, glyphosate-isopropylammonium, sulfosate), oxyacetamides (for example flufenacet, mefenacet), phenoxycarboxylic acid derivatives (for example 2,4-D, dichlorprop-P, MCPA, MCPB, mecoprop), pyrazoles (for example pyrazolate, pyrazoxyfen), pyridazinones (for example norflurazon), pyridines (for example dithiopyr, thiazopyr), pyrimidinyl(thio)benzoates (for example bispyribac, pyribenzoxim, pyrithiobac, pyriminobac), sulfonylureas (for example amidosulfuron, azimsulfuron, bensulfuron-methyl, chlorimuron-ethyl, chlorsulfuron, cinosulfuron, cyclosulfamuron, ethoxysulfuron, flupyrsulfuron-methyl-sodium, foramsulfuron, iodosulfuron-methyl-sodium, imazosulfuron, metsulfuron-methyl, nicosulfuron, oxasulfuron, primisulfuron-methyl, prosulfuron, pyrazosulfuron-ethyl, rimsulfuron, sulfometuron-methyl, sulfosulfuron, thifensulfuron-methyl, triasulfuron, tribenuron-methyl, trifloxysulfuron, triflusulfuron-methyl, tritosulfuron), tetrazolinones (for example fentrazamide), thiocarbamates (for example butylate, dimepiperate, EPTC, esprocarb, molinate, orbencarb, prosulfocarb, triallate), triazines (for example ametryn, atrazin, cyanazine, dimexyflam, simazin, terbuthylazine, terbutryn), triazinones (for example hexazinone, metamitron, metribuzin), triazoles (for example amitrole), triazolinones (for example amicarbazone, flucarbazone-sodium, propoxycarbazone-sodium), triazolopyrimidines (for example cloransulam-methyl, diclosulam, florasulam, flumetsulam, metosulam), triketones (for example mesotrione, sulcotrione), uracils (for example bromacil).

Mixing components from the active compounds of group 2 which are particularly emphasized are:

acetochlor, alachlor, amicarbazone, amidosulfuron, anilofos, atrazin, azimsulfuron, benfuresate, bensulfuron-methyl, bentazone, benthiocarb (thiobencarb), benzobicyclon, benzofenap, bispyrbac-sodium, bromobutide, butachlor, cafenstrole, carfentrazone-ethyl, chlomethoxyfen, cinmethylin, cinosulfuron, clefoxydim, clodinafop-propargyl, clomeprop, cumyluron, cyanazine, cyclosulfamuron, cyhalofop-butyl, 2,4-D, dichlorprop-P, dimepiperate, dimethametryn, dimethenamid, S-dimethenamid, dithiopyr, dymron, esprocarb, ethoxysulfuron, etobenzanid, fenoxaprop-P-ethyl, fentrazamide, fluazifop-P-butyl, flucarbazone-sodium, flufenacet, flumetsulam, haloxyfop-P-methyl, imazamox, imazaquin, imazethapyr, imazosulfuron, isoxaflutole, MCPA, mefenacet, mesosulfuron, mesotrione, metolachlor, S-metolachlor, metosulam, metsulfuron-methyl, metribuzin, molinate, naproanilide, nicosulfuron, oxadiargyl, oxadiazon, oxaziclomefone, oxyfluorfen, pendimethalin, pentoxazone, piperophos, pretilachlor, propanil, propoxycarbazone-sodium, pyraclonil, pyrazolate, pyrazosulfuron-ethyl, pyrazoxyfen, pyribenzoxim, pyributicarb, pyriminobac-methyl, qinclorac, simazin, simetryn, sulcotrione, terbuthylazine, thenylchlor, thifensulfuron-methyl, tritosulfuron.

Mixing components from the active compounds of group 3 which are particularly emphasized are: cloquintocet-mexyl, isoxadifen-ethyl, mefenpyr-diethyl, AD-67, BAS-145138, benoxacor, dichlormid, furilazole, MON-13900 and R-29148.

The compositions according to the invention preferably comprise one or two active compounds of group 1, one to three active compounds of group 2 and optionally one active compound of group 3.

The compositions according to the invention in particular comprise one active compound of group 1, one or two active compounds of group 2 and optionally one active compound of group 3.

Examples of combinations according to the invention of in each case one active compound of group 1 and one or two active compounds of group 2—or of in each case one active compound of group 1, one or two active compounds of group 2 and one active compound of group 3—are listed below in table 2. Here, the names of the active compounds of the formula (I) (active compounds of group 1) are in each case taken from table 1.

TABLE 2
Examples of combinations comprising one
active compound of group 1 and
one active compound of group 2

| Active compound | Active compound |
|---|---|
| group 1 | group 2 |
| (I-1) | acetochlor |
| (I-1) | alachlor |
| (I-1) | amicarbazone |
| (I-1) | amidosulfuron |
| (I-1) | anilofos |
| (I-1) | atrazin |
| (I-1) | azimsulfuron |
| (I-1) | benfuresate |
| (I-1) | bensulfuron-methyl |
| (I-1) | bentazone |
| (I-1) | benthiocarb (thiobencarb) |
| (I-1) | benzobicyclon |
| (I-1) | benzofenap |
| (I-1) | bispyrbac-sodium |
| (I-1) | bromobutide |
| (I-1) | butachlor |
| (I-1) | cafenstrole |
| (I-1) | carfentrazone-ethyl |
| (I-1) | chlomethoxyfen |
| (I-1) | cinmethylin |
| (I-1) | cinosulfuron |
| | clefoxydim |
| (I-1) | clodinafop-propargyl |
| (I-1) | clomeprop |
| (I-1) | cumyluron |
| (I-1) | cyanazine |
| (I-1) | cyclosulfamuron |
| (I-1) | cyhalofop-butyl |
| (I-1) | 2,4-D |
| (I-1) | dichlorprop-P |
| (I-1) | dimepiperate |
| (I-1) | dimethametryn |
| (I-1) | dimethenamid |
| (I-1) | S-dimethenamid |
| (I-1) | dithiopyr |
| (I-1) | dymron |
| (I-1) | esprocarb |
| (I-1) | ethoxysulfuron |
| (I-1) | etobenzanid |
| (I-1) | fenoxaprop-P-ethyl |
| (I-1) | fentrazamide |
| (I-1) | fluazifop-P-butyl |
| (I-1) | flucarbazone-sodium |
| (I-1) | flufenacet |
| (I-1) | flumetsulam |
| (I-1) | haloxyfop-P-methyl |
| (I-1) | imazamox |
| (I-1) | imazaquin |
| (I-1) | imazethapyr |
| (I-1) | imazosulfuron |
| (I-1) | isoxaflutole |
| (I-1) | MCPA |
| (I-1) | mefenacet |
| (I-1) | mesosulfuron |
| (I-1) | mesotrione |
| (I-1) | metolachlor |
| (I-1) | S-metolachlor |
| (I-1) | metosulam |
| (I-1) | metsulfuron-methyl |
| (I-1) | metribuzin |
| (I-1) | molinate |
| (I-1) | naproanilide |
| (I-1) | nicosulfuron |
| (I-1) | oxadiargyl |
| (I-1) | oxadiazon |
| (I-1) | oxaziclomefone |
| (I-1) | oxyfluorfen |
| (I-1) | pendimethalin |
| (I-1) | pentoxazone |
| (I-1) | pentoxazone |
| (I-1) | piperophos |
| (I-1) | pretilachlor |
| (I-1) | propanil |
| (I-1) | propoxycarbazone-sodium |
| (I-1) | pyraclonil |
| (I-1) | pyrazolate |
| (I-1) | pyrazosulfuron-ethyl |
| | tritosulfuron |
| (I-1) | pyrazoxyfen |
| (I-1) | pyribenzoxim |
| (I-1) | pyributicarb |
| (I-1) | pyriminobac-methyl |
| (I-1) | qinclorac |
| (I-1) | simazin |
| (I-1) | simetryn |
| (I-1) | sulcotrione |
| (I-1) | terbuthylazine |
| (I-1) | thenylchlor |
| (I-1) | thifensulfuron-methyl |
| (I-1) | tritosulfuron |
| (I-2) | acetochlor |
| (I-2) | alachlor |
| (I-2) | amicarbazone |
| (I-2) | amidosulfuron |
| (I-2) | anilofos |
| (I-2) | atrazin |
| (I-2) | azimsulfuron |
| (I-2) | benfuresate |
| (I-2) | bensulfuron-methyl |
| (I-2) | bentazone |
| (I-2) | benthiocarb (thiobencarb) |
| (I-2) | benzobicyclon |
| (I-2) | benzofenap |
| (I-2) | bispyrbac-sodium |
| (I-2) | bromobutide |
| (I-2) | butachlor |
| (I-2) | cafenstrole |
| (I-2) | carfentrazone-ethyl |
| (I-2) | chlomethoxyfen |
| (I-2) | cinmethylin |
| (I-2) | cinosulfuron |
| (I-2) | clefoxydim |
| (I-2) | clodinafop-propargyl |
| (I-2) | clomeprop |
| (I-2) | cumyluron |
| (I-2) | cyanazine |
| (I-2) | cyclosulfamuron |
| (I-2) | cyhalofop-butyl |
| (I-2) | 2,4-D |
| (I-2) | dichlorprop-P |
| (I-2) | dimepiperate |
| (I-2) | dimethametryn |
| (I-2) | dimethenamid |
| (I-2) | S-dimethenamid |
| (I-2) | dithiopyr |
| (I-2) | dymron |
| (I-2) | esprocarb |
| (I-2) | ethoxysulfuron |
| (I-2) | etobenzanid |
| (I-2) | fenoxaprop-P-ethyl |
| (I-2) | fentrazamide |
| (I-2) | fluazifop-P-butyl |
| (I-2) | flucarbazone-sodium |
| (I-2) | flufenacet |
| (I-2) | flumetsulam |
| (I-2) | haloxyfop-P-methyl |
| (I-2) | imazamox |
| (I-2) | imazaquin |
| (I-2) | imazethapyr |
| (I-2) | imazosulfuron |
| (I-2) | isoxaflutole |
| (I-2) | MCPA |
| (I-2) | mefenacet |
| (I-2) | mesosulfuron |
| (I-2) | mesotrione |
| (I-2) | metolachlor |
| (I-2) | S-metolachlor |
| (I-2) | metosulam |
| (I-2) | metsulfuron-methyl |
| (I-2) | metribuzin |
| (I-2) | molinate |
| (I-2) | naproanilide |
| (I-2) | nicosulfuron |
| (I-2) | oxadiargyl |
| (I-2) | oxadiazon |
| (I-2) | oxaziclomefone |
| (I-2) | oxyfluorfen |
| (I-2) | pendimethalin |
| (I-2) | pentoxazone |
| (I-2) | pentoxazone |
| (I-2) | piperophos |
| (I-2) | pretilachlor |
| (I-2) | propanil |
| (I-2) | propoxycarbazone-sodium |
| (I-2) | pyraclonil |
| (I-2) | pyrazolate |
| (I-2) | pyrazosulfuron-ethyl |
| | tritosulfuron |
| (I-2) | pyrazoxyfen |
| (I-2) | pyribenzoxim |
| (I-2) | pyributicarb |
| (I-2) | pyriminobac-methyl |
| (I-2) | qinclorac |
| (I-2) | simazin |
| (I-2) | simetryn |
| (I-2) | sulcotrione |
| (I-2) | terbuthylazine |
| (I-2) | thenylchlor |
| (I-2) | thifensulfuron-methyl |
| (I-2) | tritosulfuron |
| (I-3) | acetochlor |
| (I-3) | alachlor |
| (I-3) | amicarbazone |
| (I-3) | amidosulfuron |
| (I-3) | anilofos |
| (I-3) | atrazin |
| (I-3) | azimsulfuron |
| (I-3) | benfuresate |
| (I-3) | bensulfuron-methyl |
| (I-3) | bentazone |
| (I-3) | benthiocarb (Thiobencarb) |
| (I-3) | benzobicyclon |
| (I-3) | benzofenap |
| (I-3) | bispyrbac-sodium |
| (I-3) | bromobutide |
| (I-3) | butachlor |
| (I-3) | cafenstrole |
| (I-3) | carfentrazone-ethyl |
| (I-3) | chlomethoxyfen |
| (I-3) | cinmethylin |
| (I-3) | cinosulfuron |
| (I-3) | clefoxydim |
| (I-3) | clodinafop-propargyl |
| (I-3) | clomeprop |
| (I-3) | cumyluron |
| (I-3) | cyanazine |
| (I-3) | cyclosulfamuron |
| (I-3) | cyhalofop-butyl |
| (I-3) | 2,4-D |
| (I-3) | dichlorprop-P |
| (I-3) | dimepiperate |
| (I-3) | dimethametryn |
| (I-3) | dimethenamid |
| (I-3) | S-dimethenamid |
| (I-3) | dithiopyr |
| (I-3) | dymron |
| (I-3) | esprocarb |
| (I-3) | ethoxysulfuron |
| (I-3) | etobenzanid |
| (I-3) | fenoxaprop-P-ethyl |
| (I-3) | fentrazamide |
| (I-3) | fluazifop-P-butyl |
| (I-3) | flucarbazone-sodium |
| (I-3) | flufenacet |
| (I-3) | flumetsulam |
| (I-3) | haloxyfop-P-methyl |
| (I-3) | imazamox |
| (I-3) | imazaquin |
| (I-3) | imazethapyr |
| (I-3) | imazosulfuron |
| (I-3) | isoxaflutole |
| (I-3) | MCPA |
| (I-3) | mefenacet |
| (I-3) | mesosulfuron |
| (I-3) | mesotrione |
| (I-3) | metolachlor |
| (I-3) | S-metolachlor |
| (I-3) | metosulam |
| (I-3) | metsulfuron-methyl |
| (I-3) | metribuzin |
| (I-3) | molinate |
| (I-3) | naproanilide |
| (I-3) | nicosulfuron |
| (I-3) | oxadiargyl |
| (I-3) | oxadiazon |
| (I-3) | oxaziclomefone |
| (I-3) | oxyfluorfen |
| (I-3) | pendimethalin |
| (I-3) | pentoxazone |
| (I-3) | pentoxazone |
| (I-3) | piperophos |
| (I-3) | pretilachlor |
| (I-3) | propanil |
| (I-3) | propoxycarbazone-sodium |
| (I-3) | pyraclonil |
| (I-3) | pyrazolate |
| (I-3) | pyrazosulfuron-ethyl |
| | tritosulfuron |
| (I-3) | pyrazoxyfen |
| (I-3) | pyribenzoxim |
| (I-3) | pyributicarb |
| (I-3) | pyriminobac-methyl |
| (I-3) | qinclorac |
| (I-3) | simazin |
| (I-3) | simetryn |
| (I-3) | sulcotrione |
| (I-3) | terbuthylazine |
| (I-3) | thenylchlor |
| (I-3) | thifensulfuron-methyl |
| (I-3) | tritosulfuron |
| (I-4) | acetochlor |
| (I-4) | alachlor |
| (I-4) | amicarbazone |
| (1-4) | amidosulfuron |
| (I-4) | anilofos |
| (I-4) | atrazin |
| (I-4) | azimsulfuron |
| (I-4) | benfuresate |
| (I-4) | bensulfuron-methyl |
| (I-4) | bentazone |
| (I-4) | benthiocarb (thiobencarb) |
| (I-4) | benzobicyclon |
| (I-4) | benzofenap |
| (I-4) | bispyrbac-sodium |
| (I-4) | bromobutide |
| (I-4) | butachlor |
| (I-4) | cafenstrole |
| (I-4) | carfentrazone-ethyl |
| (I-4) | chlomethoxyfen |
| (I-4) | cinmethylin |
| (I-4) | cinosulfuron |
| (I-4) | clefoxydim |
| (I-4) | clodinafop-propargyl |
| (I-4) | clomeprop |
| (I-4) | cumyluron |
| (I-4) | cyanazine |
| (I-4) | cyclosulfamuron |
| (I-4) | cyhalofop-butyl |
| (I-4) | 2,4-D |
| (I-4) | dichlorprop-P |
| (I-4) | dimepiperate |
| (I-4) | dimethametryn |
| (I-4) | dimethenamid |
| (I-4) | S-dimethenamid |
| (I-4) | dithiopyr |
| (I-4) | dymron |
| (I-4) | esprocarb |
| (I-4) | ethoxysulfuron |
| (I-4) | etobenzanid |
| (I-4) | fenoxaprop-P-ethyl |
| (I-4) | fentrazamide |
| (I-4) | fluazifop-P-butyl |
| (I-4) | flucarbazone-sodium |
| (I-4) | flufenacet |
| (I-4) | flumetsulam |
| (I-4) | haloxyfop-P-methyl |
| (I-4) | imazamox |
| (I-4) | imazaquin |
| (I-4) | imazethapyr |
| (I-4) | imazosulfuron |
| (I-4) | isoxaflutole |
| (I-4) | MCPA |
| (I-4) | mefenacet |
| (I-4) | mesosulfuron |
| (I-4) | mesotrione |
| (I-4) | metolachlor |
| (I-4) | S-metolachlor |
| (I-4) | metosulam |
| (I-4) | metsulfuron-methyl |
| (I-4) | metribuzin |
| (I-4) | molinate |
| (I-4) | naproanilide |
| (I-4) | nicosulfuron |
| (I-4) | oxadiargyl |
| (I-4) | oxadiazon |
| (I-4) | oxaziclomefone |
| (I-4) | oxyfluorfen |
| (I-4) | pendimethalin |
| (I-4) | pentoxazone |
| (I-4) | pentoxazone |
| (I-4) | piperophos |
| (I-4) | pretilachlor |
| (I-4) | propanil |
| (I-4) | propoxycarbazone-sodium |
| (I-4) | pyraclonil |
| (I-4) | pyrazolate |
| (I-4) | pyrazosulfuron-ethyl |
| | tritosulfuron |
| (I-4) | pyrazoxyfen |
| (I-4) | pyribenzoxim |
| (I-4) | pyributicarb |
| (I-4) | pyriminobac-methyl |
| (I-4) | qinclorac |
| (I-4) | simazin |
| (I-4) | simetryn |
| (I-4) | sulcotrione |
| (I-4) | terbuthylazine |
| (I-4) | thenylchlor |
| (I-4) | thifensulfuron-methyl |
| (I-4) | tritosulfuron |
| (I-5) | acetochlor |
| (I-5) | alachlor |
| (I-5) | amicarbazone |
| (I-5) | amidosulfuron |
| (I-5) | anilofos |
| (I-5) | atrazin |
| (I-5) | azimsulfuron |
| (I-5) | benfuresate |
| (I-5) | bensulfuron-methyl |
| (I-5) | bentazone |
| (I-5) | benthiocarb (thiobencarb) |
| (I-5) | benzobicyclon |
| (I-5) | benzofenap |
| (I-5) | bispyrbac-sodium |
| (I-5) | bromobutide |
| (I-5) | butachlor |
| (I-5) | cafenstrole |
| (I-5) | carfentrazone-ethyl |
| (I-5) | chlomethoxyfen |
| (I-5) | cinmethylin |
| (I-5) | cinosulfuron |
| (I-5) | clefoxydim |
| (I-5) | clodinafop-propargyl |
| (I-5) | clomeprop |
| (I-5) | cumyluron |
| (I-5) | cyanazine |
| (I-5) | cyclosulfamuron |
| (I-5) | cyhalofop-butyl |
| (I-5) | 2,4-D |
| (I-5) | dichlorprop-P |
| (I-5) | dimepiperate |
| (I-5) | dimethametryn |
| (I-5) | dimethenamid |
| (I-5) | S-dimethenamid |
| (I-5) | dithiopyr |
| (I-5) | dymron |
| (I-5) | esprocarb |
| (I-5) | ethoxysulfuron |
| (I-5) | etobenzanid |
| (I-5) | fenoxaprop-P-ethyl |
| (I-5) | fentrazamide |
| (I-5) | fluazifop-P-butyl |
| (I-5) | flucarbazone-sodium |
| (I-5) | flufenacet |
| (I-5) | flumetsulam |
| (I-5) | haloxyfop-P-methyl |
| (I-5) | imazamox |
| (I-5) | imazaquin |
| (I-5) | imazethapyr |
| (I-5) | imazosulfuron |
| (I-5) | isoxaflutole |
| (I-5) | MCPA |
| (I-5) | mefenacet |
| (I-5) | mesosulfuron |
| (I-5) | mesotrione |
| (I-5) | metolachlor |
| (I-5) | S-metolachlor |
| (I-5) | metosulam |
| (I-5) | metsulfuron-methyl |
| (I-5) | metribuzin |
| (I-5) | molinate |
| (I-5) | naproanilide |
| (I-5) | nicosulfuron |
| (I-5) | oxadiargyl |
| (I-5) | oxadiazon |
| (I-5) | oxaziclomefone |
| (I-5) | oxyfluorfen |
| (I-5) | pendimethalin |
| (I-5) | pentoxazone |
| (I-5) | pentoxazone |
| (I-5) | piperophos |
| (I-5) | pretilachlor |
| (I-5) | propanil |
| (I-5) | propoxycarbazone-sodium |
| (I-5) | pyraclonil |
| (I-5) | pyrazolate |
| (I-5) | pyrazosulfuron-ethyl |
| | tritosulfuron |
| (I-5) | pyrazoxyfen |
| (I-5) | pyribenzoxim |
| (I-5) | pyributicarb |
| (I-5) | pyriminobac-methyl |
| (I-5) | qinclorac |
| (I-5) | simazin |
| (I-5) | simetryn |
| (I-5) | sulcotrione |
| (I-5) | terbuthylazine |
| (I-5) | thenylchlor |
| (I-5) | thifensulfuron-methyl |
| (I-5) | tritosulfuron |
| (I-6) | acetochlor |
| (I-6) | alachlor |
| (I-6) | amicarbazone |
| (I-6) | amidosulfuron |
| (I-6) | anilofos |
| (I-6) | atrazin |
| (I-6) | azimsulfuron |
| (I-6) | benfuresate |
| (I-6) | bensulfuron-methyl |
| (I-6) | bentazone |
| (I-6) | benthiocarb (thiobencarb) |
| (I-6) | benzobicyclon |
| (I-6) | benzofenap |
| (I-6) | bispyrbac-sodium |
| (I-6) | bromobutide |
| (I-6) | butachlor |
| (I-6) | cafenstrole |
| (I-6) | carfentrazone-ethyl |
| (I-6) | chlomethoxyfen |
| (I-6) | cinmethylin |
| (I-6) | cinosulfuron |
| (I-6) | clefoxydim |
| (I-6) | clodinafop-propargyl |
| (I-6) | clomeprop |
| (I-6) | cumyluron |
| (I-6) | cyanazine |
| (I-6) | cyclosulfamuron |
| (I-6) | cyhalofop-butyl |
| (I-6) | 2,4-D |
| (I-6) | dichlorprop-P |
| (I-6) | dimepiperate |
| (I-6) | dimethametryn |
| (I-6) | dimethenamid |
| (I-6) | S-dimethenamid |
| (I-6) | dithiopyr |
| (I-6) | dymron |
| (I-6) | esprocarb |
| (I-6) | ethoxysulfuron |
| (I-6) | etobenzanid |
| (I-6) | fenoxaprop-P-ethyl |
| (I-6) | fentrazamide |
| (I-6) | fluazifop-P-butyl |
| (I-6) | flucarbazone-sodium |
| (I-6) | flufenacet |
| (I-6) | flumetsulam |
| (I-6) | haloxyfop-P-methyl |
| (I-6) | imazamox |
| (I-6) | imazaquin |
| (I-6) | imazethapyr |
| (I-6) | imazosulfuron |
| (I-6) | isoxaflutole |
| (I-6) | MCPA |
| (I-6) | mefenacet |
| (I-6) | mesosulfuron |
| (I-6) | mesotrione |
| (I-6) | metolachlor |
| (I-6) | S-metolachlor |
| (I-6) | metosulam |
| (I-6) | metsulfuron-methyl |
| (I-6) | metribuzin |
| (I-6) | molinate |
| (I-6) | naproanilide |
| (I-6) | nicosulfuron |
| (I-6) | oxadiargyl |
| (I-6) | oxadiazon |
| (I-6) | oxaziclomefone |
| (I-6) | oxyfluorfen |
| (I-6) | pendimethalin |
| (I-6) | pentoxazone |
| (I-6) | pentoxazone |
| (I-6) | piperophos |
| (I-6) | pretilachlor |
| (I-6) | propanil |
| (I-6) | propoxycarbazone-sodium |
| (I-6) | pyraclonil |
| (I-6) | pyrazolate |
| (I-6) | pyrazosulfuron-ethyl |
| | tritosulfuron |
| (I-6) | pyrazoxyfen |
| (I-6) | pyribenzoxim |
| (I-6) | pyributicarb |
| (I-6) | pyriminobac-methyl |
| (I-6) | qinclorac |
| (I-6) | simazin |
| (I-6) | simetryn |
| (I-6) | sulcotrione |
| (I-6) | terbuthylazine |
| (I-6) | thenylchlor |
| (I-6) | thifensulfuron-methyl |
| (I-6) | tritosulfuron |
| (I-7) | acetochlor |
| (I-7) | alachlor |
| (I-7) | amicarbazone |
| (I-7) | amidosulfuron |
| (I-7) | anilofos |
| (I-7) | atrazin |
| (I-7) | azimsulfuron |
| (I-7) | benfuresate |
| (I-7) | bensulfuron-methyl |
| (I-7) | bentazone |
| (I-7) | benthiocarb (thiobencarb) |
| (I-7) | benzobicyclon |
| (I-7) | benzofenap |
| (I-7) | bispyrbac-sodium |
| (I-7) | bromobutide |
| (I-7) | butachlor |
| (I-7) | cafenstrole |
| (I-7) | carfentrazone-ethyl |
| (I-7) | chlomethoxyfen |
| (I-7) | cinmethylin |
| (I-7) | cinosulfuron |
| (I-7) | clefoxydim |
| (I-7) | clodinafop-propargyl |
| (I-7) | clomeprop |
| (I-7) | cumyluron |
| (I-7) | cyanazine |
| (I-7) | cyclosulfamuron |
| (I-7) | cyhalofop-butyl |
| (I-7) | 2,4-D |
| (I-7) | dichlorprop-P |
| (I-7) | dimepiperate |
| (I-7) | dimethametryn |
| (I-7) | dimethenamid |
| (I-7) | S-dimethenamid |
| (I-7) | dithiopyr |
| (I-7) | dymron |
| (I-7) | esprocarb |
| (I-7) | ethoxysulfuron |
| (I-7) | etobenzanid |
| (I-7) | fenoxaprop-P-ethyl |
| (I-7) | fentrazamide |
| (I-7) | fluazifop-P-butyl |
| (I-7) | flucarbazone-sodium |
| (I-7) | flufenacet |
| (I-7) | flumetsulam |
| (I-7) | haloxyfop-P-methyl |
| (I-7) | imazamox |
| (I-7) | imazaquin |
| (I-7) | imazethapyr |
| (I-7) | imazosulfuron |
| (I-7) | isoxaflutole |
| (I-7) | MCPA |
| (I-7) | mefenacet |
| (I-7) | mesosulfuron |
| (I-7) | mesotrione |
| (I-7) | metolachlor |
| (I-7) | S-metolachlor |
| (I-7) | metosulam |
| (I-7) | metsulfuron-methyl |
| (I-7) | metribuzin |
| (I-7) | molinate |
| (I-7) | naproanilide |
| (I-7) | nicosulfuron |
| (I-7) | oxadiargyl |
| (I-7) | oxadiazon |
| (I-7) | oxaziclomefone |
| (I-7) | oxyfluorfen |
| (I-7) | pendimethalin |
| (I-7) | pentoxazone |
| (I-7) | pentoxazone |
| (I-7) | piperophos |
| (I-7) | pretilachlor |
| (I-7) | propanil |
| (I-7) | propoxycarbazone-sodium |
| (I-7) | pyraclonil |
| (I-7) | pyrazolate |
| (I-7) | pyrazosulfuron-ethyl |
| | tritosulfuron |
| (I-7) | pyrazoxyfen |
| (I-7) | pyribenzoxim |
| (I-7) | pyributicarb |
| (I-7) | pyriminobac-methyl |
| (I-7) | qinclorac |
| (I-7) | simazin |
| (I-7) | simetryn |
| (I-7) | sulcotrione |
| (I-7) | terbuthylazine |
| (I-7) | thenylchlor |
| (I-7) | thifensulfuron-methyl |
| (I-7) | tritosulfuron |
| (I-8) | acetochlor |
| (I-8) | alachlor |
| (I-8) | amicarbazone |
| (I-8) | amidosulfuron |
| (I-8) | anilofos |
| (I-8) | atrazin |
| (I-8) | azimsulfuron |
| (I-8) | benfuresate |
| (I-8) | bensulfuron-methyl |
| (I-8) | bentazone |
| (I-8) | benthiocarb (thiobencarb) |
| (I-8) | benzobicyclon |
| (I-8) | benzofenap |
| (I-8) | bispyrbac-sodium |
| (I-8) | bromobutide |
| (I-8) | butachlor |
| (I-8) | cafenstrole |
| (I-8) | carfentrazone-ethyl |
| (I-8) | chlomethoxyfen |
| (I-8) | cinmethylin |
| (I-8) | cinosulfuron |
| (I-8) | clefoxydim |
| (I-8) | clodinafop-propargyl |
| (I-8) | clomeprop |
| (I-8) | cumyluron |
| (I-8) | cyanazine |
| (I-8) | cyclosulfamuron |
| (I-8) | cyhalofop-butyl |
| (I-8) | 2,4-D |
| (I-8) | dichlorprop-P |
| (I-8) | dimepiperate |
| (I-8) | dimethametryn |
| (I-8) | dimethenamid |
| (I-8) | S-dimethenamid |
| (I-8) | dithiopyr |
| (I-8) | dymron |
| (I-8) | esprocarb |
| (I-8) | ethoxysulfuron |
| (I-8) | etobenzanid |
| (I-8) | fenoxaprop-P-ethyl |
| (I-8) | fentrazamide |
| (I-8) | fluazifop-P-butyl |
| (I-8) | flucarbazone-sodium |
| (I-8) | flufenacet |
| (I-8) | flumetsulam |
| (I-8) | haloxyfop-P-methyl |
| (I-8) | imazamox |
| (I-8) | imazaquin |
| (I-8) | imazethapyr |
| (I-8) | imazosulfuron |
| (I-8) | isoxaflutole |
| (I-8) | MCPA |
| (I-8) | mefenacet |
| (I-8) | mesosulfuron |
| (I-8) | mesotrione |
| (I-8) | metolachlor |
| (I-8) | S-metolachlor |
| (I-8) | metosulam |
| (I-8) | metsulfuron-methyl |
| (I-8) | metribuzin |
| (I-8) | molinate |
| (I-8) | naproanilide |
| (I-8) | nicosulfuron |
| (I-8) | oxadiargyl |
| (I-8) | oxadiazon |
| (I-8) | oxaziclomefone |
| (I-8) | oxyfluorfen |
| (I-8) | pendimethalin |
| (I-8) | pentoxazone |
| (I-8) | pentoxazone |
| (I-8) | piperophos |
| (I-8) | pretilachlor |
| (I-8) | propanil |
| (I-8) | propoxycarbazone-sodium |
| (I-8) | pyraclonil |
| (I-8) | pyrazolate |
| (I-8) | pyrazosulfuron-ethyl |
| | tritosulfuron |
| (I-8) | pyrazoxyfen |
| (I-8) | pyribenzoxim |
| (I-8) | pyributicarb |
| (I-8) | pyriminobac-methyl |
| (I-8) | qinclorac |
| (I-8) | simazin |
| (I-8) | simetryn |
| (I-8) | sulcotrione |
| (I-8) | terbuthylazine |
| (I-8) | thenylchlor |
| (I-8) | thifensulfuron-methyl |
| (I-8) | tritosulfuron |
| (I-9) | acetochlor |
| (I-9) | alachlor |
| (I-9) | amicarbazone |
| (I-9) | amidosulfuron |
| (I-9) | anilofos |
| (I-9) | atrazin |
| (I-9) | azimsulfuron |
| (I-9) | benfuresate |
| (I-9) | bensulfuron-methyl |
| (I-9) | bentazone |
| (I-9) | benthiocarb (thiobencarb) |
| (I-9) | benzobicyclon |
| (I-9) | benzofenap |
| (I-9) | bispyrbac-sodium |
| (I-9) | bromobutide |
| (I-9) | butachlor |
| (I-9) | cafenstrole |
| (I-9) | carfentrazone-ethyl |
| (I-9) | chlomethoxyfen |
| (I-9) | cinmethylin |
| (I-9) | cinosulfuron |
| (I-9) | clefoxydim |
| (I-9) | clodinafop-propargyl |
| (I-9) | clomeprop |
| (I-9) | cumyluron |
| (I-9) | cyanazine |
| (I-9) | cyclosulfamuron |
| (I-9) | cyhalofop-butyl |
| (I-9) | 2,4-D |
| (I-9) | dichlorprop-P |
| (I-9) | dimepiperate |
| (I-9) | dimethametryn |
| (I-9) | dimethenamid |
| (I-9) | S-dimethenamid |
| (I-9) | dithiopyr |
| (I-9) | dymron |
| (I-9) | esprocarb |
| (I-9) | ethoxysulfuron |
| (I-9) | etobenzanid |
| (I-9) | fenoxaprop-P-ethyl |
| (I-9) | fentrazamide |
| (I-9) | fluazifop-P-butyl |
| (I-9) | flucarbazone-sodium |
| (I-9) | flufenacet |
| (I-9) | flumetsulam |
| (I-9) | haloxyfop-P-methyl |
| (I-9) | imazamox |
| (I-9) | imazaquin |
| (I-9) | imazethapyr |
| (I-9) | imazosulfuron |
| (I-9) | isoxaflutole |
| (I-9) | MCPA |
| (I-9) | mefenacet |
| (I-9) | mesosulfuron |
| (I-9) | mesotrione |
| (I-9) | metolachlor |
| (I-9) | S-metolachlor |
| (I-9) | metosulam |
| (I-9) | metsulfuron-methyl |
| (I-9) | metribuzin |
| (I-9) | molinate |
| (I-9) | naproanilide |
| (I-9) | nicosulfuron |
| (I-9) | oxadiargyl |
| (I-9) | oxadiazon |
| (I-9) | oxaziclomefone |
| (I-9) | oxyfluorfen |
| (I-9) | pendimethalin |
| (I-9) | pentoxazone |
| (I-9) | pentoxazone |
| (I-9) | piperophos |
| (I-9) | pretilachlor |
| (I-9) | propanil |
| (I-9) | propoxycarbazone-sodium |
| (I-9) | pyraclonil |
| (I-9) | pyrazolate |
| (I-9) | pyrazosulfuron-ethyl |
| | tritosulfuron |
| (I-9) | pyrazoxyfen |
| (I-9) | pyribenzoxim |
| (I-9) | pyributicarb |
| (I-9) | pyriminobac-methyl |
| (I-9) | qinclorac |
| (I-9) | simazin |
| (I-9) | simetryn |
| (I-9) | sulcotrione |
| (I-9) | terbuthylazine |
| (I-9) | thenylchlor |
| (I-9) | thifensulfuron-methyl |
| (I-9) | tritosulfuron |
| (I-10) | acetochlor |
| (I-10) | alachlor |
| (I-10) | amicarbazone |
| (I-10) | amidosulfuron |
| (I-10) | anilofos |
| (I-10) | atrazin |
| (I-10) | azimsulfuron |
| (I-10) | benfuresate |
| (I-10) | bensulfuron-methyl |
| (I-10) | bentazone |
| (I-10) | benthiocarb (thiobencarb) |
| (I-10) | benzobicyclon |
| (I-10) | benzofenap |
| (I-10) | bispyrbac-sodium |
| (I-10) | bromobutide |
| (I-10) | butachlor |
| (I-10) | cafenstrole |
| (I-10) | carfentrazone-ethyl |
| (I-10) | chlomethoxyfen |
| (I-10) | cinmethylin |
| (I-10) | cinosulfuron |
| (I-10) | clefoxydim |
| (I-10) | clodinafop-propargyl |
| (I-10) | clomeprop |
| (I-10) | cumyluron |
| (I-10) | cyanazine |
| (I-10) | cyclosulfamuron |
| (I-10) | cyhalofop-butyl |
| (I-10) | 2,4-D |
| (I-10) | dichlorprop-P |
| (I-10) | dimepiperate |
| (I-10) | dimethametryn |
| (I-10) | dimethenamid |
| (I-10) | S-dimethenamid |
| (I-10) | dithiopyr |
| (I-10) | dymron |
| (I-10) | esprocarb |
| (I-10) | ethoxysulfuron |
| (I-10) | etobenzanid |
| (I-10) | fenoxaprop-P-ethyl |
| (I-10) | fentrazamide |
| (I-10) | fluazifop-P-butyl |
| (I-10) | flucarbazone-sodium |
| (I-10) | flufenacet |
| (I-10) | flumetsulam |
| (I-10) | haloxyfop-P-methyl |
| (I-10) | imazamox |
| (I-10) | imazaquin |
| (I-10) | imazethapyr |
| (I-10) | imazosulfuron |
| (I-10) | isoxaflutole |
| (I-10) | MCPA |
| (I-10) | mefenacet |
| (I-10) | mesosulfuron |
| (I-10) | mesotrione |
| (I-10) | metolachlor |
| (I-10) | S-metolachlor |
| (I-10) | metosulam |
| (I-10) | metsulfuron-methyl |
| (I-10) | metribuzin |
| (I-10) | molinate |
| (I-10) | naproanilide |
| (I-10) | nicosulfuron |
| (I-10) | oxadiargyl |
| (I-10) | oxadiazon |
| (I-10) | oxaziclomefone |
| (I-10) | oxyfluorfen |
| (I-10) | pendimethalin |
| (I-10) | pentoxazone |
| (I-10) | pentoxazone |
| (I-10) | piperophos |
| (I-10) | pretilachlor |
| (I-10) | propanil |
| (I-10) | propoxycarbazone-sodium |
| (I-10) | pyraclonil |
| (I-10) | pyrazolate |
| (I-10) | pyrazosulfuron-ethyl |
| | tritosulfuron |
| (I-10) | pyrazoxyfen |
| (I-10) | pyribenzoxim |
| (I-10) | pyributicarb |
| (I-10) | pyriminobac-methyl |
| (I-10) | qinclorac |
| (I-10) | simazin |
| (I-10) | simetryn |
| (I-10) | sulcotrione |
| (I-10) | terbuthylazine |
| (I-10) | thenylchlor |
| (I-10) | thifensulfuron-methyl |
| (I-10) | tritosulfuron |
| (I-11) | acetochlor |
| (I-11) | alachlor |
| (I-11) | amicarbazone |
| (I-11) | amidosulfuron |
| (I-11) | anilofos |
| (I-11) | atrazin |
| (I-11) | azimsulfuron |
| (I-11) | benfuresate |
| (I-11) | bensulfuron-methyl |
| (I-11) | bentazone |
| (I-11) | benthiocarb (thiobencarb) |
| (I-11) | benzobicyclon |
| (I-11) | benzofenap |
| (I-11) | bispyrbac-sodium |
| (I-11) | bromobutide |
| (I-11) | butachlor |
| (I-11) | cafenstrole |
| (I-11) | carfentrazone-ethyl |
| (I-11) | chlomethoxyfen |
| (I-11) | cinmethylin |
| (I-11) | cinosulfuron |
| (I-11) | clefoxydim |
| (I-11) | clodinafop-propargyl |
| (I-11) | clomeprop |
| (I-11) | cumyluron |
| (I-11) | cyanazine |
| (I-11) | cyclosulfamuron |
| (I-11) | cyhalofop-butyl |
| (I-11) | 2,4-D |
| (I-11) | dichlorprop-P |
| (I-11) | dimepiperate |
| (I-11) | dimethametryn |
| (I-11) | dimethenamid |
| (I-11) | S-dimethenamid |
| (I-11) | dithiopyr |
| (I-11) | dymron |
| (I-11) | esprocarb |
| (I-11) | ethoxysulfuron |
| (I-11) | etobenzanid |
| (I-11) | fenoxaprop-P-ethyl |
| (I-11) | fentrazamide |
| (I-11) | fluazifop-P-butyl |
| (I-11) | flucarbazone-sodium |
| (I-11) | flufenacet |
| (I-11) | flumetsulam |
| (I-11) | haloxyfop-P-methyl |
| (I-11) | imazamox |
| (I-11) | imazaquin |
| (I-11) | imazethapyr |
| (I-11) | imazosulfuron |
| (I-11) | isoxaflutole |
| (I-11) | MCPA |
| (I-11) | mefenacet |
| (I-11) | mesosulfuron |
| (I-11) | mesotrione |
| (I-11) | metolachlor |
| (I-11) | S-metolachlor |
| (I-11) | metosulam |
| (I-11) | metsulfuron-methyl |
| (I-11) | metribuzin |
| (I-11) | molinate |
| (I-11) | naproanilide |
| (I-11) | nicosulfuron |
| (I-11) | oxadiargyl |
| (I-11) | oxadiazon |
| (I-11) | oxaziclomefone |
| (I-11) | oxyfluorfen |
| (I-11) | pendimethalin |
| (I-11) | pentoxazone |
| (I-11) | pentoxazone |
| (I-11) | piperophos |
| (I-11) | pretilachlor |
| (I-11) | propanil |
| (I-11) | propoxycarbazone-sodium |
| (I-11) | pyraclonil |
| (I-11) | pyrazolate |
| (I-11) | pyrazosulfuron-ethyl |
| | tritosulfuron |
| (I-11) | pyrazoxyfen |
| (I-11) | pyribenzoxim |
| (I-11) | pyributicarb |
| (I-11) | pyriminobac-methyl |
| (I-11) | qinclorac |
| (I-11) | simazin |
| (I-11) | simetryn |
| (I-11) | sulcotrione |
| (I-11) | terbuthylazine |
| (I-11) | thenylchlor |
| (I-11) | thifensulfuron-methyl |
| (I-11) | tritosulfuron |
| (I-12) | acetochlor |
| (I-12) | alachlor |
| (I-12) | amicarbazone |
| (I-12) | amidosulfuron |
| (I-12) | anilofos |
| (I-12) | atrazin |
| (I-12) | azimsulfuron |
| (I-12) | benfuresate |
| (I-12) | bensulfuron-methyl |
| (I-12) | bentazone |
| (I-12) | benthiocarb (thiobencarb) |
| (I-12) | benzobicyclon |
| (I-12) | benzofenap |
| (I-12) | bispyrbac-sodium |
| (I-12) | bromobutide |
| (I-12) | butachlor |
| (I-12) | cafenstrole |
| (I-12) | carfentrazone-ethyl |
| (I-12) | chlomethoxyfen |
| (I-12) | cinmethylin |
| (I-12) | cinosulfuron |
| (I-12) | clefoxydim |
| (I-12) | clodinafop-propargyl |
| (I-12) | clomeprop |
| (I-12) | cumyluron |
| (I-12) | cyanazine |
| (I-12) | cyclosulfamuron |
| (I-12) | cyhalofop-butyl |
| (I-12) | 2,4-D |
| (I-12) | dichlorprop-P |
| (I-12) | dimepiperate |
| (I-12) | dimethametryn |
| (I-12) | dimethenamid |
| (I-12) | S-dimethenamid |
| (I-12) | dithiopyr |
| (I-12) | dymron |
| (I-12) | esprocarb |
| (I-12) | ethoxysulfuron |
| (I-12) | etobenzanid |
| (I-12) | fenoxaprop-P-ethyl |
| (I-12) | fentrazamide |
| (I-12) | fluazifop-P-butyl |
| (I-12) | flucarbazone-sodium |
| (I-12) | flufenacet |
| (I-12) | flumetsulam |
| (I-12) | haloxyfop-P-methyl |
| (I-12) | imazamox |
| (I-12) | imazaquin |
| (I-12) | imazethapyr |
| (I-12) | imazosulfuron |
| (I-12) | isoxaflutole |
| (I-12) | MCPA |
| (I-12) | mefenacet |
| (I-12) | mesosulfuron |
| (I-12) | mesotrione |
| (I-12) | metolachlor |
| (I-12) | S-metolachlor |
| (I-12) | metosulam |
| (I-12) | metsulfuron-methyl |
| (I-12) | metribuzin |
| (I-12) | molinate |
| (I-12) | naproanilide |
| (I-12) | nicosulfuron |
| (I-12) | oxadiargyl |
| (I-12) | oxadiazon |
| (I-12) | oxaziclomefone |
| (I-12) | oxyfluorfen |
| (I-12) | pendimethalin |
| (I-12) | pentoxazone |
| (I-12) | pentoxazone |
| (I-12) | piperophos |
| (I-12) | pretilachlor |
| (I-12) | propanil |
| (I-12) | propoxycarbazone-sodium |
| (I-12) | pyraclonil |
| (I-12) | pyrazolate |
| (I-12) | pyrazosulfuron-ethyl |
| | tritosulfuron |
| (I-12) | pyrazoxyfen |
| (I-12) | pyribenzoxim |
| (I-12) | pyributicarb |
| (I-12) | pyriminobac-methyl |
| (I-12) | qinclorac |
| (I-12) | simazin |
| (I-12) | simetryn |
| (I-12) | sulcotrione |
| (I-12) | terbuthylazine |
| (I-12) | thenylchlor |
| (I-12) | thifensulfuron-methyl |
| (I-12) | tritosulfuron |
| (I-13) | acetochlor |
| (I-13) | alachlor |
| (I-13) | amicarbazone |
| (I-13) | amidosulfuron |
| (I-13) | anilofos |
| (I-13) | atrazin |
| (I-13) | azimsulfuron |
| (I-13) | benfuresate |
| (I-13) | bensulfuron-methyl |
| (I-13) | bentazone |
| (I-13) | benthiocarb (thiobencarb) |
| (I-13) | benzobicyclon |
| (I-13) | benzofenap |
| (I-13) | bispyrbac-sodium |
| (I-13) | bromobutide |
| (I-13) | butachlor |
| (I-13) | cafenstrole |
| (I-13) | carfentrazone-ethyl |
| (I-13) | chlomethoxyfen |
| (I-13) | cinmethylin |
| (I-13) | cinosulfuron |
| (I-13) | clefoxydim |
| (I-13) | clodinafop-propargyl |
| (I-13) | clomeprop |
| (I-13) | cumyluron |
| (I-13) | cyanazine |
| (I-13) | cyclosulfamuron |
| (I-13) | cyhalofop-butyl |
| (I-13) | 2,4-D |
| (I-13) | dichlorprop-P |
| (I-13) | dimepiperate |
| (I-13) | dimethametryn |
| (I-13) | dimethenamid |
| (I-13) | S-dimethenamid |
| (I-13) | dithiopyr |
| (I-13) | dymron |
| (I-13) | esprocarb |
| (I-13) | ethoxysulfuron |
| (I-13) | etobenzanid |
| (I-13) | fenoxaprop-P-ethyl |
| (I-13) | fentrazamide |
| (I-13) | fluazifop-P-butyl |
| (I-13) | flucarbazone-sodium |
| (I-13) | flufenacet |
| (I-13) | flumetsulam |
| (I-13) | haloxyfop-P-methyl |
| (I-13) | imazamox |
| (I-13) | imazaquin |
| (I-13) | imazethapyr |
| (I-13) | imazosulfuron |
| (I-13) | isoxaflutole |
| (I-13) | MCPA |
| (I-13) | mefenacet |
| (I-13) | mesosulfuron |
| (I-13) | mesotrione |
| (I-13) | metolachlor |
| (I-13) | S-metolachlor |
| (I-13) | metosulam |
| (I-13) | metsulfuron-methyl |
| (I-13) | metribuzin |
| (I-13) | molinate |
| (I-13) | naproanilide |
| (I-13) | nicosulfuron |
| (I-13) | oxadiargyl |
| (I-13) | oxadiazon |
| (I-13) | oxaziclomefone |
| (I-13) | oxyfluorfen |
| (I-13) | pendimethalin |
| (I-13) | pentoxazone |
| (I-13) | pentoxazone |
| (I-13) | piperophos |
| (I-13) | pretilachlor |
| (I-13) | propanil |
| (I-13) | propoxycarbazone-sodium |
| (I-13) | pyraclonil |
| (I-13) | pyrazolate |
| (I-13) | pyrazosulfuron-ethyl |
| | tritosulfuron |
| (I-13) | pyrazoxyfen |
| (I-13) | pyribenzoxim |
| (I-13) | pyributicarb |
| (I-13) | pyriminobac-methyl |
| (I-13) | qinclorac |
| (I-13) | simazin |
| (I-13) | simetryn |
| (I-13) | sulcotrione |
| (I-13) | terbuthylazine |
| (I-13) | thenylchlor |
| (I-13) | thifensulfuron-methyl |
| (I-13) | tritosulfuron |
| (I-14) | acetochlor |
| (I-14) | alachlor |
| (I-14) | amicarbazone |
| (I-14) | amidosulfuron |
| (I-14) | anilofos |
| (I-14) | atrazin |
| (I-14) | azimsulfuron |
| (I-14) | benfuresate |
| (I-14) | bensulfuron-methyl |
| (I-14) | bentazone |
| (I-14) | benthiocarb (thiobencarb) |
| (I-14) | benzobicyclon |
| (I-14) | benzofenap |
| (I-14) | bispyrbac-sodium |
| (I-14) | bromobutide |
| (I-14) | butachlor |
| (I-14) | cafenstrole |
| (I-14) | carfentrazone-ethyl |
| (I-14) | chlomethoxyfen |
| (I-14) | cinmethylin |
| (I-14) | cinosulfuron |
| (I-14) | clefoxydim |
| (I-14) | clodinafop-propargyl |
| (I-14) | clomeprop |
| (I-14) | cumyluron |
| (I-14) | cyanazine |
| (I-14) | cyclosulfamuron |
| (I-14) | cyhalofop-butyl |
| (I-14) | 2,4-D |
| (I-14) | dichlorprop-P |
| (I-14) | dimepiperate |
| (I-14) | dimethametryn |
| (I-14) | dimethenamid |
| (I-14) | S-dimethenamid |
| (I-14) | dithiopyr |
| (I-14) | dymron |
| (I-14) | esprocarb |
| (I-14) | ethoxysulfuron |
| (I-14) | etobenzanid |
| (I-14) | fenoxaprop-P-ethyl |
| (I-14) | fentrazamide |
| (I-14) | fluazifop-P-butyl |
| (I-14) | flucarbazone-sodium |
| (I-14) | flufenacet |
| (I-14) | flumetsulam |
| (I-14) | haloxyfop-P-methyl |
| (I-14) | imazamox |
| (I-14) | imazaquin |
| (I-14) | imazethapyr |
| (I-14) | imazosulfuron |
| (I-14) | isoxaflutole |
| (I-14) | MCPA |
| (I-14) | mefenacet |
| (I-14) | mesosulfuron |
| (I-14) | mesotrione |
| (I-14) | metolachlor |
| (I-14) | S-metolachlor |
| (I-14) | metosulam |
| (I-14) | metsulfuron-methyl |
| (I-14) | metribuzin |
| (I-14) | molinate |
| (I-14) | naproanilide |
| (I-14) | nicosulfuron |
| (I-14) | oxadiargyl |
| (I-14) | oxadiazon |
| (I-14) | oxaziclomefone |
| (I-14) | oxyfluorfen |
| (I-14) | pendimethalin |
| (I-14) | pentoxazone |
| (I-14) | pentoxazone |
| (I-14) | piperophos |
| (I-14) | pretilachlor |
| (I-14) | propanil |
| (I-14) | propoxycarbazone-sodium |
| (I-14) | pyraclonil |
| (I-14) | pyrazolate |
| (I-14) | pyrazosulfuron-ethyl |
| | tritosulfuron |
| (I-14) | pyrazoxyfen |
| (I-14) | pyribenzoxim |
| (I-14) | pyributicarb |
| (I-14) | pyriminobac-methyl |
| (I-14) | qinclorac |
| (I-14) | simazin |
| (I-14) | simetryn |
| (I-14) | sulcotrione |
| (I-14) | terbuthylazine |
| (I-14) | thenylchlor |
| (I-14) | thifensulfuron-methyl |
| (I-14) | tritosulfuron |
| (I-15) | acetochlor |
| (I-15) | alachlor |
| (I-15) | amicarbazone |
| (I-15) | amidosulfuron |
| (I-15) | anilofos |
| (I-15) | atrazin |
| (I-15) | azimsulfuron |
| (I-15) | benfuresate |
| (I-15) | bensulfuron-methyl |
| (I-15) | bentazone |
| (I-15) | benthiocarb (thiobencarb) |
| (I-15) | benzobicyclon |
| (I-15) | benzofenap |
| (I-15) | bispyrbac-sodium |
| (I-15) | bromobutide |
| (I-15) | butachlor |
| (I-15) | cafenstrole |
| (I-15) | carfentrazone-ethyl |
| (I-15) | chlomethoxyfen |
| (I-15) | cinmethylin |
| (I-15) | cinosulfuron |
| (I-15) | clefoxydim |
| (I-15) | clodinafop-propargyl |
| (I-15) | clomeprop |
| (I-15) | cumyluron |
| (I-15) | cyanazine |
| (I-15) | cyclosulfamuron |
| (I-15) | cyhalofop-butyl |
| (I-15) | 2,4-D |
| (I-15) | dichlorprop-P |
| (I-15) | dimepiperate |
| (I-15) | dimethametryn |
| (I-15) | dimethenamid |
| (I-15) | S-dimethenamid |
| (I-15) | dithiopyr |
| (I-15) | dymron |
| (I-15) | esprocarb |
| (I-15) | ethoxysulfuron |
| (I-15) | etobenzanid |
| (I-15) | fenoxaprop-P-ethyl |
| (I-15) | fentrazamide |
| (I-15) | fluazifop-P-butyl |
| (I-15) | flucarbazone-sodium |
| (I-15) | flufenacet |
| (I-15) | flumetsulam |
| (I-15) | haloxyfop-P-methyl |
| (I-15) | imazamox |
| (I-15) | imazaquin |
| (I-15) | imazethapyr |
| (I-15) | imazosulfuron |
| (I-15) | isoxaflutole |
| (I-15) | MCPA |
| (I-15) | mefenacet |
| (I-15) | mesosulfuron |
| (I-15) | mesotrione |
| (I-15) | metolachlor |
| (I-15) | S-metolachlor |
| (I-15) | metosulam |
| (I-15) | metsulfuron-methyl |
| (I-15) | metribuzin |
| (I-15) | molinate |
| (I-15) | naproanilide |
| (I-15) | nicosulfuron |
| (I-15) | oxadiargyl |
| (I-15) | oxadiazon |
| (I-15) | oxaziclomefone |
| (I-15) | oxyfluorfen |
| (I-15) | pendimethalin |
| (I-15) | pentoxazone |
| (I-15) | pentoxazone |
| (I-15) | piperophos |
| (I-15) | pretilachlor |
| (I-15) | propanil |
| (I-15) | propoxycarbazone-sodium |
| (I-15) | pyraclonil |
| (I-15) | pyrazolate |
| (I-15) | pyrazosulfuron-ethyl |
| | tritosulfuron |
| (I-15) | pyrazoxyfen |
| (I-15) | pyribenzoxim |
| (I-15) | pyributicarb |
| (I-15) | pyriminobac-methyl |
| (I-15) | qinclorac |
| (I-15) | simazin |
| (I-15) | simetryn |
| (I-15) | sulcotrione |
| (I-15) | terbuthylazine |
| (I-15) | thenylchlor |
| (I-15) | thifensulfuron-methyl |
| (I-15) | tritosulfuron |
| (I-16) | acetochlor |
| (I-16) | alachlor |
| (I-16) | amicarbazone |
| (I-16) | amidosulfuron |
| (I-16) | anilofos |
| (I-16) | atrazin |
| (I-16) | azimsulfuron |
| (I-16) | benfuresate |
| (I-16) | bensulfuron-methyl |
| (I-16) | bentazone |
| (I-16) | benthiocarb (thiobencarb) |
| (I-16) | benzobicyclon |
| (I-16) | benzofenap |
| (I-16) | bispyrbac-sodium |
| (I-16) | bromobutide |
| (I-16) | butachlor |
| (I-16) | cafenstrole |
| (I-16) | carfentrazone-ethyl |
| (I-16) | chlomethoxyfen |
| (I-16) | cinmethylin |
| (I-16) | cinosulfuron |
| (I-16) | clefoxydim |
| (I-16) | clodinafop-propargyl |
| (I-16) | clomeprop |
| (I-16) | cumyluron |
| (I-16) | cyanazine |
| (I-16) | cyclosulfamuron |
| (I-16) | cyhalofop-butyl |
| (I-16) | 2,4-D |
| (I-16) | dichlorprop-P |
| (I-16) | dimepiperate |
| (I-16) | dimethametryn |
| (I-16) | dimethenamid |
| (I-16) | S-dimethenamid |
| (I-16) | dithiopyr |
| (I-16) | dymron |
| (I-16) | esprocarb |
| (I-16) | ethoxysulfuron |
| (I-16) | etobenzanid |
| (I-16) | fenoxaprop-P-ethyl |
| (I-16) | fentrazamide |
| (I-16) | fluazifop-P-butyl |
| (I-16) | flucarbazone-sodium |
| (I-16) | flufenacet |
| (I-16) | flumetsulam |
| (I-16) | haloxyfop-P-methyl |
| (I-16) | imazamox |
| (I-16) | imazaquin |
| (I-16) | imazethapyr |
| (I-16) | imazosulfuron |
| (I-16) | isoxaflutole |
| (I-16) | MCPA |
| (I-16) | mefenacet |
| (I-16) | mesosulfuron |
| (I-16) | mesotrione |
| (I-16) | metolachlor |
| (I-16) | S-metolachlor |
| (I-16) | metosulam |
| (I-16) | metsulfuron-methyl |
| (I-16) | metribuzin |
| (I-16) | molinate |
| (I-16) | naproanilide |
| (I-16) | nicosulfuron |
| (I-16) | oxadiargyl |
| (I-16) | oxadiazon |
| (I-16) | oxaziclomefone |
| (I-16) | oxyfluorfen |
| (I-16) | pendimethalin |
| (I-16) | pentoxazone |
| (I-16) | pentoxazone |
| (I-16) | piperophos |
| (I-16) | pretilachlor |
| (I-16) | propanil |
| (I-16) | propoxycarbazone-sodium |
| (I-16) | pyraclonil |
| (I-16) | pyrazolate |
| (I-16) | pyrazosulfuron-ethyl |
| | tritosulfuron |
| (I-16) | pyrazoxyfen |
| (I-16) | pyribenzoxim |
| (I-16) | pyributicarb |
| (I-16) | pyriminobac-methyl |
| (I-16) | qinclorac |
| (I-16) | simazin |
| (I-16) | simetryn |
| (I-16) | sulcotrione |
| (I-16) | terbuthylazine |
| (I-16) | thenylchlor |
| (I-16) | thifensulfuron-methyl |
| (I-16) | tritosulfuron |

Surprisingly, it has now been found that the above-defined active compound combinations of the substituted aryl ketones of the formula (I) and the above-mentioned active compounds of group 2 exhibit a particularly high herbicidal activity combined with very good crop plant compatibility and can be used for the selective control of monocotyledonous and dicotyledonous weeds in a variety of crops, especially in cotton, barley, corn, rice, soybeans, sunflower, wheat and sugar cane, in particular in barley, corn, rice and wheat, very particularly in rice, and additionally also for controlling monocotyledonous and dicotyledonous weeds in the semi- and nonselective field.

Surprisingly, the herbicidal activity of the active compound combinations according to the invention, of compounds of the abovementioned groups 1 and 2 exceeds the total of the actions of the individual active compounds considerably.

Thus, not just a complementation of actions but a synergistic effect is present which could not have been predicted. The novel active compound combinations are well tolerated in a variety of crops, also effecting good control of weeds which are otherwise difficult to control. Thus, the novel active compound combinations are a valuable addition to the herbicides.

The synergistic effect of the active compound combinations according to the invention is particularly strongly pronounced in certain concentration ratios. However, the weight ratios of the active compounds in the active compound combinations may be varied within relatively wide ranges. In general, from 0.001 to 1000 parts by weight, preferably from 0.002 to 500 parts by weight and particularly preferably from 0.01 to 100 parts by weight of active compound of group 2 are used per part by weight of active compound of the formula (I).

It must be considered as surprising that, from amongst a large number of known safeners or antidotes capable of antagonizing the harmful effect of a herbicide on the crop plants, it is precisely the abovementioned compounds of group 3 which are capable of almost completely compensating the harmful effect, on the crop plants, of active compounds of the formula (I) and their salts, if appropriate also in combination with one or more of the abovementioned active compounds of group 2, without adversely affecting the herbicidal efficacy toward the weeds.

Surprisingly, it has furthermore been found that the herbicidally active substance 2,3-dichlorophenoxy-acetic acid (2,4-D) and its derivatives can also play the safener role described above.

Accordingly, another preferred embodiment is a mixture comprising a compound of the formula (I) and/or its salts and 2,4-D and/or its salts, optionally in combination with one or more of the abovementioned active compounds of group 2. Typical derivatives of 2,4-D are, for example, its esters.

Surprisingly, it has also been found that the herbicidally active substances (4-chloro-2-methylphenoxy)acetic acid (MCPA) and (+-)-2-(4-chloro-2-methylphenoxy)-propanoic acid (mecoprop) can likewise act as safeners. The compounds mentioned are described in the following patent applications: JP 63 072 605 and GB 00 820 180.

The compounds diethyl 1-(2,4-dichlorophenyl)-4,5-dihydro-5-methyl-1H-pyrazole-3,5-dicarboxylate (mefenpyr-diethyl), 1-methyl-hexyl [(5-chloro-8-quinolinyl)oxy]acetate (cloquintocet-mexyl) and ethyl 1-(2,4-dichlorophenyl)-5-(trichloromethyl)-1H-1,2,4-triazole-3-carboxylate (fenchlorazole-ethyl) are described in the following patent applications: DE-A-39 39 503, EP-A-191 736 and DE-A-35 25 205, respectively. 2,4-D is a known herbicide.

The advantageous effect of the crop plant compatibility of the active compound combinations according to the invention is likewise particularly strongly pronounced at certain concentration ratios. However, the weight ratios of the active compounds in the active combinations can be varied within relatively wide ranges. In general, from 0.001 to 1000 parts by weight, preferably from 0.01 to 100 parts by weight and particularly preferably from 0.1 to 10 parts by weight of one of the crop-plant-compatibility-improving compounds (antidotes/safeners) mentioned above under (c) are used per part by weight of active compound of the formula (I) or its mixtures with active compounds of group 2.

All plants and plant parts can be treated in accordance with the invention. Plants are to be understood as meaning in the present context all plants and plant populations such as desired and undesired wild plants or crop plants (inclusive of naturally occurring crop plants). Crop plants can be plants which can be obtained by conventional plant breeding and optimization methods or by biotechnological and recombinant methods or by combinations of these methods, inclusive of the transgenic plants and inclusive of the plant varieties protectable or not protectable by plant breeders' rights. Plant parts are to be understood as meaning all aerial and subterranean plant parts and organs of the plants such as shoot, leaf, flower and root, examples which may be mentioned being leaves, needles, stalks, trunks, flowers, fruiting bodies, fruits, and seeds, and also roots, tubers and rhiozomes. The plant parts also include vegetative and generative propagation material, for example cuttings, tubers, rhizomes, seedlings and seeds.

The treatment according to the invention, of the plant and plant parts with the active compounds is carried out directly or by allowing the compounds to act on the surroundings, environment or storage space by the customary treatment methods, for example by immersion, spraying, evaporation, fogging, scattering, painting on and, in the case of propagation material, in particular in the case of seeds, also by applying one or more coats.

Amongst the plants obtained by biotechnological and recombinant methods, or by combining these methods, plants which are emphasized are those which tolerate so-called ALS, 4-HPPD, EPSP and/or PPO inhibitors, such as, for example, Acuron plants.

The active compounds according to the invention can be used, for example, in the following plants:

Dicotyledonous weeds of the genera: Abutilon, Amaranthus, Ambrosia, Anoda, Anthemis, Aphanes, Atriplex, Bellis, Bidens, Capsella, Carduus, Cassia, Centaurea, Chenopodium, Cirsium, Convolvulus, Datura, Desmodium, Emex, Erysimum, Euphorbia, Galeopsis, Galinsoga, Galium, Hibiscus, Ipomoea, Kochia, Lamium, Lepidium, Lindernia, Matricaria, Mentha, Mercurialis, Mullugo, Myosotis, Papaver, Pharbitis, Plantago, Polygonum, Portulaca, Ranunculus, Raphanus, Rorippa, Rotala, Rumex, Salsola, Senecio, Sesbania, Sida, Sinapis, Solanum, Sonchus, Sphenoclea, Stellaria, Taraxacum, Thlaspi, Trifolium, Urtica, Veronica, Viola, Xanthium.

Dicotyledonous crops of the genera: Arachis, Beta, Brassica, Cucumis, Cucurbita, Helianthus, Daucus, Glycine, Gossypium, Ipomoea, Lactuca, Linum, Lycopersicon, Nicotiana, Phaseolus, Pisum, Solanum, Vicia.

Monocotyledonous weeds of the genera: Aegilops, Agropyron, Agrostis, Alopecurus, Apera, Avena, Brachiaria, Bromus, Cenchrus, Commelina, Cynodon, Cyperus, Dactyloctenium, Digitaria, Echinochloa, Eleocharis, Eleusine, Eragrostis, Eriochloa, Festuca, Fimbristylis, Heteranthera, Imperata, Ischaemum, Leptochloa, Lolium, Monochoria, Panicum, Paspalum, Phalaris, Phleum, Poa, Rottboellia, Sagittaria, Scirpus, Setaria, Sorghum.

Monocotyledonous crops of the genera: Allium, Ananas, Asparagus, Avena, Hordeum, Oryza, Panicum, Saccharum, Secale, Sorghum, Triticale, Triticum, Zea.

However, the use of the active compound combinations according to the invention is in no way restricted to these genera, but also extends in the same manner to other plants.

The active compound combinations to be used in accordance with the invention can be employed not only in conventional cultivation methods (suitably spaced row crops), in plantation crops (for example grapevines, fruit, citrus) and in industrial plants and railtracks, on paths and squares, but also for stubble treatment and in the minimum tillage method. They are furthermore suitable as dessicants (haulm killing in, for example, potatoes) or as defoliants (for example in cotton). They are furthermore suitable for use on non-crop areas. Other fields of application are nurseries, forests, grassland and the production of ornamentals.

The active compound combinations can be converted into the customary formulations such as solutions, emulsions, wettable powders, suspensions, powders, dusts, pastes, soluble powders, granules, suspo-emulsion concentrates, natural and synthetic materials impregnated with active compound, and microencapsulations in polymeric materials.

These formulations are produced in a known manner, for example by mixing the active compounds with extenders, that is, liquid solvents and/or solid carriers, optionally with the use of surfactants, that is, emulsifiers and/or dispersants and/or foam formers.

If the extender used is water, it is also possible to employ, for example, organic solvents as cosolvents. The following are essentially suitable as liquid solvents: aromatics such as xylene, toluene, or alkylnaphthalenes, chlorinated aromatics and chlorinated aliphatic hydrocarbons such as chlorobenzenes, chloroethylenes or methylene chloride, aliphatic hydrocarbons such as cyclohexane or paraffins, for example mineral oil fractions, mineral and vegetable oils, alcohols such as butanol or glycol and their ethers and esters, ketones such as acetone, methyl ethyl ketone, methyl isobutyl ketone or cyclohexanone, strongly polar solvents such as dimethylformamide and dimethyl sulphoxide, or else water.

Solid carriers which are suitable are: for example ammonium salts and ground natural minerals such as kaolins, clays, talc, chalk, quartz, attapulgite, montmorillonite or diatomaceous earth, and ground synthetic materials such as highly-dispersed silica, alumina and silicates; suitable solid carriers for granules are for example crushed and fractionated natural rocks such as calcite, marble, pumice, sepiolite and dolomite, or else synthetic granules of inorganic and organic meals, and granules of organic material such as sawdust, coconut shells, corn cobs and tobacco stalks; suitable emulsifiers and/or foam formers are for example nonionic and anionic emulsifiers such as polyoxyethylene fatty acid esters, polyoxyethylene fatty alcohol ethers, for example alkylaryl polyglycol ethers, alkylsulfonates, alkyl sulfates, arylsulfonates, or else protein hydrolyzates; suitable dispersants are for example ligninosulfite waste liquors and methylcellulose.

Tackifiers such as carboxymethylcellulose and natural and synthetic polymers in the form of powders, granules or latices, such as gum arabic, polyvinyl alcohol and polyvinyl acetate, or else natural phospholipids such as cephalins and lecithins and synthetic phospholipids can be used in the formulations. Other possible additives are mineral and vegetable oils.

It is possible to use colorants such as inorganic pigments, for example iron oxide, titanium oxide and Prussian Blue, and organic dyestuffs, such as alizarin dyestuffs, azo dyestuffs and metal phthalocyanine dyestuffs, and trace nutrients such as salts of iron, manganese, boron, copper, cobalt, molybdenum and zinc.

The formulations generally comprise between 0.1 and 95 percent by weight of active compounds, preferably between 0.5 and 90%.

The active compound combinations according to the invention are generally applied in the form of ready mixes. However, the active compounds contained in the active compound combinations may also be applied in the form of individual formulations which are mixed upon use, that is, in the form of tank mixes.

The novel active compound combinations, as such or in their formulations, may furthermore also be used as a mixture with other known herbicides, again with ready mixes or tank mixes being possible. A mixture with other known active compounds such as fungicides, insecticides, acaricides, nematicides, bird repellents, growth substances, plant nutrients and soil conditioners is also possible. It may furthermore be advantageous for specific applications, in particular for the post-emergence method, to incorporate into the formulations plant-compatible mineral or vegetable oils (for example the commercial product “Rako Binol”) or ammonium salts such as, for example, ammonium sulphate or ammonium thiocyanate, as further additives.

The novel active compound combinations can be used as such, in the form of their formulations or the use forms which can be prepared from these formulations by further dilution, such as ready-to-use solutions, suspensions, emulsions, powders, pastes and granules. Application is effected in the customary manner, for example by pouring, spraying, atomizing, dusting or broadcasting.

The active compound combinations according to the invention can be applied before and after emergence of the plants, that is to say by the pre- and post-emergence method. They may also be incorporated into the soil prior to sowing.

The good herbicidal activity of the novel active compound combinations is demonstrated by the examples below. Whereas there are deficits in the herbicidal action of the individual active compounds, the combinations all have very good action against weeds which exceeds a simple addition of activities.

A synergistic effect in herbicides is always present when the herbicidal action of the active compound combination exceeds the action of the active compounds when applied individually.

The expected action for a given combination of two herbicides can be calculated as follows (cf. COLBY, S. R.: “Calculating synergistic and antagonistic responses of herbicide combinations”, Weeds 15, pages 20-22, 1967):

If

X=% damage by herbicide A (active compound of the formula I) at an application rate of p kg/ha, and

Y=% damage by herbicide B (active compound of the formula II) at an application rate of q kg/ha, and

E=the expected damage of herbicides A and B at an application rate of p and q kg/ha, then

E=X+Y−(X*Y/100).

If the actual damage exceeds the calculated value, the combination has a superadditive effect, that is to say a synergistic effect.

The expected activity for a given combination of three herbicides can likewise be found in the literature cited above.

1. Compositions, characterized by an effective amount of an active compound combination comprising
(a) at least one substituted aryl ketone of the general formula (I) 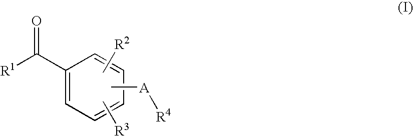
in which
A represents a single bond or represents alkanediyl having 1 to 6 carbon atoms,
R¹ represents one of the groupings below 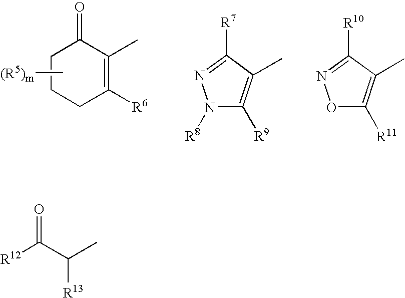
where
m represents the numbers 0 to 6,
R⁵ represents halogen, represents in each case optionally cyano-, halogen- or C₁-C₄-alkoxy-substituted alkyl or alkylthio having in each case 1 to 6 carbon atoms, or represents optionally halogen-, C₁-C₄-alkyl- or C₁-C₄-alkoxy-substituted phenyl, or—if m represents 2—optionally together with a second radical R⁵ also represents a carbonyl group (C═O) or alkanediyl (alkylene) having 2 to 6 carbon atoms,
R⁶ represents hydroxyl, formyloxy, halogen, represents in each case optionally cyano-, halogen- or C₁-C₄-alkoxy-substituted alkoxy, alkylthio, alkylsulfinyl, alkylsulfonyl, alkylcarbonyloxy, alkoxycarbonyloxy, alkylaminocarbonyloxy or alkylsulfonyloxy having in each case 1 to 6 carbon atoms in the alkyl groups, represents in each case optionally cyano- or halogen-substituted alkenyloxy or alkinyloxy having in each case 2 to 6 carbon atoms, or represents in each case optionally nitro-, cyano-, halogen-, C₁-C₄-alkyl-, C₁-C₄-halogenoalkyl-, C₁-C₄-alkoxy- or C₁-C₄-halogenoalkoxy-substituted phenoxy, phenylthio, phenylsulfinyl, phenylsulfonyl, phenylcarbonyloxy, phenylcarbonylalkoxy, phenylsulfonyloxy, phenylalkoxy, phenylalkylthio, phenylalkylsulfinyl or phenylalkylsulfonyl having optionally 1 to 4 carbon atoms in the alkyl moiety,
R⁷ represents hydrogen, cyano, carbamoyl, thiocarbamoyl, halogen, represents in each case optionally cyano-, halogen- or C₁-C₄-alkoxy-substituted alkyl, alkoxy, alkylthio, alkylsulfinyl, alkylsulfonyl or alkoxycarbonyl having in each case 1 to 6 carbon atoms in the alkyl groups, or represents optionally cyano-, halogen- or C₁-C₄-alkyl-substituted cycloalkyl having 3 to 6 carbon atoms,
R⁸ represents hydrogen, represents optionally cyano-, halogen- or C₁-C₄-alkoxy-substituted alkyl having 1 to 6 carbon atoms, represents in each case optionally cyano- or halogen-substituted alkenyl or alkinyl having in each case 2 to 6 carbon atoms, represents in each case optionally cyano-, halogen- or C₁-C₄-alkyl-substituted cycloalkyl or cycloalkylalkyl having in each case 3 to 6 carbon atoms in the cycloalkyl group and optionally 1 to 4 carbon atoms in the alkyl moiety, or represents in each case optionally nitro-, cyano-, halogen-, C₁-C₄-alkyl-, C₁-C₄-halogenoalkyl-, C₁-C₄-alkoxy- or C₁-C₄-halogenoalkoxy-substituted phenyl or phenyl-C₁-C₄-alkyl,
R⁹ represents hydroxyl, formyloxy, represents in each case optionally cyano-, halogen- or C₁-C₄-alkoxy-substituted alkoxy, alkylcarbonyloxy, alkoxycarbonyloxy, alkylaminocarbonyloxy or alkylsulfonyloxy having in each case 1 to 6 carbon atoms in the alkyl groups, represents in each case optionally cyano- or halogen-substituted alkenyloxy or alkinyloxy having in each case 2 to 6 carbon atoms, represents in each case optionally nitro-, cyano-, halogen-, C₁-C₄-alkyl- or C₁-C₄-halogenoalkyl-substituted phenylalkoxy, phenylcarbonyloxy, phenylcarbonylalkoxy or phenylsulfonyloxy having optionally 1 to 4 carbon atoms in the alkyl moiety,
R¹⁰ represents hydrogen, cyano, carbamoyl, thiocarbamoyl, halogen or represents in each case optionally cyano-, halogen- or C₁-C₄-alkoxy-substituted alkyl, alkylcarbonyl, alkoxy, alkoxycarbonyl, alkylthio, alkylsulfinyl or alkylsulfonyl having in each case 1 to 6 carbon atoms in the alkyl groups,
R¹¹ represents hydrogen, represents optionally cyano-, halogen- or C₁-C₄-alkoxy-substituted alkyl having 1 to 6 carbon atoms or represents optionally cyano-, halogen- or C₁-C₄-alkyl-substituted cycloalkyl having 3 to 6 carbon atoms,
R¹² represents hydrogen, represents optionally cyano-, halogen- or C₁-C₄-alkoxy-substituted C₁-C₆-alkyl or represents optionally cyano-, halogen- or C₁-C₄-alkyl-substituted cycloalkyl having 3 to 8 carbon atoms, and
R¹³ represents hydrogen, cyano, carbamoyl, halogen, or represents in each case optionally represents optionally cyano-, halogen- or C₁-C₄-alkoxy-substituted alkyl, alkoxy, alkoxycarbonyl, alkylthio, alkylsulfinyl or alkylsulfonyl having in each case 1 to 6 carbon atoms in the alkyl groups,
R² represents hydrogen, nitro, cyano, carboxyl, carbamoyl, thiocarbamoyl, halogen, or represents in each case optionally represents optionally cyano-, halogen- or C₁-C₄-alkoxy-, C₁-C₄-alkylthio-, C₁-C₄-alkylsulfinyl- or C₁-C₄-alkylsulfonyl-substituted alkyl, alkoxy, alkylthio, alkylsulfinyl, alkylsulfonyl, alkylamino, dialkylamino or dialkylaminosulfonyl having in each case 1 to 6 carbon atoms in the alkyl groups,
R³ represents hydrogen, nitro, cyano, carboxyl, carbamoyl, thiocarbamoyl, halogen, or represents in each case optionally cyano-, halogen- or C₁-C₄-alkoxy-, C₁-C₄-alkylthio-, C₁-C₄-alkylsulfinyl- or C₁-C₄-alkylsulfonyl-substituted alkyl, alkoxy, alkylthio, alkylsulfinyl, alkylsulfonyl, alkylamino, dialkylamino or dialkylaminosulfonyl having in each case 1 to 6 carbon atoms in the alkyl groups, and
R⁴ represents an optionally substituted 4- to 12-membered saturated or unsaturated monocyclic or bicyclic heterocyclic grouping which contains 1 to 4 heteroatoms, up to 4 of which are nitrogen atoms, and optionally—alternatively or additionally—1 to 3 oxygen atoms, sulfur atoms, —SO— groups, —SO₂— groups, —CO— groups and/or —CS— groups,
including all possible tautomeric forms of the compounds of the general formula (I) and the possible salts or acid or base adducts of the compounds of the general formula (I)
(“active compounds of group 1”)
and
(b) one or more compounds from a second group of herbicides comprising the active compounds listed below:
2-chloro-N-(ethoxymethyl)-N-(2-ethyl-6-methyl-phenyl)-acetamide (acetochlor), 5-(2-chloro-4-trifluoromethyl-phenoxy)-2-nitro-benzoic acid sodium salt (acifluorfen-sodium), 2-chloro-6-nitro-3-phenoxy-benzeneamine (aclonifen), 2-chloro-N-(methoxymethyl)-N-(2,6-diethyl-phenyl)-acetamide (alachlor), N-ethyl-N′-i-propyl-6-methylthio-1,3,5-triazine-2,4-diamine (ametryn), 4-amino-N-(1,1-dimethyl-ethyl)-4,5-dihydro-3-(1-methyl-ethyl)-5-oxo-1H-1,2,4-triazole-1-carboxamide (amicarbazone), N-(4,6-dimethoxy-pyrimidin-2-yl)-N′-(N-methyl-N-methylsulfonyl-sulfamoyl)-urea (amidosulfuron), 1H-1,2,4-triazol-3-amine (amitrole), S-[2-[(4-chloro-phenyl)-(1-isopropyl)-amino]-2-oxo-ethyl] O,O-dimethyl phosphorodithioate (anilofos), 6-chloro-4-ethylamino-2-isopropylamino-1,3,5-triazine (atrazine), 2-[2,4-dichloro-5-(2-propinyloxy)-phenyl]-5,6,7,8-tetrahydro-1,2,4-triazolo-[4,3-a]-pyridin-3(2H)-one (azafenidin), N-(4,6-dimethoxy-pyrimidin-2-yl)-N′-[1-methyl-4-(2-methyl-2H-tetrazol-5-yl)-1H-pyrazol-5-ylsulfonyl]-urea (azimsulfuron), N-benzyl-2-(4-fluoro-3-trifluoromethyl-phenoxy)-butanamide (beflubutamid), 4-chloro-2-oxo-3(2H)-benzothiazoleacetic acid (benazolin), N-butyl-N-ethyl-2,6-dinitro-4-trifluoromethyl-benzeneamine (benfluralin), 2,3-dihydro-3,3-dimethyl-5-benzofuranyl-ethanesulfonate (benfuresate), N-(4,6-dimethoxy-pyrimidin-2-yl)-N′-(2-methoxycarbonyl-phenylmethylsulfonyl)-urea (bensulfuron-methyl), S-[(4-chloro-phenyl)-methyl]diethyl-thiocarbamate (benthiocarb, thiobencarb), methyl 2-[2-[4-(3,6-dihydro-3-methyl-2,6-dioxo-4-trifluoromethyl-1(2H)-pyrimidinylphenoxymethyl]-5-ethyl-phenoxy-propanoate (benzfendizone), 3-(2-chloro-4-methylsulfonyl-benzoyl)-4-phenylthio-bicyclo-[3.2.1]-oct-3-en-2-one (benzobicyclon), 2-[[4-(2,4-dichloro-3-methyl-benzoyl)-1,3-dimethyl-1H-pyrazol-5-yl]-oxy]-1-(4-methyl-phenyl)-ethanone (benzofenap), ethyl N-benzoyl-N-(3,4-dichlorophenyl)-DL-alaninate (benzoylprop-ethyl), 3-i-propyl-1H-2,1,3-benzo-thiadiazin-4(3H)-one (bentazon), methyl 5-(2,4-dichloro-phenoxy)-2-nitro-benzoate (bifenox), 2,6-bis-(4,6-dimethoxy-pyrimidin-2-yl-oxy)-benzoic acid sodium salt (bispyribac-sodium), 5-bromo-6-methyl-3-(1-methyl-propyl)-2,4(1H,3H)pyrimidinedione (bromacil), 2-bromo-3,3-dimethyl-N-(1-methyl-1-phenyl-ethyl)-butanamide (bromobutide), 3,5-dibromo-4-hydroxy-benzaldehyde O-(2,4-dinitro-phenyl)-oxime (bromofenoxim), 3,5-dibromo-4-hydroxy-benzonitrile (bromoxynil), N-butoxymethyl-2-chloro-N-(2,6-diethyl-phenyl)-acetamide (butachlor), [1,1-dimethyl-2-oxo-2-(2-propenyloxy)]-ethyl 2-chloro-5-(3,6-dihydro-3-methyl-2,6-dioxo-4-trifluoromethyl-1(2H)-pyrimidinyl)-benzoate (butafenacil-allyl), 2-(1-ethoximino-propyl)-3-hydroxy-5-[2,4,6-trimethyl-3-(1-oxo-butyl)-phenyl]-2-cyclohexen-1-one (butroxydim), S-ethyl-bis-(2-methyl-propyl)-thiocarbamate (butylate), N,N-diethyl-3-(2,4,6-trimethyl-phenylsulfonyl)-1H-1,2,4-triazole-1-carboxamide (cafenstrole), 2-[1-[(3-chloro-2-propenyl)-oxy-imino]-propyl]-3-hydroxy-5-(tetrahydro-2H-pyran-4-yl)-2-cyclohexen-1-one (caloxydim, tepraloxydim), 2-(4-chloro-2-fluoro-5-(2-chloro-2-ethoxycarbonyl-ethyl)-phenyl)-4-difluoro-methyl-5-methyl-2,4-dihydro-3H-1,2,4-triazol-3-one (carfentrazone-ethyl), 2,4-dichloro-1-(3-methoxy-4-nitro-phenoxy)-benzene (chlomethoxyfen), 3-amino-2,5-dichloro-benzoic acid (chloramben), N-(4-chloro-6-methoxy-pyrimidin-2-yl)-N′-(2-ethoxycarbonyl-phenylsulfonyl)-urea (chlorimuron-ethyl), 1,3,5-trichloro-2-(4-nitro-phenoxy)-benzene (chlornitrofen), N-(4-methoxy-6-methyl-1,3,5-triazin-2-yl)-N′-(2-chloro-phenylsulfonyl)-urea (chlorsulfuron), N′-(3-chloro-4-methyl-phenyl)-N,N-dimethyl-urea (chlortoluron), ethyl 2-chloro-3-[2-chloro-5-(1,3,4,5,6,7-hexahydro-1,3-dioxo-2H-isoindol-2-yl)-phenyl]-2-propanoate (cinidon-ethyl), exo-1-methyl-4-isopropyl-2-(2-methyl-phenyl-methoxy)-7-oxabicyclo-[2.2.1]-heptane (cinmethylin), N-(4,6-dimethoxy-1,3,5-triazin-2-yl)-N′-(2-(2-methoxy-ethoxy)-phenylsulfonyl)-urea (cinosulfuron), 2-[1-[2-(4-chloro-phenoxy)-propoxyaminobutyl]]-5-(tetrahydro-2H-thiopyran-3-yl)-1,3-cyclohexanedione (clefoxydim), (E,E)-(+)-2-[1-[[(3-chloro-2-propenyl)-oxy]-imino]-propyl]-3-hydroxy-2-cyclohexen-1-one (clethodim), (R)-(2-propinyl) 2-[4-(5-chloro-3-fluoro-pyridin-2-yl-oxy)-phenoxy-propanoate (clodinafop-propargyl), 2-(2,4-dichloro-3-methyl-phenoxy)-N-phenyl-propanamide (clomeprop), 3,6-dichloro-pyridine-2-carboxylic acid (clopyralid), methyl 3-chloro-2-[(5-ethoxy-7-fluoro[1,2,4]triazolo[1,5-c]pyrimidin-2-yl-sulfonyl)-amino]-benzoate (cloransulam-methyl), N-[(2-chloro-phenyl)-methyl]-N′-(1-methyl-1-phenyl-ethyl)-urea (cumyluron), 2-chloro-4-ethylamino-6-(1-cyano-1-methyl-ethylamino)-1,3,5-triazine (cyanazine), N-(4,6-dimethoxy-pyrimidin-2-yl)-N′-(2-cyclopropylcarbonyl-phenylsulfonyl)-urea (cyclosulfamuron), -2-(1-ethoximinobutyl)-3-hydroxy-5-(tetrahydro-2H-thiopyran-3-yl)-2-cyclo-hexen-1-one (cycloxydim), (R)-2-butyl [4-(4-cyano-2-fluoro-phenoxy)-phenoxy]-propanoate (cyhalofop-butyl), 2,4-dichloro-phenoxyacetic acid (2,4-D), 3,6-dichloro-2-methoxy-benzoic acid (dicamba), (R)-2-(2,4-Dichloro-phenoxy)-propanoic acid (dichlorprop-P), methyl 2-[4-(2,4-dichlorophenoxy)-phenoxy]-propanoate (diclofop-methyl), N-(2,6-dichloro-phenyl)-5-ethoxy-7-fluoro-[1,2,4]-triazolo-[1,5-c]-pyrimidine-2-sulfonamide (diclosulam), 1,2-dimethyl-3,5-diphenyl-1H-pyrazolium methylsulfate (difenzoquat), N-(2,4-difluoro-phenyl)-2-(3-trifluoromethyl-phenoxy)-pyridine-3-carboxamide (diflufenican), 2-[1-[(3,5-difluoro-phenyl)-amino-carbonyl-hydrazono]-ethyl]-pyridine-3-carboxylic acid (diflufenzopyr), S-(1-methyl-1-phenyl-ethyl)-1-piperidine carbothioate (dimepiperate), 2-chloro-N-(2,6-dimethyl-phenyl)-N-(2-methoxy-ethyl)-acetamide (dimethachlor), N-(1,2-dimethyl-propyl)-N′-ethyl-6-methylthio-1,3,5-triazine-2,4-diamine (dimethametryn), (S-) 2-chloro-N-(2,4-dimethyl-3-thienyl)-N-(2-methoxy-1-methyl-ethyl)-acetamide (S-) (dimethenamid), 2-amino-4-(1-fluoro-1-methyl-ethyl)-6-(1-methyl-2-(3,5-dimethyl-phenoxy)-ethylamino)-1,3,5-triazine (dimexyflam), N3,N3-diethyl-2,4-dinitro-6-trifluoromethyl-1,3-diamino-benzene (dinitramine), 6,7-dihydro-dipyrido[1,2-a:2′,1′-c]pyrazinediium (diquat), S,S-dimethyl-2-difluoromethyl-4-i-butyl-6-trifluoromethyl-pyridine-3,5-dicarbothioate (dithiopyr), N′-(3,4-dichloro-phenyl)-N,N-dimethyl-urea (diuron), N-(4-methyl-phenyl)-N′-(1-methyl-1-phenyl-ethyl)-urea (dymron, daimuron), 2-[2-(3-chloro-phenyl)-oxiranylmethyl]-2-ethyl-1H-indene-1,3(2H)-dione (epropodan), S-ethyl dipropylthiocarbamate (EPTC), S-(phenylmethyl)-N-ethyl-N-(1,2-dimethyl-propyl)-thiocarbamate (esprocarb), N-ethyl-N-(2-methyl-2-propenyl)-2,6-dinitro-4-trifluoromethyl-benzeneamine (ethalfluralin), (S)-(2-ethoxy-1-methyl-2-oxoethyl) 2-chloro-5-(2-chloro-4-trifluoromethyl-phenoxy)-benzoate (ethoxyfen), N-(4,6-dimethoxy-pyrimidin-2-yl)-N′-(2-ethoxy-phenoxysulfonyl)-urea (ethoxysulfuron), N-(2,3-dichlorophenyl)-4-ethoxymethoxy-benzamide (etobenzanid), (R)-ethyl-2-[4-(6-chloro-benzoxazol-2-yl-oxy)-phenoxy]-propanoate (fenoxaprop-(P)-ethyl), 4-(2-chloro-phenyl)-N-cyclohexyl-N-ethyl-4,5-dihydro-5-oxo-1H-tetrazole-1-carboxamide (fentrazamide), isopropyl N-benzoyl-N-(3-chloro-4-fluoro-phenyl)-DL-alaninate (flamprop-isopropyl), isopropyl N-benzoyl-N-(3-chloro-4-fluoro-phenyl)-L-alaninate (flamprop-isopropyl-L), methyl N-benzoyl-N-(3-chloro-4-fluoro-phenoxy)-DL-alaninate (flamprop-methyl), N-(2,6-difluoro-phenyl)-8-fluoro-5-methoxy-[1,2,4]-triazolo-[1,5-c]-pyrimidine-2-sulfonamide (florasulam), butyl (R)-2-[4-(5-trifluoromethyl-pyridin-2-yl-oxy)-phenoxy]-propanoate (fluazifop, -butyl, -P-butyl), i-propyl 5-(4-bromo-1-methyl-5-trifluoromethyl-1H-pyrazol-3-yl)-2-chloro-4-fluoro-benzoate (fluazolate), 4,5-dihydro-3-methoxy-4-methyl-5-oxo-N-[(2-trifluoromethoxy-phenyl)-sulfonyl]-1H-1,2,4-triazole-1-carboxamide sodium salt (flucarbazone-sodium), N-(4-fluoro-phenyl)-N-i-propyl-2-(5-trifluoromethyl-1,3,4-thiadiazol-2-yl-oxy)-acetamide (flufenacet), N-(2,6-difluoro-phenyl)-5-methyl-1,2,4-triazolo[1,5-a]-pyrimidine-2-sulfonamide (flumetsulam), pentyl [2-chloro-4-fluoro-5-(1,3,4,5,6,7-hexahydro-1,3-dioxo-2H-isoindol-2-yl)-phenoxy]-acetate (flumiclorac-pentyl), 2-[7-fluoro-3,4-dihydro-3-oxo-4-(2-propinyl)-2H-1,4-benzoxazin-6-yl]-4,5,6,7-tetrahydro-1H-isoindole-1,3-dione (flumioxazin), 2-[4-chloro-2-fluoro-5-[(1-methyl-2-propinyl)-oxy]-phenyl]-4,5,6,7-tetrahydro-1H-isoindole-1,3(2H)-dione (flumipropyn), 3-chloro-4-chloromethyl-1-(3-trifluoromethyl-phenyl)-2-pyrrolidinone (fluorochloridone), ethoxycarbonylmethyl 5-(2-chloro-4-trifluoromethyl-phenoxy)-2-nitro-benzoate (fluoroglycofen-ethyl), 1-(4-chloro-3-(2,2,3,3,3-pentafluoro-propoxymethyl)-phenyl)-5-phenyl-1H-1,2,4-triazol-3-carboxamide (flupoxam), 1-isopropyl-2-chloro-5-(3,6-dihydro-3-methyl-2,6-dioxo-4-trifluoromethyl-1(2H)-pyrimidyl)-benzoate (flupropacil), N-(4,6-dimethoxy-pyrimidin-2-yl)-N′-(3-methoxycarbonyl-6-trifluoromethyl-pyridin-2-yl-sulfonyl)-urea sodium salt (flupyrsulfuron-methyl-sodium), 9-hydroxy-9H-fluorene-9-carboxylic acid (flurenol), (4-amino-3,5-dichloro-6-fluoro-pyridin-2-yl-oxy)-acetic acid (-2-butoxy-1-methyl-ethyl ester, -1-methyl-heptyl ester) (fluroxypyr, -butoxypropyl, -meptyl), 5-methylamino-2-phenyl-4-(3-trifluoromethyl-phenyl)-3(2H)-furanone (flurtamone), methyl-[(2-chloro-4-fluoro-5-(tetrahydro-3-oxo-1H,3H-[1,3,4]-thiadiazolo-[3,4-a]-pyridazin-1-ylidene)-amino-phenyl]-thio-acetate (fluthiacet-methyl), 5-(2-chloro-4-trifluoromethyl-phenoxy)-N-methylsulfonyl-2-nitro-benzamide (fomesafen), 2-[[[[(4,6-dimethoxy-2-pyrimidinyl)-amino]-carbonyl]-amino]-sulfonyl]-4-formylamino-N,N-dimethyl-benzamide (foramsulfuron), 2-amino-4-(hydroxymethylphosphinyl)-butanoic acid (-ammonium salt) (glufosinate (-ammonium)), N-phosphonomethyl-glycine (-isopropylammonium salt), (glyphosate, -isopropylammonium), (R)-2-[4-(3-chloro-5-trifluoromethyl-pyridin-2-yl-oxy)-phenoxy]-propanoic acid (-methyl ester, -2-ethoxy-ethyl ester, -butyl ester) (haloxyfop, -methyl, -P-methyl, -ethoxyethyl, -butyl), 3-cyclohexyl-6-dimethylamino-1-methyl-1,3,5-triazine-2,4(1H,3H)-dione (hexazinone), methyl 2-(4,5-dihydro-4-methyl-4-isopropyl-5-oxo-1H-imidazol-2-yl)-4-methyl-benzoate (imazamethabenz-methyl), 2-(4,5-dihydro-4-methyl-4-isopropyl-5-oxo-1H-imidazol-2-yl)-5-methyl-pyridine-3-carboxylic acid (imazamethapyr), 2-(4,5-dihydro-4-methyl-4-isopropyl-5-oxo-1H-imidazol-2-yl)-5-methoxymethyl-pyridine-3-carboxylic acid (imazamox), 2-(4,5-dihydro-4-methyl-4-isopropyl-5-oxo-1H-imidazol-2-yl)-quinoline-3-carboxylic acid (imazaquin), 2-(4,5-dihydro-4-methyl-4-i-propyl-5-oxo-1H-imidazol-2-yl)-5-ethyl-pyridine-3-carboxylic acid (imazethapyr), N-(4,6-dimethoxy-pyrimidin-2-yl)-N′-(2-chloro-imidazo[1,2-a]-pyridin-3-yl-sulfonyl)-urea (imazosulfuron), N-(4-methoxy-6-methyl-1,3,5-triazin-2-yl)-N′-(5-iodo-2-methoxycarbonyl-phenylsulfonyl)-urea sodium salt (iodosulfuron-methyl-sodium), 4-hydroxy-3,5-diiodo-benzonitrile (ioxynil), N,N-dimethyl-N′-(4-isopropyl-phenyl)-urea (isoproturon), N-(3-(1-ethyl-1-methyl-propyl)-isoxazol-5-yl)-2,6-dimethoxy-benzamide (isoxaben), (4-chloro-2-methylsulfonyl-phenyl)-(5-cyclopropyl-isoxazol-4-yl)-methanone (isoxachlortole), (5-cyclopropyl-isoxazol-4-yl)-(2-methylsulfonyl-4-trifluoromethyl-phenyl)-methanone (isoxaflutole), 2-[2-[4-[3,5-dichloro-2-pyridinyl)-oxy]-phenoxy]-1-oxo-propyl]-isoxazolidine (isoxapyrifop), (2-ethoxy-1-methyl-2-oxo-ethyl) 5-(2-chloro-4-trifluoromethyl-phenoxy)-2-nitro-benzoate (lactofen), N′-(3,4-dichloro-phenyl)-N-methoxy-N-methyl-urea (linuron), (4-chloro-2-methyl-phenoxy)-acetic acid (MCPA), 2-(4-chloro-2-methylphenoxy)-propionic acid (mecoprop), 2-(2-benzothiazolyloxy)-N-methyl-N-phenyl-acetamide (mefenacet), methyl 2-[[[[(4,6-dimethoxy-2-pyrimidinyl)-amino]-carbonyl]-amino]-sulfonyl]-4-[[(methylsulfonyl)-amino]methyl]-benzoate (mesosulfuron), 2-(4-methylsulfonyl-2-nitro-benzoyl)-1,3-cyclohexanedione (mesotrione), 4-amino-3-methyl-6-phenyl-1,2,4-triazin-5(4H)-one (metamitron), 2-chloro-N-(2,6-dimethyl-phenyl)-N-(1H-pyrazol-1-yl-methyl)-acetamide (metazachlor), N′-(4-(3,4-dihydro-2-methoxy-2,4,4-trimethyl-2H-1-benzopyran-7-yl-oxy)-phenyl)-N-methoxy-N-methyl-urea (metobenzuron), N′-(4-bromo-phenyl)-N-methoxy-N-methylurea (metobromuron), (S)-2-chloro-N-(2-ethyl-6-methyl-phenyl)-N-(2-methoxy-1-methyl-ethyl)-acetamide (metolachlor, S-metolachlor), N-(2,6-dichloro-3-methyl-phenyl)-5,7-dimethoxy-1,2,4-triazolo[1,5-a]-pyrimidine-2-sulfon-amide (metosulam), N′-(3-chloro-4-methoxy-phenyl)-N,N-dimethyl-urea (metoxuron), 4-amino-6-tert-butyl-3-methylthio-1,2,4-triazin-5(4H)-one (metribuzin), N-(4-methoxy-6-methyl-1,3,5-triazin-2-yl)-N′-(2-methoxycarbonyl-phenylsulfonyl)-urea (metsulfuron-methyl), S-ethyl hexahydro-1H-azepin-1-carbothioate (molinate), 2-(2-naphthyloxy)-N-phenyl-propanamide (naproanilide), N-butyl-N′-(3,4-dichloro-phenyl)-N-methyl-urea (neburon), N-(4,6-dimethoxy-pyrimidin-2-yl)-N′-(3-dimethylcarbamoyl-pyridin-2-yl-sulfonyl)-urea (nicosulfuron), 4-chloro-5-methylamino-2-(3-trifluoromethyl-phenyl)-3(2H)pyridazinone (norflurazon), S-(2-chloro-benzyl) N,N-diethylthiocarbamate (orbencarb), 4-dipropylamino-3,5-dinitro-benzenesulfonamide (oryzalin), 3-[2,4-dichloro-5-(2-propinyloxy)-phenyl]-5-(t-butyl)-1,3,4-oxadiazol-2(3H)-one (oxadiargyl), 3-[2,4-dichloro-5-(1-methyl-ethoxy)-phenyl]-5-(t-butyl)-1,3,4-oxadiazol-2(3H)-one (oxadiazon), N-(4,6-dimethyl-pyrimidin-2-yl)-N′-(2-oxetan-3-yl-oxycarbonyl-phenylsulfonyl)-urea (oxasulfuron), 3-[1-(3,5-dichloro-phenyl)-1-i-propyl]-2,3-dihydro-6-methyl-5-phenyl-4H-1,3-oxazin-4-one (oxaziclomefone), 2-chloro-1-(3-ethoxy-4-nitro-phenoxy)-4-trifluoromethyl-benzene (oxyfluorfen), 1,1′-dimethyl-4,4′-bipyridinium (paraquat), 1-amino-N-(1-ethyl-propyl)-3,4-dimethyl-2,6-dinitro-benzene (pendimethalin), 4-(t-butyl)-N-(1-ethyl-propyl)-2,6-dinitro-benzeneamine (pendralin), 3-(4-chloro-5-cyclopentyloxy-2-fluoro-phenyl)-5-(1-methyl-ethylidene)-2,4-oxazolidine-dione (pentoxazone), 4-amino-3,5,6-trichloro-pyridine-2-carboxylic acid (picloram), N-(4-fluoro-phenyl)-6-(3-trifluoromethyl-phenoxy)-pyridine-2-carboxamide (picolinafen), S-[2-(2-methyl-1-piperidinyl)-2-oxo-ethyl] O,O-dipropyl phosphorodithioate (piperophos), 2-chloro-N-(2,6-diethyl-phenyl)-N-(2-propoxy-ethyl)-acetamide (pretilachlor), N-(4,6-bis-difluoromethoxy-pyrimidin-2-yl)-N′-(2-methoxycarbonyl-phenylsulfonyl)-urea (primisulfuron-methyl), 1-chloro-N-[2-chloro-4-fluoro-5-[(6S,7aR)-6-fluoro-tetrahydro-1,3-dioxo-1H-pyrrolo[1,2-c]-imidazol-2(3H)-yl]-phenyl]-methanesulfonamide (profluazol), 2-chloro-N-isopropyl-N-phenyl-acetamide (propachlor), N-(3,4-dichloro-phenyl)-propanamide (propanil), (R)-[2-[[(1-methyl-ethylidene)-amino]-oxy]-ethyl] 2-[4-(6-chloro-2-quinoxalinyloxy)-phenoxy]-propanoate (propaquizafop), 2-chloro-N-(2-ethyl-6-methyl-phenyl)-N-[(1-methyl-ethoxy)-methyl]-acetamide (propisochlor), methyl 2-[[[(4,5-dihydro-4-methyl-5-oxo-3-propoxy-1H-1,2,4-triazol-1-yl)-carbonyl]-amino]-sulfonyl]-benzoate sodium salt (propoxycarbazone-sodium), S-phenylmethyl-N,N-dipropyl-thiocarbamate (prosulfocarb), N-(4-methoxy-6-methyl-1,3,5-triazin-2-yl)-N′-(2-(3,3,3-trifluoro-propyl)-phenylsulfonyl)-urea (prosulfuron), ethyl [2-chloro-5-(4-chloro-5-difluoromethoxy-1-methyl-1H-pyrazol-3-yl)-4-fluoro-phenoxy]-acetate (pyraflufen-ethyl), 1-(3-chloro-4,5,6,7-tetrahydro-pyrazolo[1,5-a]pyridin-2-yl)-5-(methyl-2-propinylamino)-1H-pyrazole-4-carbonitrile (pyraclonil, pyrazogyl), 4-(2,4-dichloro-benzoyl)-1,3-dimethyl-5-(4-methyl-phenylsulfonyloxy)-pyrazole (pyrazolate), 4-(2,4-dichloro-benzoyl)-1,3-dimethyl-5-(phenylcarbonylmethoxy)-pyrazole (pyrazoxyfen), N-(4,6-dimethoxy-pyrimidin-2-yl)-N′-(4-ethoxycarbonyl-1-methyl-pyrazol-5-yl-sulfonyl)-urea (pyrazosulfuron-ethyl), diphenylmethanone O-[2,6-bis-(4,6-dimethoxy-pyrimidin-2-yl-oxy)-benzoyl]-oxime (pyribenzoxim), O-[3-(1,1-dimethyl-ethyl)-phenyl] (6-methoxy-2-pyridinyl)-methylthiocarbamate (pyributicarb), 6-chloro-3-phenyl-4-pyridazinol (pyridafol), O-(6-chloro-3-phenyl-pyridazin-4-yl) S-octyl-thiocarbonate (pyridate), 6-chloro-3-phenyl-pyridazin-4-ol (pyridatol), 7-[(4,6-dimethoxy-2-pyrimidinyl)-thio]-3-methyl-1(3H)-isobenzofuranone (pyriftalid), methyl 2-(4,6-dimethoxy-pyrimidin-2-yl-oxy)-benzoate (pyriminobac-methyl), 2-chloro-6-(4,6-dimethoxy-pyrimidin-2-ylthio)-benzoic acid sodium salt (pyrithiobac-sodium), 3,7-dichloro-quinoline-8-carboxylic acid (quinchlorac), 7-chloro-3-methyl-quinoline-8-carboxylic acid (quinmerac), 2-[4-(6-chloro-2-quinoxalinyloxy)-phenoxy]-propanoic acid (-ethyl ester, -tetrahydro-2-furanyl-methyl ester) (quizalofop, -ethyl, -P-ethyl, -P-tefuryl), N-(4,6-dimethoxy-pyrimidin-2-yl)-N′-(3-ethylsulfonyl-pyridin-2-yl-sulfonyl)-urea (rimsulfuron), 2-(1-ethoximinobutyl)-5-(2-ethylthiopropyl)-3-hydroxy-2-cyclohexen-1-one (sethoxydim), 6-chloro-2,4-bis-ethylamino-1,3,5-triazine (simazine), 2-(2-chloro-4-methylsulfonyl-benzoyl)-cyclohexane-1,3-dione (sulcotrione), 2-(2,4-dichloro-5-methylsulfonylamino-phenyl)-4-difluoromethyl-5-methyl-2,4-dihydro-3H-1,2,4-triazol-3-one (sulfentrazone), methyl 2-[[[[(4,6-dimethyl-2-pyrimidinyl)-amino]-carbonyl]-amino]-sulfonyl]-benzoate (sulfometuron-methyl), N-phosphonomethyl-glycine-trimethylsulfonium (sulfosate), N-(4,6-dimethoxy-pyrimidin-2-yl)-N′-(2-ethylsulfonyl-imidazo-[1,2-a]pyridine-3-sulfonamide (sulfosulfuron), 6-chloro-4-ethylamino-2-tert-butylamino-1,3,5-triazine (terbuthylazine), 2-tert-butylamino-4-ethylamino-6-methylthio-1,3,5-triazine (terbutryn), 2-chloro-N-(2,6-dimethyl-phenyl)-N-(3-methoxy-2-thienyl-methyl)-acetamide (thenylchlor), methyl 2-difluoromethyl-5-(4,5-dihydro-thiazol-2-yl)-4-(2-methyl-propyl)-6-trifluoromethyl-pyridine-3-carboxylate (thiazopyr), 6-(6,7-dihydro-6,6-dimethyl-3H,5H-pyrrolo[2,1-c]-1,2,4-thiadiazol-3-ylideneamino)-7-fluoro-4-(2-propinyl)-2H-1,4-benzoxazin-3(4H)-one (thidiazimin), N-(4-methoxy-6-methyl-1,3,5-triazin-2-yl)-N′-(2-methoxycarbonyl-thien-3-yl-sulfonyl)-urea (thifensulfuron-methyl), 2-(ethoximino-propyl)-3-hydroxy-5-(2,4,6-trimethyl-phenyl)-2-cyclohexen-1-one (tralkoxydim), S-(2,3,3-trichloro-2-propenyl)diisopropylcarbamothioate (triallate), N-(4-methoxy-6-methyl-1,3,5-triazin-2-yl)-N′-[2-(2-chloro-ethoxy)-phenylsulfonyl]-urea (triasulfuron), N-methyl-N-(4-methoxy-6-methyl-1,3,5-triazin-2-yl)-N′-(2-methoxycarbonyl-phenylsulfonyl)-urea (tribenuron-methyl), (3,5,6-trichloro)-pyridin-2-yl-oxy-acetic acid (triclopyr), 2-(3,5-dichloro-phenyl)-2-(2,2,2-trichloro-ethyl)-oxirane (tridiphane), N-[[(4,6-dimethoxy-2-pyrimidinyl)-amino]-carbonyl]-3-(2,2,2-trifluoro-ethoxy)-2-pyridinesulfonamide sodium salt (trifloxysulfuron), 1-amino-2,6-dinitro-N,N-dipropyl-4-trifluoromethyl-benzene (trifluralin), N-[4-dimethylamino-6-(2,2,2-trifluoro-ethoxy)-1,3,5-triazin-2-yl]-N′-(2-methoxycarbonyl-phenylsulfonyl)-urea (triflusulfuron-methyl), N-(4-methoxy-6-trifluoromethoxy-1,3,5-triazin-2-yl)-N′-(2-trifluoromethyl-phenylsulfonyl)-urea (tritosulfuron), N-[[(4,6-dimethoxy-2-pyrimidinyl)-amino]-carbonyl]-3-(N-methyl-N-methylsulfonyl-amino)-2-pyridinesulfonamide, (cf WO-A-92/10660), 4-[4,5-dihydro-4-methyl-5-oxo-(3-trifluoromethyl)-1H-1,2,4-triazol-1-yl]-2-[(ethylsulfonyl)amino]-5-fluoro-benzenecarbothioamide (cf. WO-A-95/30661)
(“active compounds of group 2”),
and optionally additionally
(c) at least one compound which improves crop plant compatibility, from the group of compounds below:
4-dichloroacetyl-1-oxa-4-aza-spiro[4.5]-decane (AD-67), 1-dichloroacetyl-hexahydro-3,3,8a-trimethylpyrrolo[1,2-a]-pyrimidin-6(2H)-one (BAS-145138), 4-dichloroacetyl-3,4-dihydro-3-methyl-2H-1,4-benzoxazine (benoxacor), 1-methyl-hexyl 5-chloro-quinoxalin-8-oxy-acetate (cloquintocet-mexyl, α-(cyanomethoximino)-phenylacetonitrile (cyometrinil), 2,4-dichlorophenoxy acetic acid (2,4-D), 2,2-dichloro-N-(2-oxo-2-(2-propenylamino)-ethyl)-N-(2-propenyl)-acetamide (DKA-24), 2,2-dichloro-N,N-di-2-propenyl acetamide (dichlormid), N-(4-methyl-phenyl)-N′-(1-methyl-1-phenyl-ethyl)-urea (dymron), 4,6-dichloro-2-phenyl-pyrimidine (fenclorim), ethyl 1-(2,4-dichloro-phenyl)-5-trichloro-methyl-1H-1,2,4-triazole-3-carboxylate (fenchlorazol-ethyl), phenylmethyl 2-chloro-4-trifluoromethyl-thiazole-5-carboxylate (flurazole), 4-chloro-N-(1,3-dioxolan-2-yl-methoxy)-α-trifluoro-acetophenone oxime (fluxofenim), 3-dichloroacetyl-5-(2-furanyl)-2,2-dimethyl-oxazolidine (furilazole, MON-13900), ethyl-4,5-dihydro-5,5-diphenyl-3-isoxazolecarboxylate (isoxadifen-ethyl), (4-chloro-2-methyl-phenoxy)-acetic acid (MCPA), (+-)-2-(4-chloro-methylphenoxy)-propionic acid (mecoprop), diethyl 1-(2,4-dichlorophenyl)-4,5-dihydro-5-methyl-1H-pyrazole-3,5-dicarboxylate (mefenpyr-diethyl), 2-dichloromethyl-2-methyl-1,3-dioxolan (MG-191), 1,8-naphthalic anhydride, α-(1,3-dioxolan-2-yl-methoximino)-phenylacetonitrile (oxabetrinil), 2,2-dichloro-N-(1,3-dioxolan-2-yl-methyl)-N-(2-propenyl)-acetamide (PPG-1292), 3-dichloroacetyl-2,2,5-trimethyl-oxazolidine (R-29148), N-cyclopropyl-4-[[(2-methoxy-5-methyl-benzoyl)-amino]-sulfonyl]-benzamide, N-[[(4-methoxyacetylamino)-phenyl]-sulfonyl-2-methoxy-benzamide and N-[[(4-methylaminocarbonylamino)-phenyl]-sulfonyl-2-methoxy-benzamide (the latter each known from WO-A-99/66795)
(“active compounds of group 3”).

2. Compositions according to claim 1, characterized in that they comprise, as active compound of group 1, at least one aryl ketone of the general formula (I) in which
m represents the numbers 0, 1, 2, 3 or 4,
A represents a single bond or represents alkanediyl (alkylene) having 1 to 3 carbon atoms,
R¹ represents one of the groupings below 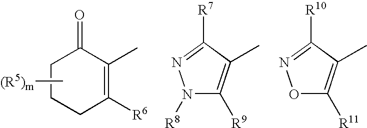
R² represents hydrogen, nitro, cyano, carboxyl, carbamoyl, thiocarbamoyl, fluorine, chlorine, bromine, iodine, or represents in each case optionally cyano-, fluorine-, chlorine-, bromine-, C₁-C₃-alkoxy-, C₁-C₃-alkylthio-, C₁-C₃-alkylsulfinyl- or C₁-C₃-alkylsulfonyl-substituted alkyl, alkoxy, alkylthio, alkylsulfinyl, alkylsulfonyl, alkylamino, dialkylamino or dialkylaminosulfonyl having in each case 1 to 5 carbon atoms in the alkyl groups,
R³ represents hydrogen, nitro, cyano, carboxyl, carbamoyl, thiocarbamoyl, fluorine, chlorine, bromine, iodine, or represents in each case optionally cyano-, fluorine-, chlorine-, bromine-, C₁-C₃-alkoxy-, C₁-C₃-alkylthio-, C₁-C₃-alkylsulfinyl- or C₁-C₃-alkylsulfonyl-substituted alkyl, alkoxy, alkylthio, alkylsulfinyl, alkylsulfonyl, alkylamino, dialkylamino or dialkylaminosulfonyl having in each case 1 to 5 carbon atoms in the alkyl groups,
R⁴ represents one of the heterocyclic groupings below 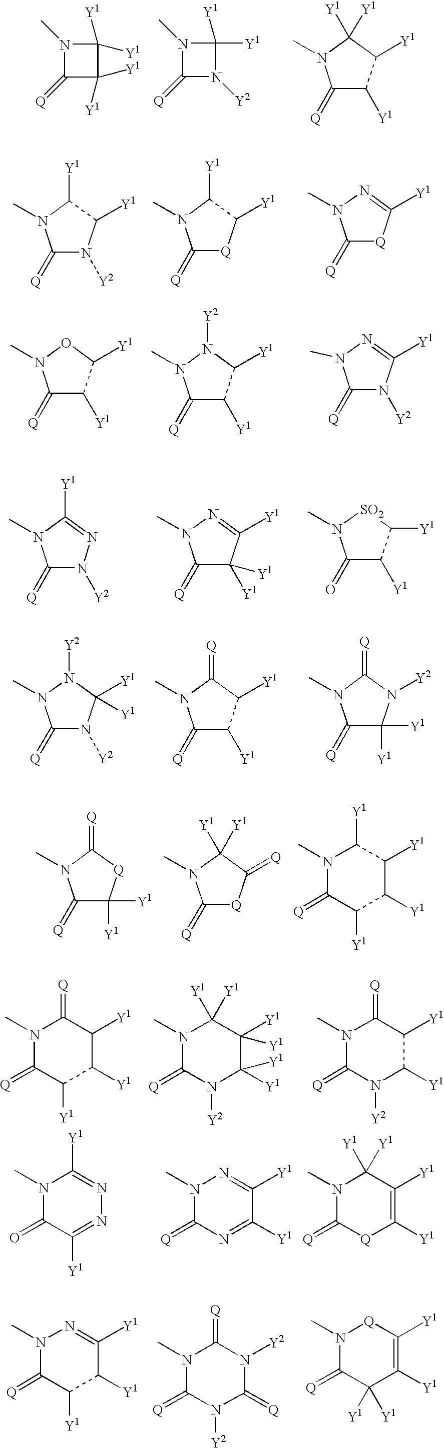 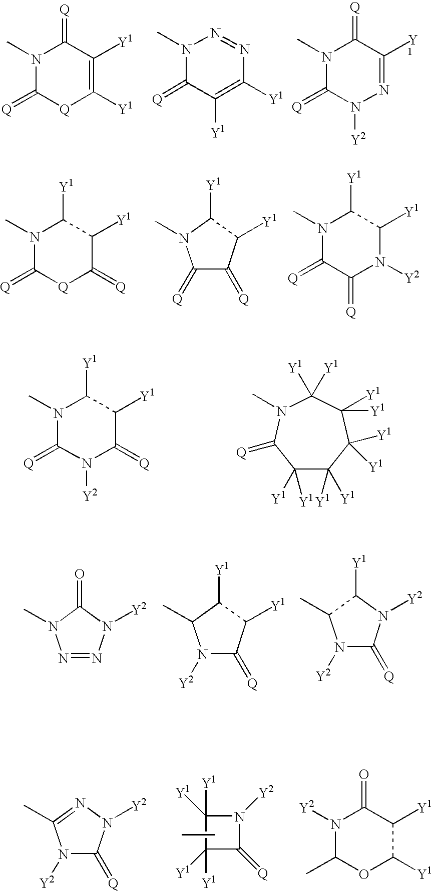
where in each case the broken bond is a single bond or a double bond,
Q represents oxygen or sulfur,
Y¹ represents hydrogen, hydroxyl, mercapto, cyano, fluorine, chlorine, bromine, iodine, represents in each case optionally cyano-, fluorine-, chlorine-, bromine-, C₁-C₃-alkoxy-, C₁-C₃-alkylthio-, C₁-C₃-alkylsulfinyl- or C₁-C₃-alkylsulfonyl-substitued alkyl, alkylcarbonyl, alkoxy, alkoxycarbonyl, alkylthio, alkylsulfinyl or alkylsulfonyl having in each case up to 5 carbon atoms in the alkyl groups, represents in each case optionally fluorine- or chlorine-substitued alkylamino or dialkylamino having in each case up to 5 carbon atoms in the alkyl groups, represents in each case optionally fluorine-, chlorine- and/or bromine-substituted alkenyl, alkinyl, alkenyloxy, alkenylthio or alkenylamino having in each case up to 5 carbon atoms in the alkenyl or alkinyl groups, represents in each case optionally fluorine-, chlorine- and/or bromine-substituted cycloalkyl, cycloalkyloxy, cycloalkylthio, cycloalkylamino, cycloalkylalkyl, cycloalkylalkoxy, cycloalkylalkylthio or cycloalkylalkylamino having in each case 3 to 6 carbon atoms in the cycloalkyl groups and optionally up to 3 carbon atoms in the alkyl moiety, or represents in each case optionally fluorine-, chlorine-, bromine-, iodine-, C₁-C₄-alkyl- or C₁-C₄-alkoxy-substituted phenyl, phenyloxy, phenylthio, phenylamino, benzyl, benzyloxy, benzylthio or benzylamino, represents pyrrolidino, piperidino or morpholino, or—if two adjacent radicals Y¹ and Y¹ are located at a double bond—together with the adjacent radical Y¹ also represents a benzo grouping, and
Y² represents hydrogen, hydroxyl, amino, alkylideneamino having up to 4 carbon atoms, represents in each case optionally fluorine-, chlorine-, bromine- or C₁-C₃-alkoxy-substituted alkyl, alkoxy, alkylamino, dialkylamino or alkanoylamino having in each case up to 5 carbon atoms in the alkyl groups, represents in each case optionally fluorine-, chlorine- and/or bromine-substituted alkenyl, alkinyl or alkenyloxy having in each case up to 5 carbon atoms in the alkenyl or alkinyl groups, represents in each case optionally fluorine-, chlorine- and/or bromine-substituted cycloalkyl, cycloalkylalkyl or cycloalkylamino having in each case 3 to 6 carbon atoms in the cycloalkyl groups and optionally up to 3 carbon atoms in the alkyl moiety, or represents in each case optionally fluorine-, chlorine-, bromine-, iodine-, C₁-C₄-alkyl- or C₁-C₄-alkoxy-substituted phenyl or benzyl, or together with an adjacent radical Y¹ or Y² represents optionally halogen- or C₁-C₄-alkyl-substituted alkanediyl having 3 to 5 carbon atoms,
where the individual radicals Y¹ and Y²—if more than one of them, preferably up to three, are attached to the same heterocyclic groupings—can have identical or different meanings within the scope of the above definition,
R⁵ represents fluorine, chlorine, bromine, represents in each case optionally cyano-, fluorine-, chlorine-, bromine- or C₁-C₃-alkoxy-substituted alkyl or alkylthio having in each case 1 to 5 carbon atoms, represents optionally fluorine-, chlorine-, bromine-, C₁-C₄-alkyl- or C₁-C₄-alkoxy-substituted phenyl, or optionally also—if m represents 2—together with a second radical R⁵ represents alkanediyl (alkylene) having 2 to 6 carbon atoms,
R⁶ represents hydroxyl, formyloxy, or represents in each case optionally cyano-, fluorine-, chlorine- or C₁-C₃-alkoxy-substituted alkoxy, alkylthio, alkylsulfinyl, alkylsulfonyl, alkylcarbonyloxy, alkoxycarbonyloxy, alkylaminocarbonyloxy or alkylsulfonyloxy having in each case 1 to 5 carbon atoms in the alkyl groups, represents in each case optionally cyano-, fluorine-, chlorine- and/or bromine-substituted alkenyloxy or alkinyloxy having in each case 3 to 5 carbon atoms, or represents in each case optionally nitro-, cyano-, fluorine-, chlorine-, bromine-, or (in each case fluorine- and/or chlorine-substituted) C₁-C₄-alkyl- or C₁-C₄-alkoxy-substituted phenoxy, phenylthio, phenylsulfinyl, phenylsulfonyl, phenylcarbonyloxy, phenylcarbonylalkoxy, phenyisulfonyloxy, phenylalkoxy, phenylalkylthio, phenylalkylsulfinyl or phenylalkylsulfonyl having optionally 1 to 4 carbon atoms in the alkyl moiety,
R⁷ represents hydrogen, cyano, carbamoyl, thiocarbamoyl, fluorine, chlorine, bromine, represents in each case optionally cyano-, fluorine-, chlorine-, bromine- or C₁-C₃-alkoxy-substituted alkyl, alkoxy, alkylthio, alkylsulfinyl, alkylsulfonyl or alkoxycarbonyl having in each case 1 to 5 carbon atoms in the alkyl groups, or represents optionally cyano-, fluorine-, chlorine, bromine- or C₁-C₃-alkyl-substituted cycloalkyl having 3 to 6 carbon atoms,
R⁸ represents hydrogen, represents in each case optionally cyano-, fluorine-, chlorine-, bromine- or C₁-C₃-alkoxy-substituted alkyl having 1 to 5 carbon atoms, represents in each case optionally cyano-, fluorine-, chlorine- and/or bromine-substituted alkenyl or alkinyl having in each case 3 to 5 carbon atoms, represents in each case optionally cyano-, fluorine-, chlorine-, bromine- or C₁-C₃-alkyl-substituted cycloalkyl or cycloalkylalkyl having in each case 3 to 6 carbon atoms in the cycloalkyl group and optionally 1 to 3 carbon atoms in the alkyl moiety, or represents in each case optionally nitro-, cyano-, fluorine-, chlorine-, bromine-, iodine-, or (in each case optionally fluorine- and/or chlorine-substituted) C₁-C₄-alkyl- or C₁-C₄-alkoxy-substituted phenyl or phenyl-C₁-C₄-alkyl,
R⁹ represents hydroxyl, formyloxy, represents in each case optionally cyano-, fluorine-, chlorine-, bromine- or C₁-C₃-alkoxy-substituted alkoxy, alkylcarbonyloxy, alkoxycarbonyloxy, alkylaminocarbonyloxy or alkylsulfonyloxy having in each case 1 to 5 carbon atoms in the alkyl groups, represents in each case optionally cyano-, fluorine-, chlorine- and/or bromine-substituted alkenyloxy or alkinyloxy having in each case 3 to 5 carbon atoms, or represents in each case optionally nitro-, cyano-, fluorine-, chlorine-, bromine-, iodine-, or (in each case optionally fluorine- and/or substituted) C₁-C₄-alkyl- or C₁-C₄-alkoxy-substituted phenylalkoxy, phenylcarbonyloxy, phenylcarbonylalkoxy or phenylsulfonyloxy having optionally 1 to 3 carbon atoms in the alkyl moiety,
R¹⁰ represents hydrogen, cyano, carbamoyl, thiocarbamoyl, fluorine, chlorine, bromine, or represents in each case optionally cyano-, fluorine-, chlorine-, bromine- or C₁-C₃-alkoxy-substituted alkyl, alkylcarbonyl, alkoxy, alkoxycarbonyl, alkylthio, alkylsulfinyl or alkylsulfonyl having in each case 1 to 5 carbon atoms in the alkyl groups,
R¹¹ represents hydrogen, represents optionally cyano-, fluorine-, chlorine-, bromine- or C₁-C₃-alkoxy-substituted alkyl having 1 to 5 carbon atoms or represents optionally cyano-, fluorine-, chlorine-, bromine- or C₁-C₃-alkyl-substituted cycloalkyl having 3 to 6 carbon atoms,
R¹² represents hydrogen, represents optionally cyano-, fluorine-, chlorine-, bromine- or C₁-C₃-alkoxy-substituted alkyl having 1 to 5 carbon atoms or represents optionally cyano-, fluorine-, chlorine-, bromine- or C₁-C₃-alkyl-substituted cycloalkyl having 3 to 6 carbon atoms, and
R¹³ represents hydrogen, cyano, carbamoyl, fluorine, chlorine, bromine, or represents in each case optionally cyano-, fluorine-, chlorine-, bromine- or C₁-C₃-alkoxy-substituted alkyl, alkoxy, alkoxycarbonyl, alkylthio, alkylsulfinyl or alkylsulfonyl having in each case 1 to 5 carbon atoms in the alkyl groups.

3. Compositions according to claim 1 or 2, characterized in that they comprise, as active compound of group 1, at least one aryl ketone of the general formula (I) in which
m represents the number 0, 1, 2 or 3,
A represents a single bond or represents methylene, ethane-1,2-diyl (dimethylene), ethane-1,1-diyl, propane-1,2-diyl or propane-1,3-diyl (trimethylene),
R² represents hydrogen, nitro, cyano, carboxyl, carbamoyl, thiocarbamoyl, fluorine, chlorine, bromine, iodine, or represents in each case optionally fluorine-, chlorine-, methoxy-, ethoxy-, n- or i-propoxy-, methylthio-, ethylthio-, n- or i-propylthio-, methylsulfinyl-, ethylsulfinyl-, methylsulfonyl- or ethylsulfonyl-substituted methyl, ethyl, n- or i-propyl, n-, i-, s- or t-butyl, represents in each case optionally fluorine- and/or chlorine-, methoxy-, ethoxy-, n- or i-propoxy-substituted methoxy, ethoxy, n- or i-propoxy, represents in each case optionally fluorine- and/or chlorine-substituted methylthio, ethylthio, n- or i-propylthio, methylsulfinyl, ethylsulfinyl, n- or i-propylsulfinyl, methylsulfonyl, ethylsulfonyl, n- or i-propylsulfonyl, or represents methylamino, ethylamino, n- or i-propylamino, dimethylamino, diethylamino, dimethylaminosulfonyl or diethylaminosulfonyl,
R³ represents hydrogen, nitro, cyano, carboxyl, carbamoyl, thiocarbamoyl, fluorine, chlorine, bromine, represents in each case optionally fluorine-, chlorine-, methoxy-, ethoxy-, n- or i-propoxy-, methylthio-, ethylthio-, n- or i-propylthio-, methylsulfinyl-, ethylsulfinyl-, methylsulfonyl- or ethylsulfonyl-substituted methyl, ethyl, n- or i-propyl, n-, i-, s- or t-butyl, represents in each case optionally fluorine- and/or chlorine-, methoxy-, ethoxy-, n- or i-propoxy-substituted methoxy, ethoxy, n- or i-propoxy, represents in each case optionally fluorine- and/or chlorine-substituted methylthio, ethylthio, n- or i-propylthio, methylsulfinyl, ethylsulfinyl, n- or i-propylsulfinyl, methylsulfonyl, ethylsulfonyl, n- or i-propylsulfonyl, or represents methylamino, ethylamino, n- or i-propylamino, dimethylamino, diethylamino, dimethylaminosulfonyl or diethylaminosulfonyl,
R⁴ represents one of the heterocyclic groupings below 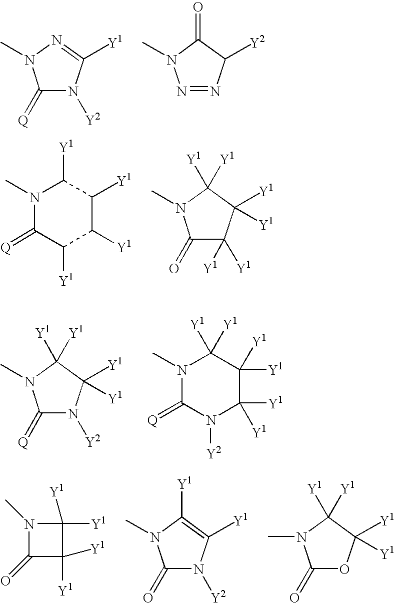
where in each case the broken bond is a single bond or a double bond,
Q represents oxygen,
Y¹ represents hydrogen, hydroxyl, mercapto, cyano, fluorine, chlorine, bromine, iodine, represents in each case optionally fluorine-, chlorine- methoxy-, ethoxy-, n- or i-propoxy-, methylthio-, ethylthio-, n- or i-propylthio-, methylsulfinyl-, ethylsulfinyl-, methylsulfonyl- or ethylsulfonyl-substituted methyl, ethyl, n- or i-propyl, n-, i-, s- or t-butyl, methoxy, ethoxy, n- or i-propoxy, n-, i-, s- or t-butoxy, methylthio, ethylthio, n- or i-propylthio, n-, i-, s- or t-butylthio, methylsulfinyl, ethylsulfinyl, n- or i-propylsulfinyl, methylsulfonyl, ethylsulfonyl, n- or i-propylsulfonyl, represents methylamino, ethylamino, n- or i-propylamino, n-, i-, s- or t-butylamino, dimethylamino, diethylamino, di-n-propylamino or di-i-propylamino, represents in each case optionally fluorine- and/or chlorine-substituted ethenyl, propenyl, butenyl, ethinyl, propinyl, butinyl, propenyloxy, butenyloxy, propenylthio, butenylthio, propenylamino or butenylamino, represents in each case optionally fluorine- and/or chlorine-substituted cyclopropyl, cyclobutyl, cyclopentyl, cyclohexyl, cyclopropyloxy, cyclobutyloxy, cyclopentyloxy, cyclohexyloxy, cyclopropylthio, cyclobutylthio, cyclopentylthio, cyclohexylthio, cyclopropylamino, cyclobutylamino, cyclopentylamino, cyclohexylamino, cyclopropylmethyl, cyclobutylmethyl, cyclopentylmethyl, cyclohexylmethyl, cyclopropylmethoxy, cyclobutylmethoxy, cyclopentylmethoxy, cyclohexylmethoxy, cyclopropylmethylthio, cyclobutylmethylthio, cyclopentylmethylthio, cyclohexylmethylthio, cyclopropylmethylamino, cyclobutylmethylamino, cyclopentylmethylamino or cyclohexylmethylamino, or represents in each case optionally fluorine-, chlorine-, methyl-, ethyl-, n- or i-propyl-, n-, i-, s- or t-butyl-, methoxy-, ethoxy-, n- or i-propoxy-substituted phenyl, phenyloxy, phenylthio, phenylamino, benzyl, benzyloxy, benzylthio or benzylamino, represents pyrrolidino, piperidino or morpholino, or—if two adjacent radicals Y¹ and Y¹ are located at a double bond—together with the adjacent radical Y¹ also represents a benzo grouping, and
Y² represents hydrogen, hydroxyl, amino, represents in each case optionally fluorine- and/or chlorine-, methoxy- or ethoxy-substituted methyl, ethyl, n- or i-propyl, n-, i- or s-butyl, methoxy, ethoxy, n- or i-propoxy, methylamino, ethylamino or dimethylamino, represents in -each case optionally fluorine- and/or chlorine-substituted ethenyl, propenyl, ethinyl, propinyl or propenyloxy, represents in each case optionally fluorine- and/or chlorine-substituted cyclopropyl, cyclobutyl, cyclopentyl, cyclohexyl, cyclopropylmethyl, cyclobutylmethyl, cyclopentylmethyl, cyclohexylmethyl, or represents in each case optionally fluorine-, chlorine-, methyl-, ethyl-, n- or i-propyl-, n-, i-, s- or t-butyl-, methoxy-, ethoxy-, n- or i-propoxy-substituted phenyl or benzyl, or together with an adjacent radical Y¹ or Y² represents in each case optionally methyl- and/or ethyl-substituted propane-1,3-diyl (trimethylene) or butane-1,4-diyl (tetramethylene),
R⁵ represents fluorine, chlorine, bromine, represents in each case optionally cyano-, fluorine-, chlorine-, methoxy- or ethoxy-substituted methyl, ethyl, n- or i-propyl, n-, i-, s- or t-butyl, methylthio, ethylthio, n- or i-propylthio, represents optionally fluorine-, chlorine-, methyl- or methoxy-substituted phenyl, or optionally also—if m represents 2—together with a second radical R⁵ represents ethane-1,2-diyl (dimethylene), propane-1,3-diyl (trimethylene) or butane-1,4-diyl (tetramethylene),
R⁶ represents hydroxyl, formyloxy, represents in each case optionally cyano-, fluorine-, chlorine-, methoxy- or ethoxy-substituted methoxy, ethoxy, n- or i-propoxy, methylthio, ethylthio, n- or i-propylthio, methylsulfinyl, ethylsulfinyl, methylsulfonyl, ethylsulfonyl, acetyloxy, propionyloxy, n- or i-butyroyloxy, methoxycarbonyloxy, ethoxycarbonyloxy, n- or i-propoxycarbonyloxy, methylaminocarbonyloxy, ethylaminocarbonyloxy, n- or i-propylaminocarbonyloxy, methylsulfonyloxy, ethylsulfonyloxy, n- or i-propylsulfonyloxy, represents in each case optionally cyano-, fluorine-, chlorine- or bromine-substituted propenyloxy, butenyloxy, propinyloxy or butinyloxy, or represents in each case optionally nitro-, cyano-, fluorine-, chlorine-, bromine-, methyl-, ethyl-, n- or i-propyl-, n-, i-, s- or t-butyl-, trifluoromethyl-, methoxy-, ethoxy-, n- or i-propoxy-, difluoromethoxy- or trifluoromethoxy-substituted phenoxy, phenylthio, phenylsulfinyl, phenylsulfonyl, benzoyloxy, benzoylmethoxy, phenylsulfonyloxy, phenylmethoxy, phenylmethylthio, phenylmethylsulfinyl or phenylmethylsulfonyl,
R⁷ represents hydrogen, cyano, carbamoyl, thiocarbamoyl, fluorine, chlorine, bromine, represents in each case optionally cyano-, fluorine-, chlorine-, methoxy- or ethoxy-substituted methyl, ethyl, n- or i-propyl, methoxy, ethoxy, n- or i-propoxy, methylthio, ethylthio, n- or i-propylthio, methylsulfinyl, ethylsulfinyl, methylsulfonyl, ethylsulfonyl, methoxycarbonyl, ethoxycarbonyl, n- or i-propoxycarbonyl, or represents in each case optionally cyano-, fluorine-, chlorine-, bromine-, methyl- or ethyl-substituted cyclopropyl, cyclobutyl, cyclopentyl or cyclohexyl,
R⁸ represents hydrogen, represents in each case optionally cyano-, fluorine-, chlorine-, bromine-, methoxy- or ethoxy-substituted methyl, ethyl, n- or i-propyl, n-, i-, s- or t-butyl, represents in each case optionally cyano-, fluorine-, chlorine- or bromine-substituted propenyl, butenyl, propinyl or butinyl, represents in each case optionally cyano-, fluorine-, chlorine-, bromine-, methyl- or ethyl-substituted cyclopropyl, cyclobutyl, cyclopentyl, cyclohexyl, cyclopropylmethyl, cyclobutylmethyl, cyclopentylmethyl or cyclohexylmethyl, or represents in each case optionally nitro-, cyano-, fluorine-, chlorine-, bromine- methyl-, ethyl-, n- or i-propyl-, n-, i-, s- or t-butyl-, trifluoromethyl-, methoxy-, ethoxy-, n- or propoxy-, difluoromethoxy- or trifluoromethoxy-substituted phenyl or benzyl,
R⁹ represents hydroxyl, formyloxy, represents in each case optionally cyano-, fluorine-, chlorine-, bromine-, methoxy-, ethoxy-, n- or i-propoxy-substituted methoxy, ethoxy, n- or i-propoxy, acetyloxy, propionyloxy, n- or i-butyroyloxy, methoxycarbonyloxy, ethoxycarbonyloxy, n- or i-propoxycarbonyloxy, methylaminocarbonyloxy, ethylaminocarbonyloxy, n- or i-propylaminocarbonyloxy, methylsulfonyloxy, ethylsulfonyloxy, n- or i-propylsulfonyloxy, represents in each case optionally cyano-, fluorine-, chlorine- or bromine-substituted propenyloxy, butenyloxy, propinyloxy or butinyloxy, or represents in each case optionally nitro-, cyano-, fluorine-, chlorine-, bromine-, methyl-, ethyl-, n- or i-propyl-, n-, i-, s- or t-butyl-, trifluoromethyl-, methoxy-, ethoxy-, n- or i-propoxy-, difluoromethoxy- or trifluoromethoxy-substituted phenylmethoxy, benzoyloxy, benzoylmethoxy or phenylsulfonyloxy,
R¹⁰ represents hydrogen, cyano, carbamoyl, thiocarbamoyl, fluorine, chlorine, bromine, or represents in each case optionally cyano-, fluorine-, chlorine-, bromine-, methoxy- or ethoxy-substituted methyl, ethyl, n- or i-propyl, acetyl, propionyl, n- or i-butyroyl, methoxy, ethoxy, n- or i-propoxy, methoxycarbonyl, ethoxycarbonyl, n- or i-propoxycarbonyl, methylthio, ethylthio, n- or i-propylthio, methylsulfinyl, ethylsulfinyl, methylsulfonyl or ethylsulfonyl,
R¹¹ represents hydrogen, represents in each case optionally cyano-, fluorine-, chlorine-, bromine-, methoxy- or ethoxy-substituted methyl, ethyl, n- or i-propyl, or represents in each case optionally cyano-, fluorine-, chlorine-, bromine-, methyl- or ethyl-substituted cyclopropyl,
R¹² represents hydrogen, represents iri each case optionally cyano-, fluorine-, chlorine-, bromine-, methoxy- or ethoxy-substituted methyl, ethyl, n- or i-propyl, or represents in each case optionally cyano-, fluorine-, chlorine-, bromine-, methyl- or ethyl-substituted cyclopropyl, and
R¹³ represents hydrogen, cyano, carbamoyl, fluorine, chlorine, bromine, or represents in each case optionally cyano-, fluorine-, chlorine-, bromine-, methoxy- or ethoxy-substituted methyl, ethyl, n- or i-propyl, methoxy, ethoxy, n- or i-propoxy, methoxycarbonyl, ethoxycarbonyl, n- or i-propoxycarbonyl, methylthio, ethylthio, n- or i-propylthio, methylsulfinyl, ethylsulfinyl, methylsulfonyl or ethylsulfonyl.

4. Compositions according to any of claims 1 to 3, characterized in that they comprise, as active compounds of group 1, at least one aryl ketone of the general formula (I) in which
m represents the numbers 0, 1 or 2,
A represents methylene,
R¹ represents one of the groupings below 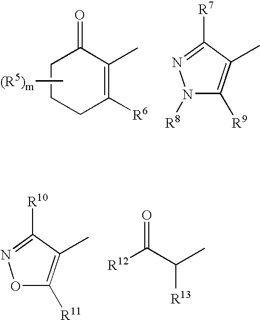
R² represents hydrogen, nitro, cyano, fluorine, chlorine, bromine, iodine, methyl, ethyl, difluoromethyl, trifluoromethyl, dichloromethyl, trichloromethyl, methoxymethyl, methylthiomethyl, methylsulfinylmethyl, methylsulfonylmethyl, methoxy, ethoxy, difluoromethoxy, trifluoromethoxy, methylthio, ethylthio, methylsulfinyl, ethylsulfinyl, methylsulfony, ethylsulfonyl or dimethylaminosulfonyl,
R³ represents hydrogen, nitro, cyano, fluorine, chlorine, bromine, iodine, methyl, ethyl, difluoromethyl, trifluoromethyl, dichloromethyl, trichloromethyl, methoxymethyl, methylthiomethyl, methylsulfinylmethyl, methylsulfonylmethyl, methoxy, ethoxy, difluoromethoxy, trifluoromethoxy, methylthio, ethylthio, methylsulfinyl, ethylsulfinyl, methylsulfony, ethylsulfonyl or dimethylaminosulfonyl,
R⁴ represents the heterocyclic grouping below 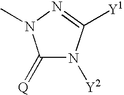
in which
Q represents oxygen or sulfur,
Y¹ represents hydrogen, hydroxyl, mercapto, cyano, fluorine, chlorine, bromine, iodine, represents in each case optionally fluorine-, chlorine-, methoxy-, ethoxy-, n- or i-propoxy-, methylthio-, ethylthio-, methylenesulfinyl-, ethylsulfinyl-, methylsulfonyl- or ethylsulfonyl-substituted methyl, ethyl, n- or i-propyl, methoxy, ethoxy, n- or i-propoxy, methylthio, ethylthio, n- or i-propylthio, methylsulfinyl, ethylsulfinyl, n- or i-propylsulfinyl, methylsulfonyl, ethylsulfonyl, n- or i-propylsulfonyl, represents methylarnino, ethylamino, n- or i-propylamino, dimethylamino or diethylamrino, represents in each case optionally fluorine- and/or chlorine-substituted ethenyl, propenyl, ethinyl, propinyl, propenyloxy, propenylthio or propenylamino, represents in each case optionally fluorine- and/or chlorine-substituted cyclopropyl, cyclopropyloxy, cyclopropylamino, cyclopropylmethyl, cyclopropylmethoxy or cyclopropylmethylamino, or represents in each case optionally fluorine-, chlorine-, methyl-, ethyl-, n- or i-propyl-, methoxy-, ethoxy-, n- or i-propoxy-substituted phenyl, phenyloxy, phenylthio, phenylamino, benzyl, benzyloxy, benzylthio or benzylamino, or—if two adjacent radicals Y¹ and Y¹ are located at a double bond—together with the adjacent radical Y¹ also represents a benzo grouping, and
Y² represents hydrogen, hydroxyl, amino, represents in each case optionally fluorine- and/or chlorine-, methoxy- or ethoxy-substituted methyl, ethyl, n- or i-propyl, methoxy, ethoxy, n- or i-propoxy, methylamino, ethylamino or dimethylamino, represents propenyl or propinyl, represents in each case optionally fluorine- and/or chlorine-substituted cyclopropyl, cyclobutyl or cyclopropylmethyl, or represents in each case optionally fluorine-, chlorine-, methyl, ethyl-, n- or i-propyl-, methoxy-, ethoxy-, n- or i-propoxy-substituted phenyl or benzyl, or together with an adjacent radical Y¹ or Y² represents in each case optionally methyl- and/or ethyl-substituted propane-1,3-diyl (trimethylene) or butane-1,4-diyl (tetramethylene),
R⁵ represents in each case optionally fluorine- or chlorine-substituted methyl, ethyl, n- or i-propyl, methylthio, ethylthio, n- or i-propylthio, represents phenyl, or optionally also—if m represents 2—together with a second radical R⁵ represents ethane-1,2-diyl (dimethylene), propane-1,3-diyl (trimethylene) or butane-1,4-diyl (tetramethylene),
R⁶ represents hydroxyl, formyloxy, represents in each case optionally fluorine-, chlorine-, methoxy- or ethoxy-substituted methoxy, ethoxy, n- or i-propoxy, methylthio, ethylthio, n- or i-propylthio, methylsulfinyl, ethylsulfinyl, methylsulfonyl, ethylsulfonyl, acetyloxy, propionyloxy, n- or i-butyroyloxy, methoxycarbonyloxy, ethoxycarbonyloxy, n- or i-propoxycarbonyloxy, methylaminocarbonyloxy, ethylaminocarbonyloxy, n- or i-propylaminocarbonyloxy, methylsulfonyloxy, ethylsulfonyloxy, n- or i-propylsulfonyloxy, represents propenyloxy or propinyloxy, or represents in each case optionally nitro-, cyano-, fluorine-, chlorine-, bromine-, methyl-, ethyl-, n- or i-propyl-, trifluoromethyl, methoxy-, ethoxy-, n- or i-propoxy-, difluoromethoxy- or trifluoromethoxy-substituted phenoxy, phenylthio, phenylsulfinyl, phenylsulfonyl, benzoyloxy, benzoylmethoxy, phenylsulfonyloxy, phenylmethoxy phenylmethylthio, phenylmethylsulfinyl or phenylmethylsulfonyl,
R⁷ represents hydrogen, cyano, fluorine, chlorine, bromine, represents in each case optionally fluorine-, chlorine-, methoxy- or ethoxy-substituted methyl, ethyl, n- or i-propyl, methoxy, ethoxy, n- or i-propoxy, methylthio, ethylthio, n- or i-propylthio, methylsulfinyl, ethylsulfinyl, n- or i-propylsulfinyl, methylsulfonyl, ethylsulfonyl, n- or i-propylsulfonyl, methoxycarbonyl, ethoxycarbonyl, n- or i-propoxycarbonyl,
R⁸ represents hydrogen, represents in each case optionally cyano-, fluorine-, chlorine-, methoxy- or ethoxy-substituted methyl, ethyl, n- or i-propyl, represents in each case optionally fluorine- or chlorine-substituted propenyl or propinyl, represents optionally fluorine-, chlorine-, bromine-, methyl- or ethyl-substituted cyclopropyl, or represents in each case optionally fluorine-, chlorine-, bromine-, methyl-, ethyl-, n- or i-propyl-, trifluoromethyl-, methoxy-, ethoxy-, n- or i-propoxy-, difluoromethoxy- or trifluoromethoxy-substituted phenyl or benzyl,
R⁹ represents hydroxyl, formyloxy, represents in each case optionally cyano-, fluorine-, chlorine-, bromine-, methoxy-, ethoxy-, n- or i-propoxy-substituted methoxy, ethoxy, n- or i-propoxy, acetyloxy, propionyloxy, n- or i-butyroyloxy, methoxycarbonyloxy, ethoxycarbonyloxy, n- or i-propoxycarbonyloxy, methylaminocarbonyloxy, ethylaminocarbonyloxy, n- or i-propylaminocarbonyloxy, methylsulfonyloxy, ethylsulfonyloxy, n- or i-propylsulfonyloxy, represents propenyloxy or propinyloxy, or represents in each case optionally nitro-, cyano-, fluorine-, chlorine-, bromine-, methyl-, ethyl-, n- or i-propyl-, trifluoromethyl-, methoxy-, ethoxy-, n- or i-propoxy-, difluoromethoxy- or trifluoromethoxy-substituted phenylmethoxy, benzoyloxy, benzoylmethoxy or phenylsulfonyloxy,
R¹⁰ represents hydrogen, cyano, fluorine, chlorine, bromine, or represents in each case optionally fluorine-, chlorine-, methoxy-, ethoxy-, n- or i-propoxy-substituted methyl, ethyl, n- or i-propyl, acetyl, propionyl, n- or i-butyroyl, methoxy, ethoxy, n- or i-propoxy, methoxycarbonyl, ethoxycarbonyl, n- or i-propoxycarbonyl, methylthio, ethylthio, n- or i-propylthio, methylsulfinyl, ethylsulfinyl, methylsulfonyl or ethylsulfonyl,
R¹¹ represents hydrogen, represents in each case optionally fluorine-, chlorine-, bromine-, methoxy- or ethoxy-substituted methyl, ethyl, n- or i-propyl, or represents optionally fluorine-, chlorine-, bromine-, methyl- or ethyl-substituted cyclopropyl,
R¹² represents hydrogen, represents in each case optionally fluorine-, chlorine-, methoxy- or ethoxy-substituted methyl, ethyl, n- or i-propyl, or represents optionally fluorine-, chlorine-, bromine-, methyl- or ethyl-substituted cyclopropyl, and
R¹³ represents hydrogen, cyano, fluorine, chlorine, bromine, or represents in each case optionally fluorine-, chlorine-, bromine-, methoxy- or ethoxy-substituted methyl, ethyl, n- or i-propyl, methoxy, ethoxy, n- or i-propoxy, methoxycarbonyl, ethoxycarbonyl, n- or i-propoxycarbonyl, methylthio, ethylthio, n- or i-propylthio, methylsulfinyl, ethylsulfinyl, n- or i-propylsulfinyl, methylsulfonyl, ethylsulfonyl, n- or i-propylsulfonyl.

5. Compositions according to any of claims 1 to 4, characterized in that they comprise, as active compound of the group 1, at least one aryl ketone of the general formula (I) in which
m, A, R¹, R², R³ have the meanings given in claim 4 and
R⁴ represents one of the heterocyclic groupings below 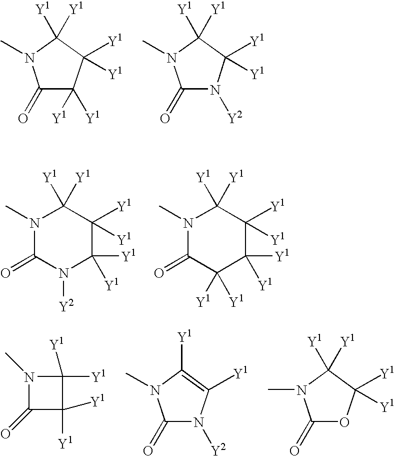
in which
Y¹ represents hydrogen, cyano, fluorine, chlorine, bromine, represents in each case optionally fluorine-, chlorine-, methoxy- or ethoxy-substituted methyl, ethyl, n- or i-propyl, methoxy, ethoxy, n- or i-propoxy, methylthio, ethylthio, n- or i-propylthio, methylsulfinyl, ethylsulfinyl, n- or i-propylsulfinyl, methylsulfonyl, ethylsulfonyl, n- or i-propylsulfonyl, represents methylamino, ethylamino, n- or i-propylamino, dimethylamino or diethylamino, represents in each case optionally fluorine- and/or chlorine-substituted ethenyl, propenyl, ethinyl, propinyl, propenyloxy, propenylthio or propenylamino, represents in each case optionally fluorine- and/or chlorine-substituted cyclopropyl, cyclopropyloxy, cyclopropylamino, cyclopropylmethyl, cyclopropylmethoxy or cyclopropylmethylamino, or represents in each case optionally fluorine-, chlorine-, methyl-, ethyl-, n- or i-propyl-, methoxy-, ethoxy-, n- or i-propoxy-substituted phenyl, phenyloxy, phenylthio, phenylamino, benzyl, benzyloxy, benzylthio or benzylamino, or—if two adjacent radicals Y¹ and Y¹ are located at a double bond—together with the adjacent radical Y¹ also represents a benzo grouping, and
Y² represents hydrogen, hydroxyl, amino, represents in each case optionally fluorine- and/or chlorine-, methoxy- or ethoxy-substituted methyl, ethyl, n- or i-propyl, methoxy, ethoxy, n- or i-propoxy, methylamino, ethylamino or dimethylamino, represents propenyl or propinyl, represents in each case optionally fluorine- and/or chlorine-substituted cyclopropyl, cyclobutyl or cyclopropylmethyl, or represents in each case optionally fluorine-, chlorine-, methyl-, ethyl-, n- or i-propyl-, methoxy-, ethoxy-, n- or i-propoxy-substituted phenyl or benzyl, or together with an adjacent radical Y¹ or Y² represents in each case optionally methyl- and/or ethyl-substituted propane-1,3-diyl (trimethylene) or butane-1,4-diyl (tetramethylene).

6. Compositions according to any of claims 1 to 5, characterized in that they comprise, as active compound of group 1, at least one aryl ketone of the general formula (I) in which
m, A, R¹, R², R³ have the meanings given in claim 4 and
R⁴ represents the heterocyclic grouping below 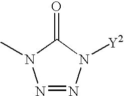
in which
Y² represents hydrogen, hydroxyl, amino, represents in each case optionally fluorine- and/or chlorine-, methoxy- or ethoxy-substituted methyl, ethyl, n- or i-propyl, methoxy, ethoxy, n- or i-propoxy, represents propenyl or propinyl, represents in each case optionally fluorine- and/or chlorine-substituted cyclopropyl, cyclobutyl or cyclopropylmethyl, or represents in each case optionally fluorine-, chlorine-, methyl-, ethyl, n- or i-propyl-, methoxy-, ethoxy-, n- or i-propoxy-substituted phenyl or benzyl.

7. Compositions according to any of claims 1 to 6, characterized in that they comprise, as active compound of group 2, one or more compounds from the group of active compounds listed below:
acetochlor, alachlor, amicarbazone, amidosulfuron, anilofos, atrazine, azimsulfuron, benfuresate, bensulfuron-methyl, bentazone, benthiocarb (thiobencarb), benzobicyclon, benzofenap, bispyrbac-sodium, bromobutide, butachlor, cafenstrole, carfentrazone-ethyl, chlomethoxyfen, cinmethylin, cinosulfuron, clefoxydim, clodinafop-propargyl, clomeprop, cumyluron, cyanazine, cyclosulfamuron, cyhalofop-butyl, 2,4-D, dichlorprop-P, dimepiperate, dimethametryn, dimethenamid, S-dimethenamid, dithiopyr, dymron, esprocarb, ethoxysulfuron, etobenzanid, fenoxaprop-P-ethyl, fentrazamide, fluazifop-P-butyl, flucarbazone-sodium, flufenacet, flumetsulam, haloxyfop-P-methyl, imazamox, imazaquin, imazethapyr, imazosulfuron, isoxaflutole, MCPA, mefenacet, mesosulfuron, mesotrione, metolachlor, S-metolachlor, metosulam, metsulfuron-methyl, metribuzin, molinate, naproanilide, nicosulfuron, oxadiargyl, oxadiazon, oxaziclomefone, oxyfluorfen, pendimethalin, pentoxazone, piperophos, pretilachlor, propanil, propoxycarbazone-sodium, pyraclonil, pyrazolate, pyrazosulfuron-ethyl, pyrazoxyfen, pyribenzoxim, pyributicarb, pyriminobac-methyl, qinclorac, simazine, simetryn, sulcotrione, terbuthylazine, thenylchlor, thifensulfuron-methyl, tritosulfuron.

8. Compositions according to any of claims 1 to 7, characterized in that they comprise, as active compound of group 3, one or more compounds from the group of active compounds listed below:
5-chloro-quinoxalin-8-oxy-acetic acid (1-methyl-hexyl ester) (cloquintocet-mexyl), ethyl 4,5-dihydro-5,5-diphenyl-3-isoxazolecarboxylate (isoxadifen-ethyl) and diethyl-1-(2,4-dichloro-phenyl)-4,5-dihydro-5-methyl-1H-pyrazole-3,5-dicarboxylate (mefenpyr-diethyl), 4-dichloroacetyl-1-oxa-4-aza-spiro-[4.5]-decane (AD-67), 1-dichloroacetyl-hexahydro-3,3,8a-trimethylpyrrolo-[1,2-a]-pyrimidin-6(2H)-one (BAS-145138), 4-dichloroacetyl-3,4-dihydro-3-methyl-2H-1,4-benzoxazine (benoxacor), 2,2-dichloro-N,N-di-2-propenyl-acetamide (dichlormid), 3-dichloroacetyl-5-(2-furanyl)-2,2-dimethyl-oxazolidine (furilazole, MON-13900), 3-dichloroacetyl-2,2,5-trimethyl-oxazolidine (R-29148), 2,4-dichlorophenoxy-acetic acid (2,4-D), (4-chloro-2-methylphenoxy)acetic acid (MCPA) and (+-)-2-(4-chloro-2-methylphenoxy)-propanoic acid (mecoprop).

9. Use of a composition according to any of claims 1 to 8 for controlling undesirable plants.

10. Method for controlling undesirable plants, characterized in that compositions according to any of claims 1 to 8 are allowed to act on the undesirable plants and/or their habitat.
